(19) United States
(12) Patent Application Publication
(10) Pub. No.: US 2007/0087448 A1
(43) Pub. Date: Apr. 19, 2007

(54) Biological profiles and methods of use

(76) Inventor: Gary L. Nelsestuen, St. Paul, MN (US)

Correspondence Address: MUETING, RAASCH & GEBHARDT, P.A., P.O. BOX 581415, MINNEAPOLIS, MN, 55458, US

(21) Appl. No.: 11/502,871

(22) Filed: Aug. 11, 2006

Related U.S. Application Data
(63) Continuation-in-part of application No. PCT/US05/00481, filed on Jan. 7, 2005.
(60) Provisional application No. 60/798,456, filed on May 5, 2006.
(60) Provisional application No. 60/730,081, filed on Oct. 25, 2005.
(60) Provisional application No. 60/718,560, filed on Sep. 19, 2005.
(60) Provisional application No. 60/708,314, filed on Aug. 15, 2005.
(60) Provisional application No. 60/544,450, filed on Feb. 16, 2004.
(60) Provisional application No. 60/573,680, filed on May 21, 2004.

(51) Int. Cl. G01N 24/00

(52) U.S. Cl. 436/173

(57) ABSTRACT

The invention provides methods to diagnose and follow the progression of disease through use of protein profile analysis.

This application claims the benefit of U.S. provisional applications Ser. No. 60/708,314, filed 15 Aug. 2005; Ser. No. 60/718,560, filed Sep. 19, 2005; Ser. No. 60/730,081, filed Oct. 25, 2005; and Ser. No. 60/798,456, filed May 5, 2006; further, this application is a continuation-in-part application of international patent application PCT/US2005/004817, filed 16 Feb. 2005, and published on 01 Sep. 2005 as WO2005/079410A2, which claims the benefit of U.S. provisional applications Ser. No. 60/544,450, filed Feb. 16, 2004 and Ser. No. 60/573,680, filed May 21, 2004, each of which is incorporated by reference in its entirety.

### GOVERNMENT RIGHTS

The invention described herein was developed with support from the National Institutes of Health under Grant Number HL65578. The U.S. Government has certain rights in the invention.

### BACKGROUND OF THE INVENTION

One goal of proteomic research is to provide methods for disease diagnosis. The methods used can be very divergent. One extreme consists of identification of every protein and modified protein in a sample such as serum (Adkins et al., Mol. Cell. Proteomics, 1:947-955 (2002); Pieper et al., Proteomics, 3:1345-1364 (2003)). While this global approach suffers from cost and time required for analysis, the ultimate target may be the identification of a single diagnostic protein. Another extreme targets rapid extraction methods that detect a limited number of proteins. One example utilizes matrix assisted laser desorption ionization-time of flight (MALDI-TOF) mass spectrometry. This method produces profiles of extracted proteins based on mass to charge ratio. Another approach is Surface-Enhanced Laser Desorption Ionization (SELDI) which appears to be useful in diagnosis of ovarian cancer (Petricoin et al., Lancet, 359: 572-577 (2002) and Ye et al., Clin. Cancer Res., 9:2904-2911 (2003)) and possibly other conditions (Schaub et al., J. Am. Soc. Nephrol., 15:219-227 (2004) and Petricoin et al., J. Natl. Cancer Inst., 94:1576-1578 (2002)). SELDI has been used to analyze urine from persons with kidney disease (Schaub et al., J. Am. Soc. Nephrol., 15:219 (2004)). Many new components were observed and the peaks were narrow and well-defined, consistent with discrete, identifiable components. However, the method illustrates the limitation of SELDI that does not provide a transition from profiling to protein identification. In addition, questions have been raised regarding reproducibility and other features of the classical method (Clarke et al., Clin. Chem. Lab. Med., 41:1562-1570 (2003); Diamandis, Mol. Cell. Proteomics (2004); Baggerly et al., Bioinformatics (2004)). Protein identification has been achieved in some cases (Schaub et al., J. Am. Soc. Nephrol., 15:219-227 (2004)).

Accordingly, what is needed is a method that can be used to diagnose and predict disease progression based on the use of a protein profile that is readily prepared from a biological sample obtained from a subject.

### SUMMARY OF THE INVENTION

The invention provides a novel method for utilizing mass spectrometry to analyze biological samples, particularly in connection with monitoring the health status or disease state of a subject.

A biological sample containing a bodily fluid, such as blood, fractionated blood, plasma, fractionated plasma, serum, fractionated serum, urine or saliva is diluted and subjected to mass spectrometry, for example matrix-assisted laser desorption ionization time-of-flight (MALDI-TOF) mass spectrometry, to yield a plurality of mass spectrometry peaks, at least one of which is analyzed. Optionally, the biological fluid analyzed in accordance with the method is not preprocessed other than, optionally, by a simple fractionation to yield a blood fraction (such as plasma or serum) or a plasma or serum fraction.

Also optionally, prior to mass spectrometric analysis, the sample is rapidly preprocessed, for example by chromatography, ultrafiltration, electrophoresis or dialysis. Examples of chromatography include ion exchange chromatography, affinity chromatography, hydrophobic chromatography, hydrophilic chromatography and reverse phase chromatography. Advantageously, the rapid preprocessing can be carried out on a microscale by contacting the sample with a preprocessing device such as a microcartridge or a pipette tip that contains a suitable matrix, preferably immediately prior to subjecting the sample to mass spectrometric analysis. Optionally, preprocessing and mass spectrometric analysis are performed sequentially “in-line” using a preprocessing device in fluid communication with a mass spectrometer. This system is well-suited to automation and the use of robotics for sample handling, and integrated software for mechanical operation and data analysis.

In a preferred embodiment, when the sample contains blood or blood components such as plasma, fractionated plasma, serum or fractionated serum, a plasma or serum protein profile is produced and at least one of the following mass spectrometry peaks in the plasma or serum sample is analyzed: peaks having an m/z value of 4152±0.1%; 4184±0.1%; 6420±0.1%; 6434±0.1%; 6450±0.1%; 6618±0.1%; 6632±0.1%; 6648±0.1%; 8765±0.1%; 8810±0.1%; 8825±0.1%; 8915±0.1%; 8931±0.1%; 8947±9; 9352±0.1%; 9422±0.1%; 9438±0.1%; 9454±0.1%; 9642±0.1%; 9713±0.1%; 9729±0.1%; 9745±0.1%; 11524±0.1%; 11681±0.1%; 13761±0.1%; 13840±0.1%; and 13880±0.1%.

The invention includes a method for diagnosing, evaluating or monitoring the health of a subject. For example, the method can be used to detect the presence, absence or status of diabetes, pre-diabetes, or insulin resistance. The method can also be used to assess the metabolic fitness of a subject. A biological fluid of the subject is analyzed using mass spectrometry to produce a biological profile. Mass spectrometry is used to identify one or more peaks with m/z values of interest, and a measurable attribute of the peak of interest is observed and optionally compared to a measurable attribute of a second peak. The attribute that is measured typically includes peak height or the area defined by the peak. The mass spectrometric peak used in the comparative analysis can, for example, be a peak having a different m/z value but generated from the same sample, or be an analogous peak with the same m/z value (within standard error) but obtained from a prior or subsequent sample of the subject, or from a different subject. Preferably, comparing the peak attributes comprises determining a ratio of the peak attributes.

In one embodiment, biological fluid of the subject is subjected to mass spectrometry, for example matrix-assisted laser desorption ionization time-of-flight (MALDI-TOF) mass spectrometry, to yield a plurality of mass spectrometry peaks; and a measurable attribute of a peak corresponding to an m/z value of 6632±0.1% is compared with a measurable attribute of a peak corresponding to an m/z value of 6434±0.1%. Optionally, peaks corresponding to m/z values of 6632±0.1% and 6434±0.1% are additionally compared with attributes of analogous peaks obtained for the subject at a different time. The comparison yields information that is indicative of the health of the subject, for example it may be indicative of the presence, absence or status of diabetes, pre-diabetes or insulin resistance, or of the metabolic fitness level of the patient.

In another embodiment, the method for diagnosing, evaluating or monitoring the health of a subject includes analyzing a biological sample of a subject, the biological sample comprising, for example, whole blood or fractionated blood, to determine the amount or concentration of apolipoprotein CI; and the amount or concentration of an apolipoprotein CI fragment, said fragment characterized by the absence of the first (threonine) and second (proline) amino acids from the N-terminus of apolipoprotein CI; and comparing the amount or concentration of apolipoprotein CI with the amount or concentration of the apolipoprotein CI fragment; wherein the comparison is indicative of the health of the subject. The comparison yields information that is indicative of the health of the subject, for example it may be indicative of the presence, absence or status of diabetes, pre-diabetes or insulin resistance, or of the metabolic fitness level of the subject.

In another aspect, the invention provides a method for assessing the effectiveness of a treatment agent. The invention accordingly includes a method for monitoring treatment of diabetes, pre-diabetes or insulin resistance in a subject that involves subjecting a biological fluid of the subject to mass spectrometry, for example matrix-assisted laser desorption ionization time-of-flight (MALDI-TOF) mass spectrometry, following administration of a therapeutic agent to the subject to yield a plurality of mass spectrometry peaks; and comparing measurable attributes of peaks corresponding to m/z values of 6632±0.1% and 6434±0.1% m/z with analogous peak attributes obtained for the subject prior to administration of the therapeutic agent. Preferably, the ratio of peak attributes at 6632±0.1% m/z and 6434±0.1% m/z obtained after administration of the therapeutic agent is compared with the ratio of analogous peak attributes obtained prior to administration of the therapeutic agent. In some embodiments, the ratio of peaks at m/z=5082/4885±0.1% can be used for this method.

In another aspect, the invention provides for an analysis of apolipoprotein in a biological fluid of a subject as an indicator of the health of the patient. Accordingly, the invention provides a method for diagnosing, prognosing or monitoring the health of a subject that includes analyzing a biological fluid or tissue of the subject, preferably using mass spectrometry, to determine the presence of a mutant form of apolipoprotein CI in an individual; wherein the mutant form of apolipoprotein CI has a molecular weight that is 14±1 mass units lower than the common form of apolipoprotein CI. In one embodiment, the biological fluid or tissue comprises a nucleic acid, and analyzing the biological fluid or tissue of the subject includes analyzing the nucleic acid.

In another aspect, the invention provides a method for diagnosing, evaluating or monitoring the health of a subject that includes subjecting a biological fluid of the subject to mass spectrometry, for example matrix-assisted laser desorption ionization time-of-flight (MALDI-TOF) mass spectrometry, to yield a plurality of mass spectrometry peaks; and comparing a measurable attribute of a first peak at an m/z value of 4152±0.1% or a polymorphic form of the protein represented by an m/z value of 4185±0.1%, with a measurable attribute of a second peak, preferably a peak at 6632±0.1% m/z, or with a combination of peaks at a different m/z value. Optionally, the method further includes comparing the attributes of peaks corresponding to a first m/z value of 4152±0.1%m/z and a second different m/z value with attributes of analogous peaks obtained for the subject at a different time. The comparison yields information that is indicative of the health of the subject. The comparison is indicative of the presence, absence or status of an autoimmune disorder or allergy, such as an inflammatory response. The comparison can be an early stage indicator of a disease state.

In another aspect, the invention provides a method for monitoring treatment of inflammation, an autoimmune disorder, or an allergy in a subject including subjecting a biological fluid of the subject to mass spectrometry, for example matrix-assisted laser desorption ionization time-of-flight (MALDI-TOF) mass spectrometry, following administration of a therapeutic agent to the subject to yield a plurality of mass spectrometry peaks; and comparing measurable attributes of peaks corresponding to a first m/z value of 4152±0.1% m/z and a second different m/z value with analogous peak attributes obtained for the subject prior to administration of the therapeutic agent.

In yet another aspect, the invention provides a method for diagnosing, prognosing or monitoring the health of a subject that includes subjecting a biological fluid of the subject to mass spectrometry, for example matrix-assisted laser desorption ionization time-of-flight (MALDI-TOF) mass spectrometry, to yield a plurality of mass spectrometry peaks; and comparing a measurable attribute of a peak corresponding to an m/z value of 13840±0.1% or 13880±0.1%, with a measurable attribute of a peak corresponding to an m/z value of 1376±0.1%; wherein the comparison is indicative of the health of the subject.

In yet another aspect, the invention provides a method for diagnosing, prognosing or monitoring the health of a subject that includes subjecting a biological fluid of the subject to mass spectrometry, for example matrix-assisted laser desorption ionization time-of-flight (MALDI-TOF) mass spectrometry, to yield a plurality of mass spectrometry peaks; and comparing a measurable attribute of a peak corresponding to an m/z value of 11524±0.1% or 11681±0.1%, with a measurable attribute of a peak such as that corresponding to an m/z value of 13761±0.1%, other peaks of the profile or combination of peak intensities of the profile; wherein the comparison is indicative of the health of the subject.

In yet another embodiment, the invention provides a method for diagnosing, prognosing or monitoring the health of a subject that includes subjecting a biological fluid of the subject to mass spectrometry, for example matrix-assisted laser desorption ionization time-of-flight (MALDI-TOF) mass spectrometry, to yield a plurality of mass spectrometry peaks; and comparing a measurable attribute of a peak associated with a polypeptide, with a measurable attribute of a peak associated with a fragment of said polypeptide lacking one or two amino acids at either or both of the N-terminus and C-terminus; wherein the comparison is indicative of the health of the subject.

In yet another aspect, the invention provides a method for diagnosing, prognosing or monitoring the health of a subject that includes subjecting a biological fluid of the subject to mass spectrometry, for example matrix-assisted laser desorption ionization time-of-flight (MALDI-TOF) mass spectrometry, to yield a plurality of mass spectrometry peaks; and comparing a measurable attribute of a peak associated with a polypeptide comprising at least one sialic acid moiety, with a measurable attribute of a peak associated with an analogous polypeptide lacking a sialic acid residue; wherein the comparison is indicative of the health of the subject.

The invention provides methods for analyzing many different types of biological samples, including urine samples. In a method for analyzing a urine sample, for example, the urine sample is subjected to mass spectrometry to yield a plurality of mass spectrometry peaks; and any peak that differs from standard components found in healthy individuals at m/z values of 9742±0.1% and/or 9070±0.1% is analyzed. In another method, a urine protein profile is produced and at least one of the following mass spectrometry peaks in the urine sample is analyzed: peaks having an m/z value of 2187±0.1%, 2431±0.1%, 2715±0.1%, 2750±0.1%, 2844±0.1%, 2882±0.1%, 2786±0.1%, 3000±0.1%, 3272±0.1%, 3370±0.1%, 3441±0.1%, 3485±0.1%, 3495±0.1%, 3525±0.1%, 3787±0.1%, 3900±0.1%, 3982±0.1%, 4132±0.1%, 4180±0.1%, 4224±0.1%, 4253±0.1%, 4271±0.1%, 4300±0.1%, 4338±0.1%, 4352±0.1%, 4375±0.1%, 4511±0.1%, 4565±0.1%, 4637±0.1%, 4675±0.1%, 4750±0.1%, 4840±0.1%, 4859±0.1%, 4988±0.1%, 5006±0.1%, 5070±0.1%, 5170±0.1%, 5321±0.1%, 5419±0.1%, 5556±0.1%, 5704±0.1%, 5764±0.1%, 5865±0.1%, 6343±0.1%, 6353±0.1%, 6431±0.1%, 6489±0.1%, 6590±0.1%, 6632±0.1%, 6643±0.1%, 6676±0.1%, 6733±0.1%, 6750±0.1%, 6766±0.1%, 6868±0.1%, 6937±0.1%, 7007±0.1%, 7154±0.1%, 7319±0.1%, 7421±0.1%, 7510±0.1%, 7560±0.1%, 7919±0.1%, 7937±0.1%, 8566±0.1%, 8846±0.1%, 8915±0.1%, 9070±0.1%, 9096±0.1%, 9394±0.1%, 9422±0.1%, 9480±0.1%, 9713±0.1%, 9742±0.1%, 10350±0.1%, 10649±0.1%, 10780±0.1%, 10840±0.1%, 10880±0.1%, 11035±0.1%, 11183±0.1%, 11310±0.1%, 11323±0.1%, 11368±0.1%, 11732±0.1%, 12262±0.1%, 12684±0.1%, 12690±0.1%, 13350±0.1%, 13760±0.1%, 13380±0.1%, 15012±0.1%, 15835±0.1%, and 20950±0.1%.

In another aspect, the invention provides a method for diagnosing, prognosing or monitoring the health of a subject that includes subjecting a urine sample of the subject to mass spectrometry, for example matrix-assisted laser desorption ionization time-of-flight (MALDI-TOF) mass spectrometry, to yield a plurality of mass spectrometry peaks; and comparing a measurable attribute of a peak corresponding to an m/z value of 9070±0.1% with a measurable attribute of a peak corresponding to an m/z value of 9742±0.1%; wherein the comparison is indicative of the health of the subject. As previously noted, the measurable attribute can include peak height or area defined by the peak. Comparing the peak attributes can include determining a ratio of the peak attributes. This comparison may indicate the presence, absence or status of kidney disease or dysfunction. In as preferred embodiment, the method includes comparing attributes of peaks corresponding to m/z values of 9070±0.1% and m/z value of 9742±0.1% with attributes of analogous peaks obtained for the subject at a different time.

In yet another aspect, the invention provides a method for monitoring treatment of kidney disease or dysfunction in a subject. The method includes subjecting a urine sample of the subject to mass spectrometry, for example matrix-assisted laser desorption ionization time-of-flight (MALDI-TOF) mass spectrometry, following administration of a therapeutic agent to the subject to yield a plurality of mass spectrometry peaks; and comparing measurable attributes of peaks corresponding to m/z values of 9070±0.1% and 9742±0.1% m/z with analogous peak attributes obtained for the subject prior to administration of the therapeutic agent.

In another aspect, the invention provides an analytical device that includes a mass spectrometer, for example a matrix-assisted laser desorption ionization time-of-flight (MALDI-TOF) mass spectrometer, preprogrammed with instructions for measuring an attribute of at least one peak described herein. Preferably, the analytical device is preprogrammed with instructions for measuring an attribute of at least one peak from a plasma or serum protein profile having an m/z value selected from the group consisting of 4152±0.1%; 4184±0.1%; 6420±0.1%; 6434±0.1%; 6450±0.1%; 6618±0.1%; 6632±0.1%; 6648±0.1%; 8765±0.1%; 8810±0.1%; 8825±0.1%; 8915±0.1%; 8931±0.1%; 8947±9; 9352±0.1%; 9422±0.1%; 9438±0.1%; 9454±0.1%; 9642±0.1%; 9713±0.1%; 9729±0.1%; 9745±0.1%; 11524±0.1%; 11681±0.1%; 13761±0.1%; 13840±0.1%; and 13880±0.1%.

Additionally or alternatively, particularly when the sample to be analyzed is a urine sample, the analytical device can be preprogrammed with instructions for measuring an attribute of at least one peak from a urine protein profile having an m/z value selected from the group consisting of 2187±0.1%, 2431±0.1%, 2715±0.1%, 2750±0.1%, 2844±0.1%, 2882±0.1%, 2786±0.1%, 3000±0.1%, 3272±0.1%, 3370±0.1%, 3441±0.1%, 3485±0.1%, 3495±0.1%, 3525±0.1%, 3787±0.1%, 3900±0.1%, 3982±0.1%, 4132±0.1%, 4180±0.1%, 4224±0.1%, 4253±0.1%, 4271±0.1%, 4300±0.1%, 4338±0.1%, 4352±0.1%, 4375±0.1%, 4511±0.1%, 4565±0.1%, 4637±0.1%, 4675±0.1%, 4750±0.1%, 4840±0.1%, 4859±0.1%, 4988±0.1%, 5006±0.1%, 5070±0.1%, 5170±0.1%, 5321±0.1%, 5419±0.1%, 5556±0.1%, 5704±0.1%, 5764±0.1%, 5865±0.1%, 6343±0.1%, 6353±0.1%, 6431±0.1%, 6489±0.1%, 6590±0.1%, 6632±0.1%, 6643±0.1%, 6676±0.1%, 6733±0.1%, 6750±0.1%, 6766±0.1%, 6868±0.1%, 6937±0.1%, 7007±0.1%, 7154±0.1%, 7319±0.1%, 7421±0.1%, 7510±0.1%, 7560±0.1%, 7919±0.1%, 7937±0.1%, 8566±0.1%, 8846±0.1%, 8915±0.1%, 9070±0.1%, 9096±0.1%, 9394±0.1%, 9422±0.1%, 9480±0.1%, 9713±0.1%, 9742±0.1%, 10350±0.1%, 10649±0.1%, 10780±0.1%, 10840±0.1%, 10880±0.1%, 11035±0.1%, 11183±0.1%, 11310±0.1%, 11323±0.1%, 11368±0.1%, 11732±0.1%, 12262±0.1%, 12684±0.1%, 12690±0.1%, 13350±0.1%, 13760±0.1%, 13380±0.1%, 15012±0.1%, 15835±0.1%, and 20950±0.1%.

Also provided is a method for using the analytical device. A biological fluid of a subject is introduced into the device to yield a plurality of mass spectrometry peaks; and at least one preprogrammed peak height or area is analyzed. The peak height or area is indicative of the health of the subject.

In yet another aspect, the invention includes a method of monitoring the metabolic fitness of a subject. A biological fluid is obtained from the subject and subjected to mass spectrometry. Peak attributes, such as height or area, at 6632±0.1% and 6434±0.1% are compared with analogous peak heights obtained for the subject at a different time. Preferably the biological fluid includes whole blood or fractionated blood. Optionally, the method can be performed in conjunction with an exercise program, and can be performed using the analytical device of the invention.

The invention further provides a method of administering a fitness program, which includes periodically receiving and analyzing information concerning the exercise activity of a subject enrolled in a fitness program; and periodically receiving and analyzing biological fluid of the subject, wherein the presence, absence or amount of at least one selected component in the biological fluid is indicative of the metabolic fitness of the subject. Optionally, the method further includes enrolling a subject in a fitness program or identifying a subject already enrolled in a fitness program. Preferably, the biological fluid comprises whole or fractionated blood. The biological fluid is preferably analyzed using mass spectrometry, for example matrix-assisted laser desorption ionization time-of-flight (MALDI-TOF) mass spectrometry, and optionally the analytical device of the invention can be utilized to perform the analysis. Optionally the method further includes providing the subject with a kit comprising means for obtaining a biological sample.

The invention lends itself readily to automation. Samples can be analyzed using automated systems, including robotics, and data can be analyzed using software integrated into the analytical device.

In another aspect, the invention provides a method to prepare a protein profile for a cell, tissue or organism that includes applying components from a cell, tissue, or a biological sample obtained from an organism that were fractionated through use of a matrix to a matrix assisted laser desorption ionization-time of flight mass spectrometer target, and analyzing the components with a matrix assisted laser desorption ionization-time of flight mass spectrometer.

The invention also provides a method to determine if a mediator causes an altered protein profile in a cell, tissue or organism that includes comparing a first protein profile of a cell, a tissue or of a biological sample obtained from the organism before the cell, the tissue or the organism was contacted with the mediator, with a second protein profile of a corresponding cell, a tissue or a biological sample obtained from the organism after the corresponding cell, the tissue or the organism was contacted with the mediator; and determining if the first protein profile differs from the second protein profile due to contact of the corresponding cell, the tissue or the organism with the mediator.

Also provided is a method to screen for an agent that reduces or eliminates alteration of a protein profile in an organism due to a response stimulator that includes contacting a test organism with a candidate agent and the response stimulator; and determining if the candidate agent reduces alteration of a protein profile in the test organism when compared to alteration of a protein profile in a control organism that was contacted with the candidate agent and was not contacted with the response stimulator.

A method to screen for an agent that prevents alteration of a protein profile in an organism due to a response stimulator is also provided by the invention. The method includes contacting a test organism with a candidate agent, contacting the test organism with the response stimulator; and determining if the candidate agent reduces alteration of a protein profile in the test organism when compared to alteration of a protein profile in a control organism that was contacted with the response stimulator and was not contacted with the candidate agent.

The invention provides a method to screen for an agent that reduces alteration of a protein profile in an organism following contact with a response stimulator that includes contacting a test organism with the response stimulator, contacting the test organism with a candidate agent; and determining if the candidate agent reduces alteration of a protein profile in the test organism when compared to alteration of a protein profile in a control organism that was contacted with the response stimulator and was not contacted with the candidate agent.

Further provided by the invention is a method to detect an immune response in an organism that includes comparing a test protein profile of a biological sample obtained from an organism suspected of having an immune response to a control protein profile; and (a) determining if a protein peak having an m/z value of 4150 is increased in the test protein profile as compared to the control protein profile, (b) determining if reduced transthyretin is lower in the test protein profile as compared to the control protein profile, (c) determining if serum amyloid A is increased in the test protein profile as compared to the control protein profile, (d) determining if degradation products of serum amyloid A are increased in the test protein profile as compared to the control protein profile, (e) determining if oxidation of one or more proteins in the test protein profile is increased as compared to the control protein profile, or (f) any combination of (a-e).

A method to diagnose ataxia in an organism is provided that includes comparing a test protein profile prepared from a biological sample obtained from an organism suspected of having ataxia, with a control protein profile prepared from a biological sample obtained from an organism that does not have ataxia; and determining if the oxidized forms of transthyretin are present in a different distribution in the test protein profile as compared to the control protein profile.

A method to diagnose sepsis in an organism is provided that includes comparing a test protein profile of a biological sample obtained from an organism suspected of having sepsis, with a control protein profile of a biological sample obtained from an organism that does not have sepsis; and determining if the test protein profile differs from the control protein profile.

The invention provides a method to diagnose diabetes, or a predisposition to develop diabetes, in a mammal that involves comparing a first protein profile prepared from a biological sample obtained from the mammal following a fasting period, with a second protein profile prepared from a biological sample obtained from the mammal after caloric intake by the mammal; and determining if a peak height, a peak height ratio, a peak area, or any combination thereof within the first protein profile is altered from a corresponding peak height, peak height ratio, peak area, or any combination thereof in the second protein profile.

A method to diagnose graft versus host disease in a test organism is provided that includes comparing a test protein profile prepared from a biological sample obtained from the test organism after the test organism received transplanted cells or tissue with a control protein profile; and determining if the test protein profile differs from the control protein profile.

A method to diagnose bronchiolitis-obliterans syndrome in an organism is provided that includes comparing a test protein profile prepared from a biological sample obtained from an organism suspected of having bronchiolitis-obliterans syndrome, with a control protein profile prepared from a biological sample obtained from an organism that does not have bronchiolitis-obliterans syndrome; and determining if a peak having m/z=10590 is elevated in the test protein profile when compared to the control protein profile.

A kit is also provided by the invention that includes packaging material and a matrix.

### BRIEF DESCRIPTION OF THE DRAWINGS

FIG. 1A shows a matrix assisted laser desorption ionization-time of flight mass spectrometry (MALDI-TOF) profile of 0.5 microliters of normal human plasma.

FIG. 1B shows a MALDI-TOF profile of 0.5 microliters of plasma from a severe sepsis patient.

FIG. 2A shows an expanded region showing the alanine ladder for major components at m/z=9713 and 9422.

FIG. 2B shows an expanded region of serum amyloid A (SAA) from FIG. 1B illustrating isoforms and degradation products of SAA.

FIG. 2C shows an expanded region of transthyretin showing the major peaks including sulfonylated TTr at m/z=13840.

FIG. 2D shows an expanded region showing a doublet for the major forms of transthyretin which may arise from polymorphism.

FIG. 3A shows the impact of sample size on peak height ratios. The amount of plasma extracted was plotted as a function of the peak height ratio. The values shown represent the averages of 6 determinations made with one sample. Standard deviations were similar to those shown in Table 3 but are omitted from in order to enhance clarity of the graph. C′/CI (closed circle), CIII0/CIII1 (closed diamond), CIII2/CIII1 (closed square), CIII2′/CIII1 (closed triangle), CIII1 /CI (open circle), CII/CIII1 (open triangle), CII/C1 (open square), TTr-SH/CIII1 (open diamond), TTr-Cys/TrA (open inverted triangle).

FIG. 3B shows the impact of laser power on peak height ratios. Laser power settings used are shown. The values shown represent the average of 6 determinations. Error bars are omitted to enhance clarity of the graph. The higher power (lower attenuation) provided approximately 6-fold higher signal intensity than the lower power setting. 6433/6631 (open circle), 8765/9422 (open square), 9711/9422 (open diamond), 9640/9422 (open triangle), 9131/9422 (open inverted triangle), 8915/9422 (closed circle), 9422/6631 (closed square), 13881/13765 (hatched open square), 13765/9422 (closed diamond), 8915/6433 (closed triangle).

FIG. 4A shows a composite analysis of protein profiles by peak area and peak height and the impact of sample storage plus freeze-thaw cycles. The composite spectra for each of 6 samples obtained from subject 1 over a 2-year period were analyzed. The average and standard deviation of peak heights (open bars) of these spectra is compared with the peak area (solid bars) obtained from the same spectra. A second set of spectra were obtained after a 4-month period of storage with up to 10 freeze-thaw cycles. Peak intensities were calculated (gray bars).

FIG. 4B shows a comparison of subject 1 with subject 2. The spectra from subject 1 in FIG. 4A (open bars) is compared with the average (gray bars) and standard deviation of 6 samples from subject 2, which were obtained over a 4-month period. Peaks that are significantly different for the two subjects (p<0.05) are indicated by an asterisk.

FIG. 5A shows the values of a homologous peak ratio obtained for the group of 18 individuals (m/z 9713/9422).

FIG. 5B shows the values for a heterologous peak ratio of the group of 18 individuals (9422/6631).

FIG. 6A illustrates two measurements of the 9422/9713 peak ratio made for 9 individuals at age 13 and again at age 19. Each symbol and line represent a different individual.

FIG. 6B illustrates the 6631/6433 peak ratio for 9 individuals at ages 13. and 19. Each symbol and line represent a different individual.

FIG. 6C shows the 9422/6433 peak ratio for nine healthy individuals at ages 13 and 19. Each symbol and line represent a different individual.

FIG. 7 shows the peak ratio (y-axis) for 6631/6433 for individuals 1 (X) and 2 (solid squares) over a 24-hour period (x-axis) of a normal day. The ratio for these individuals was also determined 2 weeks later (Individual 1=open triangle; individual 2=solid diamond). The results illustrate the stability of individual 1 and the variability of individual 2, both over a day and over weeks. The noon meal was eaten just after the 3 hour time point.

FIG. 8 shows the peak ratio (y-axis) of 9422/6433 over a 24 hour period (x-axis) for individual 1 (solid diamonds) and individual 2 (solid squares). Samples were also taken two weeks later for individual 1 (X) and individual 2 (open squares). The results show the variability of individual 2 and constancy of individual 1 over one day and over longer times.

FIG. 9 shows the peak ratio (y-axis) of 9422/9713 for 6 individuals, two taken on different occasions, once in a full 24-hour measurement (x-axis) and another over a 5-hour time period. High values for this ratio (>3.1) are associated with individuals who demonstrate insulin resistance. This peak ratio does not appear to change dramatically in response to a meal (immediately after 0 time, 12 noon) individual 1-full day (solid square), individual 1-short day (open square), individual 2-full day (solid diamond), individual 2-short day (open diamond), individual 3 (open circle), individual 4 (closed circle), individual 5 (X), individual 6 (small dot).

FIG. 10A shows the peak ratio (y-axis) of 9422/6433 response to a meal over time (x-axis) (taken just after 0 time). Individuals 5 and 6 gave a slight change and returned to the original values by 5 hours indicating a healthy response. Individual 1 overcompensated for the meal and returned to lower value at 5 hours. Individuals 2, 3 and 4 showed a substantial increase in this peak ratio that was not corrected by 5 hours. Similar outcomes were observed for the 6631/6433 peak ratio. Individual 1 (closed diamond), individual 2 (solid square), individual 3 (solid triangle), individual 4 (X), individual 5 (open triangle), individual 6 (solid circle).

FIG. 10B shows the 6631/6433 peak ratio for the same individuals presented in FIG. 10A. Individuals 1 5 and 6 are shown in the open diamonds, squares and triangles, respectively, while individuals 2, 3 and 4 are represented by the solid squares, triangles and diamonds, respectively.

FIG. 11 illustrates a change in protein ratio (delta value, y-axis) at 5 hours after a meal. The six individuals described in FIG. 9 consumed the same meal. The ratio of m/z=6631/6433 was determined before the meal and at 5 hours after the meal. The value at 5 hours was divided by the value before the meal and 1.0 was subtracted to give the ‘delta value’, effectively the fractional change in peak ratio. The same procedure was carried out for the 9422/6433 peak ratio. The sum of the delta values (closed diamonds) for these two ratios is shown. Individuals 1, 5 and 6 show a healthy response with full return to the original protein profile at 5 hours and slight overcompensation by individual 1. Individuals 2, 3 and 4 show an unhealthy response with failure to return to the original ratio at the 5-hour time point.

FIG. 12 shows a comparison of one peak ratio (m/z=6631/6433) for thin insulin sensitive adults (solid diamonds=females, and solid triangles=males) with thin insulin resistant adults (Open squares=female, solid squares=males). Samples were taken after an overnight fast.

FIG. 13 illustrates significant differences between the four quadrants for adults (thin insulin sensitive (left to right hatching), thin insulin resistant (right to left hatching), obese insulin sensitive (horizontal hatching), obese insulin resistant (no hatching)). The groups are indicated by as in the legend. Highly significant difference (p<0.01) of the peak ratio relative to the obese insulin resistant population are shown by double stars while highly significant difference relative to the thin-insulin sensitive group are shown by double asterisk. Significant differences (p<0.05) are indicated by a single star or asterisk.

FIG. 14 shows the comparison of thin-insulin resistant adolescents with thin-insulin resistant adults for the 6631/6433 peak. (Adolescents=solid diamonds, solid squares=adult females, solid triangles=adult males).

FIG. 15 illustrates significant differences in peak ratios for adolescents. Average values for peak ratios in the four quadrants for adolescents are shown (thin insulin sensitive (left to right hatching), thin insulin resistant (right to left hatching), obese insulin sensitive (horizontal hatching), obese insulin resistant (no hatching)). Highly significant difference (p<0.01) of the peak ratio relative to the obese insulin resistant population are shown by double stars while highly significant difference relative to the thin-insulin sensitive group are shown by double asterisk. Significant differences (p<0.05) are indicated by a single star or asterisk.

FIG. 16 shows change in the 6631/6433 peak ratio for individuals who were obese and insulin resistant between ages 13 and 19. Each symbol and line indicates a different individual. Change for this group contrasted with the stability of thin insulin sensitive individuals shown in FIG. 6.

FIG. 17A shows the 6631/6433 peak ratio (vertical axis) as a function of fasting glucose plus two times fasting insulin levels of each individual (horizontal axis). Six categories of persons are shown, those with low fasting blood glucose (<105 mg/dL) and BMI less than 25 (solid diamonds), those with low fasting glucose and BMI >30 (X), those with intermediate blood glucose (>105<115 mg/dL) and BMI<25 (open triangles), those with intermediate blood glucose and BMI>30 (open diamonds), those with high glucose (>115 mg/dL) and BMI<25 (Solid triangles) and those with high glucose (>115) and BMI>30 (Solid squares). The solid line is best fit to the data for the thin individuals with low fasting glucose levels (<105 mg/dL). The equation fit to the line by Excel program is given along with the R squared value for this line.

FIG. 17B shows a plot of-ln(6631/6433/(1+6631/6433)) (vertical axis) versus fasting glucose plus two times fasting insulin level (Horizontal axis) for the same groups in FIG. 17A. The straight line is a linear fit to the data for individuals with low blood glucose (<105 mg/dL) and BMI<25. The equation for the line and R squared value for the line are given on the plot.

FIG. 18A shows peaks from one individual that are produced by dithiothreitol reduction of plasma followed by profile analysis. M/z values for these polypeptides are shown.

FIG. 18B shows peaks from a different individual that are produced by dithiothreitol reduction of plasma followed by profile analysis. It is clear that different individuals have very different peak ratios. M/z values for these polypeptides are shown.

FIG. 19 shows the peak ratio of m/z=8563/8692, obtained after DTT reduction of plasma, for 10 thin insulin sensitive individuals and for 10 each of Thin-Insulin resistant, Obese insulin resistant and Obese-insulin sensitive individuals. The solid horizontal lines indicate the average for each population. The populations were significantly different (p<0.02).

FIG. 20A shows a protein profile after umbilical cord blood (UCB) transplantation that was obtained at day +30 from a patient without graft versus host disease (GVHD). The profile falls within the values for healthy individuals.

FIG. 20B shows a protein profile after umbilical cord blood (UCB) transplantation that was obtained at day +30 from a patient suffering from severe intestinal GVHD. The inset shows the transthyretin (TTr) region from another transplant patient who experienced graft vs. host disease.

FIG. 21A illustrates glycosylation state versus survival of patients with graft versus host disease (GVHD). The ratio of 9713/9422 peaks were calculated and shown as a function of time after transplant. The value at later times was divided by the value before transplant so that the ratios represent change from the individual's normal profile. It is apparent that high and increasing levels of the hyper-glycosylated form of apolipoprotein CIII represent a biomarker of disease. Surviving individuals showed recovery of a normal distribution for glycosylation. A similar pattern was obtained for the 9713/8765 peak ratio from these individuals. Individual 1+GVDH (solid diamond), Individual 2+GVDH (solid triangle), Individual 3+GVDH (solid circle), Individual 4+GVDH (solid square with x), Individual 5+GVDH (solid square), Individual 3-no GVDH (*), Individual 4-no GVDH (open diamond), Individual 5-no GVDH (open circle), Individual 6-no GVDH (open triangle), Individual 7-no GVDH (open diamond), Individual 8-no GVDH (+).

FIG. 21B shows the absolute ratios for individuals who developed GVHD. The values are the same as in FIG. 21A but are expressed without reference to the individual's profile before BMT. The dashed lines show the upper and lower values for these individuals before BMT. Individual 1+GVDH (closed diamond), Individual 2+GVDH (closed square), Individual 3+GVDH (closed triangle), Individual 4+GVDH (X), Individual 5+GVDH (*), low Normal (dashed line), high normal (dashed line with +).

FIG. 22A shows a mild response to endotoxin (lipopolysaccharide (LPS)). Time is relative to LPS administration. Peak ratios are given. 6433/6631 ratio (solid circles), 8915/9422 ratio (diamonds), 13765/13881 (inverted triangles).

FIG. 22B shows a radical response to endotoxin (LPS). Time is relative to LPS administration. Peak ratios are given. 6433/6631 ratio (diamonds), 8915/9244 ratio (solid circles), 4150/6631 (open squares), 13761/13880 (inverted triangles).

FIG. 23 shows a protein profile of one of six individuals who exhibited a large change in protein profile upon exposure to endotoxin (LPS).

FIG. 24A illustrates the ratio of 9713/9422 for 6 individuals with high response to endotoxin versus six who had a low response to endotoxin (LPS). High response-Individual 14 (closed diamond), High response-Individual 3 (closed circle), High response-Individual 20 (closed triangle), High response-Individual 21 (closed small square), High response-Individual 31 (closed large square), High response-Individual 19 (open circle), Low response-Individual 23 (X), Low response-Individual 24 (open square), Low response-Individual 26 (+), Low response-Individual 28 (*), Low response-Individual 29 (open diamond), Low response-Individual 32 (open triangle).

FIG. 24B shows the relative response of the 9713/9422 peak to low dose endotoxin (LPS). The individuals in solid symbols all displayed extreme oxidation in their protein profiles at the 8 hour time point while the open and other symbols did not display this large oxidative change. High response-Individual 14 (closed diamond), High response-Individual 3 (closed square), High response-Individual 20 (closed circle), High response-Individual 31 (closed triangle), High response-Individual 19 (closed small square), Low response-Individual 23 (open circle), Low response-Individual 24 (*), Low response-Individual 26 (+), Low response-Individual 28 (X), Low response-Individual 29 (open triangle), Low response-Individual 32 (X).

FIG. 25A shows the expression of serum amyloid A (SAA, 11697 and 11545) as well as the isoforms of transthyretin at 8 hours after endotoxin (LPS) administration. SAAI appears at m/z=11681 and its protease digestion product appears at 11524.

FIG. 25B shows serum amyloid A (M/z=11524 and 11681) and transthyretin isoforms at 24 hours after endotoxin administration.

FIG. 26A shows the relationship of the m/z=4150 peak, expressed as its ratio to the 6631 peak, component to TTrSH content. TTr-SH/TTr-Cys (solid circles). 4150/6631 (inverted triangles) for subject 2.

FIG. 26B shows the relationship of the m/z=4150 peak, expressed as the ratio of 4150/6631, and the TTrSH component, expressed as the ratio of m/z=13765/13881 for subject 1. 13765/13881 (solid circles), 4150/6631 (inverted open triangles).

FIG. 27 shows the m/z=6433/6631 and 8915/9422 ratios for a subject that were collected over a two-year period. (inverted triangles represent the 8915/9422 ratio, solid circles represent the 6433/6631 ratio).

FIG. 28 shows the protein profile of cerebral spinal fluid obtained from a patient with tumor hydrocephaly.

FIGS. 29A and 29B show the MALDI-TOF profile (in two sections) of BALF proteins in successful transplant patient.

FIGS. 29C and 29D show the protein profile (in two sections) from a lung transplant patient who developed chronic lung transplant rejection within 5 months.

FIG. 30 shows the relationship of HNP in BALF to future development of chronic lung transplant rejection. The solid horizontal line at 0.3 gives the optimum level for prediction of chronic lung transplant rejection within 15 months. The solid horizontal line at 6.0 shows a level above which the probability of developing BOS is virtually 100%.

FIG. 31 shows diagnosis of future development of chronic lung transplant rejection diagnosis by the protein profile using the HNP peak intensity at 3371 divided by the sum of peaks characteristic of healthy lung proteins. The horizontal line at 3.0 shows the optimum cutpoint for diagnosis of future disease. The upper horizontal line shows the value above which the individual is virtually guaranteed of developing BOS.

FIG. 32 shows diagnosis of future chronic lung transplant rejection on the basis of the ratio of the intensity of the Clara Cell protein (m/z=15835) to lysozyme (14700). The middle horizontal line shows the optimum cutpoint for diagnosis while the upper line shows the value above which no BOS will be experienced in 100 months and the lowest horizontal line shows the value below which BOS is virtually guaranteed.

FIG. 33 shows diagnosis of future development of BOS by the ratio of the sum of protein peak intensities of peaks found in disease divided by the sum of peaks characteristic of healthy lung. The middle horizontal line shows the optimum cutpoint for diagnosis, the upper horizontal line shows the ratio above which BOS within 15 months is virtually guaranteed and the lowermost horizontal line is the value below which the individual is very unlikely to develop BOS within 100 months.

FIG. 34 shows diagnosis of future development of BOS on the basis of combination of the peaks listed in FIGS. 31 to 33.

FIG. 35A shows the total score for the peaks shown in FIGS. 31 to 33 as a function of time before BOS for those individuals who develop BOS within 15 months.

FIG. 35B shows the total score for sequential samples from individuals who do not develop BOS in 100 months. The inset shows an expanded view of the results.

FIG. 36 shows polymorphisms for different isoforms of ApoCI (Panel A) and ApoCIII (Panel B). The isoforms of the protein share nearly all of the same amino acid sequence but differ to a small degree, usually a single amino acid difference, resulting in a doublet for each isoform of the protein given in Table 1 that differ by the mass difference of the amino acids in the two proteins.

FIG. 37A shows a mass spectrometric profile of a plasma extract from plasma in H₂O.

FIG. 37B shows a mass spectrometric profile of a plasma extract from D₂O.

FIG. 37C shows a mass spectrometric profile of a plasma extract from from an equal mixture of the samples in FIG. 37A and FIG. 37B.

FIG. 38A and FIG. 38B show deuterium labeling of proteins in bronchoalveolar lavage fluid (BALF). FIG. 38A shows a portion of the profile with a mixture of a sample in H₂O to one in D₂O (ratio=0.25:1.0). FIG. 38B shows the same samples but in a equal mixture. Peaks from H₂O are the lower of the paired peaks and the corresponding protein from the D₂O sample are the higher mass of the paired peaks.

FIG. 39 shows H:D peak intensity ratios for combined samples as a function of D₂O/H₂O.

FIG. 40 shows a protein profile of urine of a healthy adolescent male. The spectrum is provided in two sections with the m/z values indicated.

FIG. 41 shows a protein profile of urine of a healthy adult male. The spectrum is provided in two sections with the m/z values indicated.

FIG. 42 shows profiles of urine from persons with advanced kidney disease vs. controls. The different panels A, B, C and D represent different regions of the profile at the m/z values shown at the bottom of the panels. Each panel included profiles of both the disease and controls, which are are offset for clarity. The upper tracing in each panel is from the disease group and the lower from the controls. Intensity is expanded to fill the panel and is not comparable between panels.

FIG. 43 shows urine profiles from persons with disease (top profile) and healthy controls (bottom profile).

FIG. 44 shows urine MALDI-TOF profile analysis. Group I consists of 3 healthy persons who donated multiple urine samples over periods of 1 to 27 months. The data points show the average and standard deviation for the samples from each. Group 2 consists of 25 healthy persons who had been approved to serve as kidney donors. Group 3 are kidney transplant recipients who showed no adverse response. Group 4 are 10 individuals who displayed adverse response to kidney transplant but for whom biopsy indicated no rejection. Only 4 ratios are visible, one is off the top of the scale at 5.4 and 5 samples gave no detectable intensity for these components.

FIG. 45 shows protein profile scores from successful transplant recipients at one month (solid symbols) or at 1 year (open triangles) as a function of creatinine levels in the urine. Scores are 0 for no stress biomarkers, 1.0 for biomarkers of minor stress (beta 2 microglobulin, m/z=4302 peak or HNP) and 2.0 for serious profile abnormalities.

FIG. 46 shows MALDI-TOF profiles of two healthy individuals compared from m/z=1000 to 2000 (upper panel) and 14,000 to 16000 (lower panel); in both cases the profile of individual 2 is offset by increasing intensity in order to allow better comparison of the two profiles.

FIG. 47 shows oxidized profiles from individuals with Hepatitis C before therapy. Panels A to C represent an individual with one of the lowest levels of oxidation observed showing little oxidation of ApoC1 (panel A), equal intensity of the different oxidation states of ApoC3 (panel B) and severe oxidation of TTr (panel C). Panels D and E show oxidation states for ApoC1 (Panel D) and ApoC3 (Panel E) in an individual with a higher level of oxidation.

FIG. 48 shows oxidation and intensity of apolipoprotein CII (m/z=8915±0.1%) and the components at m/z=8680 and 8811 (±0.1%). Apolipoprotein CII occurs at m/z=8915 with two oxidized states, at 8931 and 8947. The components at m/z=8811 and 8680 are frequently observed in healthy individuals. However, peaks adjacent to these components at m/z=8827 and m/z=8696 are new and intense in samples with high (panel A), intermediate (panel B) and low oxidation (Panel C) due to hepatitis C.

### DETAILED DESCRIPTION OF ILLUSTRATIVE EMBODIMENTS

The current invention relates to the discovery that protein profiles obtained from healthy subjects are very constant and reproducible over time. The normal expectation for protein distribution is that healthy persons will display a range of protein concentrations or ratios and that diseased persons display a different range. In this model, diagnosis of disease is accomplished by discovery that a protein concentration or series of protein concentrations are outside of the normal range and corresponds to the range of values observed in disease. Inherent in this model is that healthy persons can vary in protein concentration or profile, but as long as they fall within the range for healthy persons, they do not have pathology detectable by this diagnosis. Thus, the expectation for the classical model for diagnosis contains the assumption that normal individuals can vary widely within the range for healthy individuals without disease.

This expectation is illustrated by a recent request for applications from the National Institutes of Health (March 18, 2004). This announcement (PAR-04-076) describes that NIH will provide the investigator with 30 samples, 10 from healthy persons, 10 from persons with impaired glucose tolerance and 10 from persons newly diagnosed with type 2 diabetes. NIH requests that investigators analyze the proteins of these samples to determine protein concentrations that are characteristic of diabetes or pre-diabetes type 2. The request for applications therefore demonstrates the expectation that disease can be monitored by proteins observed at one time in an individual. It is based on the assumption that individuals with disease or pre-disease will differ from the healthy population when the samples are taken under similar conditions.

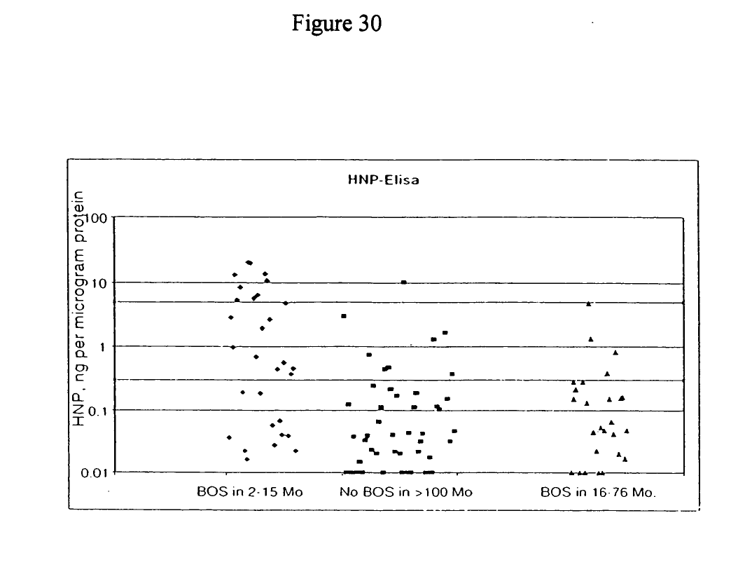

The invention described herein demonstrates that protein profiles can be used to distinguish diseased individuals from healthy subjects, such as those described in Examples VI, X, other examples. For these cases, this invention describes a novel method for determining protein concentration and ratio, but the concept conforms to the global expectation for diagnosis of disease by protein analysis with comparison to the range for a healthy population versus a diseased population. For other cases, such as insulin resistance as described in Example III, the method can distinguish populations of healthy and disease persons from one another by a single protein profile. However, like most attempts to diagnose disease by observation of a concentration, there is often overlap between the disease population and the healthy population. This overlap produces false positive and false negative readings. The extent of false positive and false negative readings is illustrated by Example XI, FIG. 30. While HNP is a relatively good biomarker of disease, 14% of those who did not develop disease within 100 months were classified as positive while 40% of those who developed disease within 15 months were classified as negative. This assay provides a favorable analysis, but is typically incomplete. Methods to enhance specificity and selectivity of an assay are greatly needed.

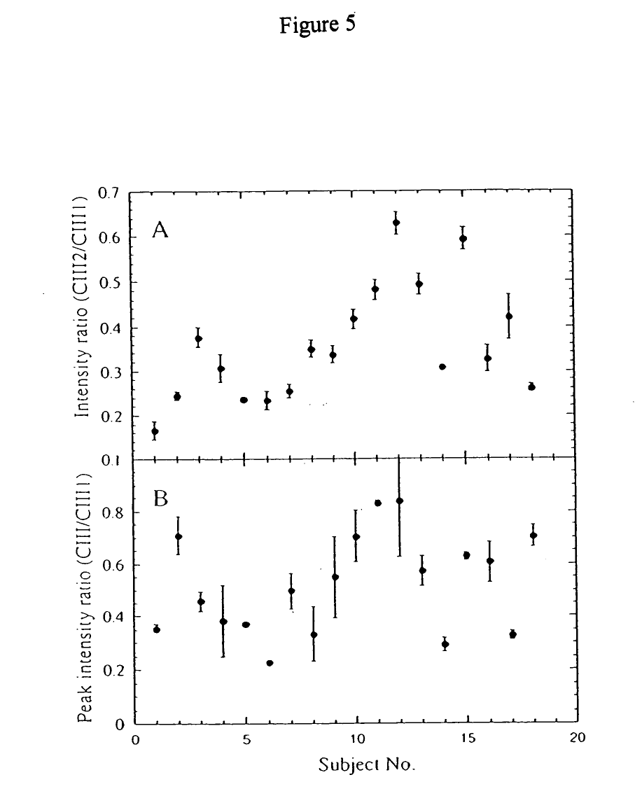

The novel concept of stability of the proteome profile within a very narrow range for each individual provides a great value-added concept, making diagnosis much more specific, sensitive and selective. An example of this increased sensitivity is provided by the peak ratio for 9713/9422. The normal range for this ratio is approximately 0.2 to 0.8 (see FIG. 5A), a 4-fold range. The classical comparison of populations would suggest that any person within this range is healthy. However, individual ratios taken under similar conditions are stable within the limits of detection, approximately ±5 to 10%. Consequently, detection of disease by comparison to a person's personal proteome profile is 40 to 80 times more sensitive (4-fold versus 0.1 or 0.05). For an example of increased sensitivity, a stable proteome pattern for each individual allows the detection of disease in cases where none of the observed protein concentrations or profiles deviate from the values observed among healthy individuals. In Example VII, a person whose normal personal value for the ratio of the m/z=9713/9422 peaks is 0.28 will be characterized as unhealthy if that value raises to 0.35, despite the fact that the range of values observed for this peak in healthy individuals is at least from 0.15 to 0.8. In another case, the value of the ratio of m/z=9422/6433 in individual 3 of Example II is 1.2 and rises to 1.7 at 5 hours after a meal. Both values fall within the range of values observed in healthy individuals. However, the failure of this individual to return to that individual's stable level by 5 hours after the caloric intake constitutes a diagnosis of disease or pre-disease. The use of the standard paradigm to detect disease from the steady state value of this parameter relative to that of the entire healthy population will miss the diagnosis entirely.

There are tests outside of the proteome research field that detect change that arises from a stimulus. However, classic examples differ from the current invention in numerous ways. Examples that can be cited include the glucose tolerance test and immune response to a skin test. While neither of these tests involve a protein profile, they do illustrate examples of diagnosis due to a stimulus in other fields. In these cases, diagnosis is based on a change that alters a person's glucose level or skin properties to a condition that deviates from the range of values for healthy persons. In the one case, glucose levels are higher than the range for healthy individuals after a glucose intake challenge that is given under specific conditions. In the other case, the person develops a skin reaction that is unlike any found in the healthy population. These assays differ conceptually from the teaching concepts of this invention, since the objective in these examples is to detect a status that is outside the range of values for healthy individuals, whether that status is due to a stimulus or is observed at one point in time. Diagnosis of disease from change in proteome pattern alone, in which the individual may or may not deviate from the range of values for normal individuals, is therefore unique to several diagnostic aspects in this invention. This global methodological concept is in addition to the novel features of the actual methods developed to diagnose proteome pattern that are described herein and to the use of these methods to detect proteome patterns that are truly outside of the range found for normal individuals. In the latter cases, the invention provides a method for sample preparation and analysis, with the results being interpreted by the standard paradigm for diagnosis by disease markers.

Change in proteome pattern in response to a stimulus also increases the specificity of the assay. For example, several conditions may produce the same change in the protein profile. Individual 2 in Example II showed a highly variable value for the m/z=6631/6433 peaks (also observed as 6632/6434 depending on the instrument and conditions) on two different dates. Individual 1 of Example II showed high stability for this ratio for all times except an occasion characterized by a low-grade fever (e.g., Example VIII) when this ratio (expressed as m/z=6433/663 1) changed to become similar the values observed for persons characterized by obese, insulin resistance (Example III). In Example III it is shown that obese insulin resistant individuals display a high value for m/z=6631/6433. Thus, variability in this peak ratio or deviation of this value from the range of values for healthy individuals, for this and many other peak ratios, can indicate a low health status but will not identify the specific health status that is affected. In the same way, variation of a profile over time, for no apparent reason, is a diagnosis of disease or the propensity to develop disease, but does not necessarily identify the disease itself. Knowledge that a person has a low health status is valuable and can encourage the health care worker to continue diagnosis in order to identify the disease responsible for instability of the protein profile or for an abnormal profile. Such non-specific markers of disease are valuable to the health care field but are not as valuable as specific markers of a disease. In fact, change in a profile can be made to be a marker of a specific disease if that change is measured in response to a specific stimulus. Example II shows that change in response to caloric intake creates change in several peak ratios. Since this evaluation was conducted on one day, when all other health considerations were constant, the profile change becomes specific for metabolic disease associated with caloric intake, or with the propensity to develop such metabolic disease. The same change in response to a fever creates a specific diagnosis related to the fever and not to diabetes.

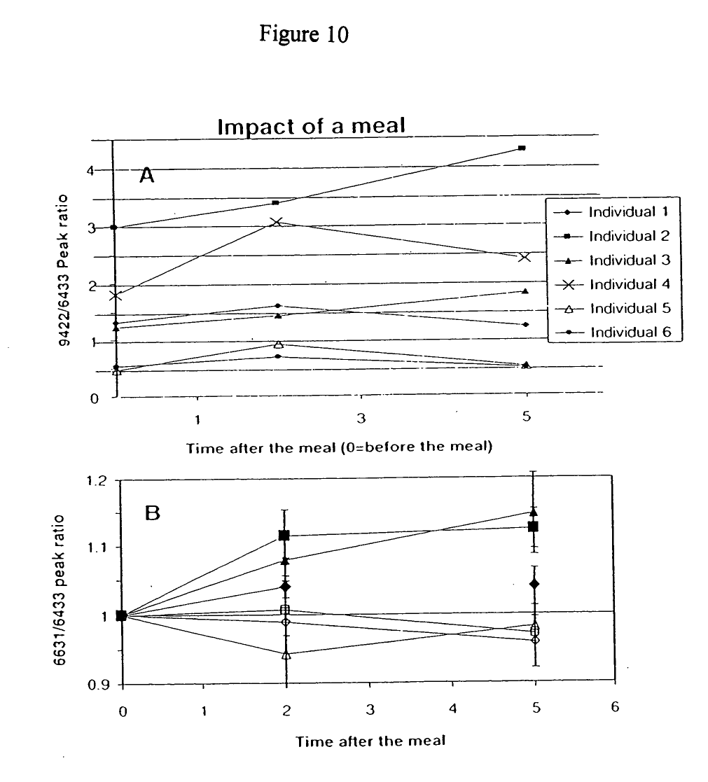

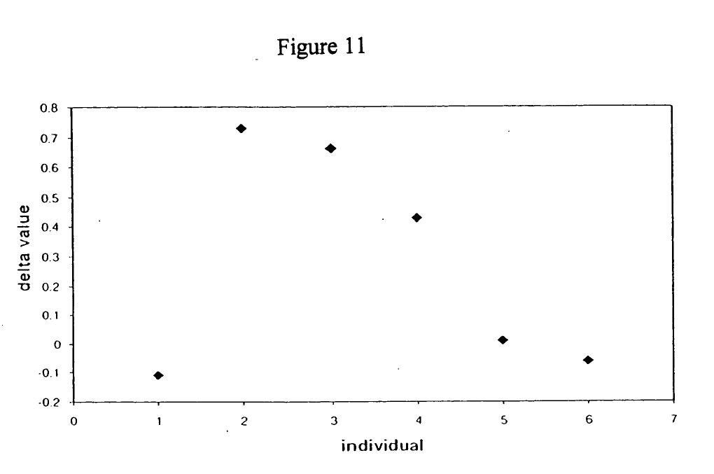

Change in a profile that is due to a specific stimulus increases the sensitivity in other ways. For example, comparison of obese-insulin resistant individuals with thin-insulin sensitive individuals under one condition (Example III) showed highly significant differences between the populations of individuals. However, there was often overlap of values in some members of the two populations. This is often the case due to variability within a diverse human population. For example, examination of 10 thin insulin sensitive individuals suggests that the ratio of this peak falls within 0.2 and 0.8. However, it is possible that examination of a larger population will find healthy individuals with peak ratios outside of this range. Such individuals would be incorrectly identified as diseased, and result in false positive identification. Others who have disease may demonstrate values within the normal range. In other words, the overlap between normal and diseased individuals produces false positive and false negative diagnoses, a major challenge for diagnosis of disease. The invention described herein can be used in this fashion but also adds the concept that a wide range of values is expected for the personal profile of healthy individuals but that failure to maintain that person's healthy profile is actually a superior diagnosis. This is illustrated in Example II, FIG. 10, where healthy and non-healthy responders have overlapping profiles at zero time. The diagnosis is achieved by change after caloric intake where the difference between individuals is very large when analyzed by any of several criteria (see, e.g., Example II, FIG. 11).

Change in a protein profile can also be used to monitor specific disease states such as autoimmunity, asthma, or other episodic diseases. In this case, the protein profile is taken when the individual is not experiencing an episode and that profile is compared to one that is taken when the individual is experiencing an episode. The non-episodic sample can be taken before or after the episode. In this case, the individual must monitor other health conditions to ascertain that other events are not responsible for differences in the protein profile. This will be less preferred to monitoring change on one day and due to an administered stimulus under controlled conditions, but is still highly valuable as a stimulus response of the protein profile. The severity of change in the profile during an episode can indicate the seriousness of the episode.

This discovery described herein substantiates the use of protein profiles for numerous purposes that include, for example, the diagnosis of disease, determination of a predisposition of an individual to develop a disorder, screening methods to identify agents that reduce or ameliorate the symptoms of a disorder, and the like. While these applications are described in connection with human subjects, it is to be understood that veterinary uses are also contemplated. For example, feline diabetes is a common affliction in cats that can be detected and monitored in accordance with the invention.

In some examples, an inexpensive and widely accessible extraction procedure was used to obtain MALDI-TOF protein profiles of human plasma. The profiles were extremely reproducible with standard deviations of 2 to 20 percent. Most of the protein peaks were identified. The results provide proof of principle for several properties of the proteome. As expected, detectable changes in the protein profile occurred in cases of disease, such as sepsis. Another aspect of the invention is that a personal and unique profile that distinguishes each person from others can be produced. Maintenance of a constant personal protein profile may be a characteristic of health, and change of the protein profile may signify disease, even though an altered profile may remain within the range attributed to other healthy individuals. The characteristic protein profile of each individual may be based on genetic and environmental factors and may form one basis for development of individualized medicine.

In some examples, Zip Tip extraction of diluted human plasma was combined with Matrix assisted laser desorption ionization-time of flight mass spectrometry to produce highly reproducible protein profiles. Examples of components that were detected included apolipoproteins CI, CII and CIII, as well as transthyretin and several isoforms of each protein that are created by glycosylation or other modification and by proteolytic processing. Profiles of normal individuals contained 15 identified components. Up to 24 identified components and many unidentified components were found in plasma from individuals with disease. The profiles of two individuals, obtained from samples collected over a several month period, were highly consistent, suggesting a personal protein profile determined by genetic and environmental factors. The existence of unique, personal profiles was also indicated by comparison of 18 individuals, all of whom could be distinguished from one another by as few as 5 peak intensity ratios. A stable protein fingerprint is thought to be useful for detecting various diseases, either from a radical profile change that correlates with a particular disease, or from a minor change in a personal profile, which may suggest loss of homeostasis. A personal protein profile is thought to apply to numerous proteins and provide a basis on which to establish individualized medicine.

### Sample Preparation

Surprisingly it has been found that MALDI-TOF can be conducted on a biological fluid, for example blood, plasma or serum, without preprocessing the sample. Blood is drawn from a subject, and optionally fractionated into a component fluid such a plasma or serum. Blood, serum or plasma can alternatively or additionally be fractionated by affinity chromatography, yielding an affinity-purified fraction such as the affinity-purified lipoprotein fraction of blood. The sample does not need to be further processed to remove one or more components such as salt, proteins or lipids, as was heretofore commonly believed. In other words, purification processes such as chromatography, dialysis, ultrafiltration, electrophoresis and the like are not necessary; the sample can comprise crude or raw fluid obtained from the subject. Preferably, the biological fluid is diluted prior to analysis; e.g., a 25 nL sample of blood can be diluted with water or buffer to about 200 nL. The diluted sample can be directly analyzed without further processing using MALDI-TOF, and at least one of the resulting mass spectrometry peaks is analyzed as described herein.

In another embodiment, the biological fluid is preprocessed prior to analysis. The sample containing the biological fluid is minimally preprocessed, preferably using a single, rapid fractionation step, such as chromatography, electrophoresis, dialysis, and the like. The preprocessing step typically takes no more than three minutes. In a preferred embodiment, preprocessing of the sample is accomplished using reverse phase chromatography, for example using a C4 ZIPTIP pipette tip available from Millipore, Inc. Other suitable hydrophobic chromatography units are available up to a carbon length of C18. Any can be used as long as they reveal the components described herein.

Prior to the present invention, it has been standard procedure to process biological fluids prior to subjecting them to MALDI-TOF mass spectrometry. Blood has a high protein content, and the conventional wisdom has been that high abundance proteins (such as albumin) should be removed from the sample prior to MALDI-TOF analysis in order for low abundance proteins to be observable. Likewise, it was believed that salts need to be removed or sodium ions would bind to the mass fragments instead of protons, complicating (e.g., by smearing) the resulting mass spectrometric profile by adding 22 amu per ion instead of 1.

### Biological Fluids

Biological fluids that can be analyzed according to the invention include, without limitation, blood (whole or fractionated), plasma, serum, urine, saliva, cerebral spinal fluid, semen, vaginal fluid, pulmonary fluid, tears, perspiration and mucus. Fractionated blood includes plasma and serum, as well as affinity-purified fractions such as the affinity-purified lipoprotein fraction of blood. Serum is present after clotting, and is essentially identical to plasma but it does not contain the components (such as fibrinogen) necessary for the clotting reaction to occur. Biological fluids analyzed according to the methods of the invention preferably include whole blood and its fractional components, such as plasma and serum.

### Mass Spectrometric Analysis

Typically, mass spectrometry peaks are analyzed by determining peak attributes such as peak heights and/or the area defined by the peak (relative to the baseline). Other measurable attributes may also be used, such as the ratio of height to width. When two peaks are compared, typically a ratio is determined, although in some cases differences in peak heights, areas etc. can be used for comparison. A peak ratio or difference can be determined at various points in time to monitor the progress of a treatment or the development of disease over time. As noted elsewhere herein, comparisons made over time within the same individual have much greater diagnostic value than comparisons between and among different individuals.

### Preparation of a Protein Profile

The invention provides a method to extract and analyze proteins from a biological sample that involves obtaining a biological sample from an organism and then determining the protein profile of the sample.

Numerous types of samples can be obtained from an organism to produce a protein profile. Examples of biological samples include blood, serum, plasma, urine, saliva, tissue, cerebral spinal fluid, semen, vaginal fluid, pulmonary fluid, tears, perspiration, mucus and the like. The source of the sample may be cells or tissues from an organism that have been treated ex vivo and profiles obtained from cell extracts or the preserving solution used to bathe the cells.

The source of a biological sample used to produce a protein profile can be selected based on the information that is to be obtained from the protein profile. For example, urine may be used to produce a protein profile to determine if a patient is undergoing rejection of a kidney transplant. In another example, serum may be analyzed to diagnose or predict if a patient is undergoing, or will develop, graft versus host disease. Thus, in some instances, the source of a biological sample may be selected to test for a specific condition or disease.

Biological samples may be obtained from many types of organisms that include prokaryotes and eukaryotes. Examples of such organisms include, but are not limited to, birds, reptiles, mammals, amphibians and fish. Examples of specific types of organisms include humans, dogs, cats, cattle, horses, pigs, sheep, goats, camels, donkeys, lions, tigers, bears, zebras, giraffes, and the like. Accordingly, the methods of the invention may be applied for the diagnosis and treatment of humans and animals.

A biological sample can be selected such that the sample size and method of extraction or purification are consistent to increase reproducibility of the protein profiles produced from the samples. High precision and reproducibility is a factor for producing a personal protein profile for an individual. In some examples, biological samples are obtained from an organism and analyzed using the same protocol. In other examples, biological samples can be obtained from an organism and analyzed using different protocols. The discovery that the protein profile of an organism remains constant allows biological samples obtained from an organism using different methods to be compared. For example, a first protein profile can be prepared for a biological sample obtained from a first organism. The peaks within the first protein profile can then be analyzed by comparison to the first protein profile. Then, a second protein profile can be prepared for a biological sample obtained from a second organism. The peaks within the second protein profile can then be analyzed by comparison to the second protein profile. The result of the first analysis conducted on the first protein profile can then be compared to the result of the analysis conducted on the second protein profile due to the discovery described herein that the protein profile of an individual stays constant under normal conditions.

A biological sample may be fractionated through use of numerous protocols known in the art. Examples of such protocols include, but are not limited to, chromatography, immuno-separation, adherence, adhesion, and the like. In one example, a ZipTip is used to fractionate proteins from serum that are then analyzed by mass spectroscopy. Use of this method has allowed a biological sample to be collected and a protein profile prepared in a period of about 15 minutes, although optional incubation steps may lengthen this time. In another example, a biological sample is applied to a reverse phase support and washed to leave proteins bound to the support and to wash away other components of the biological sample. The proteins bound to the support are then eluted from the support and used to prepare a protein profile. In another example, a biological sample may be immuno-separated by applying the biological sample to a support to which antibodies or peptide aptamers are bound that bind to specific components, such as proteins, contained within the biological sample. The support containing the bound proteins is washed to eliminate unbound components of the biological sample and then the bound components can be eluted and used to prepare a protein profile.

A protein profile may be prepared from a biological sample through use of numerous methods that include, but are not limited to, electrophoresis, chromatography, mass spectroscopy, isoelectric focusing, immunoassay, centrifugation, and the like. Numerous methods of separating proteins contained within a sample are known in the art and can be used within the methods of the invention. In one example, a biological sample can be applied to a denaturing polyacrylamide gel and subjected to electrophoresis. The proteins in the gel can be stained through use of Coomassie Blue or silver stain and then the gel can be scanned with a laser densitometer to prepare a protein profile. In another example, a biological sample can be applied to a velocity gradient and then subjected to centrifugation to separate proteins contained within the biological sample. The protein positions can be determined through fractionation of the gradient, or through use of optical methods, as are available on an analytical ultracentrifuge.

A protein profile may be prepared through use of many types of mass spectroscopy. Examples of mass spectroscopy methods include surface enhanced laser desorption/ionization spectroscopy, matrix assisted laser desorption/ionization spectroscopy (MALDI), delayed extraction MALDI, continuous electrospray, pulsed electrospray, ionspray, thermospray or massive cluster impact and a detection format that is linear time-of-flight, reflection time-of-flight, single quadrupole, multiple quadrupole, single magnetic sector, multiple magnetic sector, Fourier transform ion cyclotron resonance, ion trap, and combinations thereof. Use of mass spectroscopy, such as MALDI-TOF, allows a protein profile to be rapidly prepared and further allows individual proteins to be identified and quantified within a biological sample. The matrix used during MALDI-TOF analysis can include many types of suitable organic molecules, such as alpha-cyanocinnamic acid, dihydroxybenzoate, and any other type of material that can absorb energy from a laser and act as a matrix. The laser used may be a standard nitrogen laser as well as other types of lasers known in the art. Use of mass spectrometry, as described in the examples herein, produced typical standard deviations for a peak intensity ratio that were 2 to 10 percent. This compares favorably with a 2-fold to 4-fold range of peak ratios among the different subjects analyzed. As a result, it is now possible to distinguish the protein profiles of individuals from each other with as few as 5 peak intensity ratios. The personal profile of individuals was determined to stay constant over a period of several months, indicating that the protein profile of an individual has a strong resistance to change. In addition, it has been determined that an individual has a personal protein profile that characterizes the health status of that individual. It is thought that this protein profile is determined by genetic and environmental factors.

Numerous chromatographic methods may be used to prepare a protein profile from a biological sample. Examples of such methods include high pressure liquid chromatography, fast protein liquid chromatography, ion exchange chromatography, size exclusion chromatography, gel filtration chromatography, affinity chromatography, reverse phase chromatography, and the like. Chromatographic methods allow fractionation and preparation of a protein profile in one step and may therefore be used to rapidly produce a protein profile for an organism, such as a human.

A biological sample may be analyzed without being first purified or fractionated. For example, a biological sample be directly applied to an SDS-PAGE gel and electrophoresed. In another example, a biological sample may be analyzed by mass spectrometry without first being purified or fractionated. In other examples, a biological sample can be fractionated before the protein profile is prepared. For example, a biological sample that is blood may be fractionated to produce serum from which a protein profile is prepared. In another example, specific components of a biological sample can be separated from the biological sample through use of immunological methods and then used to prepare a protein profile.

A protein profile can be analyzed and compared through use of a variety of calculations that can be readily used by those of skill in the art. For example, a protein profile can be analyzed by comparing the peak height of an individual peak to the peak height of another individual peak. In another example, a protein profile can be analyzed by comparing the peak area of an individual peak to the peak area of another individual peak. In other examples, the peak height or area of an individual peak or combination of peaks may be compared to the peak height or area of an individual peak or combination of other peaks in the protein profile. The peak height or area of an individual peak or combination of peaks can be compared to the total area of all peaks or a combination of peaks in a protein profile. Different protein profiles can be compared to each other. For example, a protein profile prepared for an organism before the organism was contacted with a mediator can be compared to the protein profile prepared for the organism after the organism was contacted with the mediator. As described above, any combination of peak heights, areas, concentration, quantity, or combinations thereof can be calculated for the first protein profile and compared to the same calculation done on the second protein profile. Accordingly, the method of the invention includes any combination of calculations performed on one or more peaks within a protein profile that provides for the comparison of the one or more peaks to another peak or peaks in the same protein profile or a different protein profile.

In addition, any single peak or combination of peaks can be specifically excluded from a calculation used within the method of the invention. For example, use of the 6631/6433 and 9713/9422 peak ratios for diagnosis of hyperlipidemia by a single mass spectroscopy assay under a single condition can be specifically excluded. However, these peak ratios can be compared for purposes other than for the diagnosis of hyperlipidemia, such as for the diagnosis by response of an organism to a stimulus, such as food or other caloric intake.

Examples of peak ratios in a protein profile that can be prepared from human plasma through use of mass spectroscopy include, but are not limited to, peaks at m/z values within 0.2% of the following values: 2311, 2747, 2933, 3081, 3312, 3334, 3369, 3441, 3445, 3492, 4125, 4152, 4184, 4288, 4454, 4658, 4674, 4712, 4771, 4787, 4856, 4885, 4919, 4939, 5082, 6074, 6420, 6434, 6450, 6618, 6632, 6648, 6837, 6882, 6942, 7156, 8200, 8680, 8765, 8810, 8825, 8915, 8931, 8947, 9131, 9299, 9352, 9422, 9438, 9454, 9642, 9713, 9729, 9745, 9934, 10,400, 10430, 10,800, 10835, 11277, 11385, 11439, 11473, 11524, 11629, 11681, 11714, 11740, 11900, 11980, 12859, 13038, 13761, 13812, 13840, 13880, 13938, 14046, 14067, 14995, 15049, 15126, and 15886 including oxidized forms of these peaks containing one, two or three oxygen atoms covalently attached to the polypeptide chain or the corresponding +2 charged species of these components that appear at the m/z value for the singly charged species given above minus 1 divided by 2 plus 2. Additional examples of peak ratios (within 0.2% of the following values) that can be monitored within a protein profile include, but are not limited to, those having m/z values corresponding to 6632/6434, 7156/6434, 8200/6434, 8680/6434, 8765/6434, 8810/6434, 8915/6434, 9131/6434, 9351/6434, 9422/6434, 9640/6434, 9713/6434, 9934/6434, 13761/6434, 13841/6434, 13880/6434, 7156/6632, 8200/6632, 8680/6632, 8765/6632, 8810/6632, 8915/6632, 9131/6632, 9351/6632, 9422/6632, 9640/6632, 9713/6632, 9934/6632, 13761/6632, 13841/6632, 13880/6632, 8200/7156, 8680/7156, 8765/7156, 8810/7156, 8915/7156, 9131/7156, 9351/7156, 9422/7156, 9640/7156, 9713/7156, 9934/7156, 13761/7156, 13841/7156, 13880/7156, 8680/8200, 8765/8200, 8810/8200, 8915/8200, 9131/8200, 9351/8200, 9422/8200, 9640/8200, 9713/8200, 9934/8200, 13761/8200, 13841/8200, 13880/8200, 8765/8680, 8810/8680, 8915/8680, 9131/8680, 9351/8680, 9422/8680, 9640/8680, 9713/8680, 9934/8680, 13761/8680, 13841/8680, 13880/8680, 8810/8765, 8915/8765, 9131/8765, 9351/8765, 9422/8765, 9640/8765, 9713/8765, 9934/8765, 13761/8765, 13841/8765, 13880/8765, 8915/8810, 9131/8810, 9351/8810, 9422/8810, 9640/8810, 9713/8810, 9934/8810, 13761/8810, 13841/8810, 13880/8810, 9131/8915, 9351/8915, 9422/8915, 9640/8915, 9713/8915, 9934/8915, 13761/8915, 13841/8915, 13880/8915, 9351/9131, 9422/9131, 9640/9131, 9713/9131, 9934/9131, 13761/9131, 13841/9131, 13880/9131, 9422/9351, 9640/9351, 9713/9351, 9934/9351, 13761/9351, 13841/9351, 13880/9351, 9640/9422, 9713/9422, 9934/9422, 13761/9422, 13841/9422, 13880/9422, 9713/9640, 9934/9640, 13761/9640, 13841/9640, 13880/9640, 9934/9713, 13761/9713, 13841/9713, 13880/9713, 13761/9934, 13841/9934, 13880/9934, 13841/13761, 13880/13761, 13880/13841, 6631/4152, 7156/4152, 8200/4152, 8680/4152, 8765/4152, 8810/4152, 8915/4152, 9131/4152, 9351/4152, 9422/4152, 9640/4152, 9713/4152, 9934/4152, 13761/4152, 13841/4152, 13880/4152, 6631/11683, 7156/11683, 8200/11683, 8680/11683, 8765/11683, 8810/11683, 8915/11683, 9131/11683, 9351/11683, 9422/11683, 9640/11683, 9713/11683, 9934/11683, 13761/11683, 13841/11683, 13880/11683, 4152/11683, 6631/11629, 7156/11629, 8200/11629, 8680/11629, 8765/11629, 8810/11629, 8915/11629, 9131/11629, 9351/11629, 9422/11629, 9640/11629, 9713/11629, 9934/11629, 13761/11629, 13841/11629, 13880/11629, 4152/11629, 11683/11629, 6631/11528, 7156/11528, 8200/11528, 8680/11528, 8765/11528, 8810/11528, 8915/11528, 9131/11528, 9351/11528, 9422/11528, 9640/11528, 9713/11528, 9934/11528, 13761/11528, 13841/11528, 13880/11528,4152/11528, 11683/11528, 11629/11528,6631/11473, 7156/11473, 8200/11473, 8680/11473, 8765/11473, 8810/11473, 8915/11473, 9131/11473, 9351/11473, 9422/11473, 9640/11473, 9713/11473, 9934/11473, 13761/11473, 13841/11473, 13880/11473, 4152/11473, 11683/11473, 5082/4885 and 11629/11473.

In another example, bronchoalveolar lavage fluid can be analyzed and compared through use of any or all of the peaks obtained in a mass spectrum according to the method of the invention as described herein. Examples of such peaks include, but not limited to, the following within ±0.2%: 3372, 3390, 3444, 3487, 3462, 3507, 3476, 3594, 3650, 3671, 3711, 4130, 4350, 4571, 4969, 5286, 5388, 5422, 6346, 6649, 6827, 6960, 7350, 7675, 7922, 8570, 8841, 9956, 10200, 10395, 10444, 10560, 10590, 10764, 10797, 10840, 11045, 11064, 11175, 11736, 11943, 12696, 12911, 13288, 13483, 13749, 13857, 14700, 14914, 15848 and 16048.

The protein profile of human cerebral spinal fluid (CSF) contains numerous peaks that are exemplified by those at the following m/z values, 2481, 3370, 3441, 3485, 3508, 3904, 4130, 4151, 4349, 4583, 4466, 4583, 4624, 4805, 4962, 5263, 5416, 5263, 5733, 5861, 6248, 6343, 6378, 6619, 6676, 6817, 6970, 7030, 7054, 7261, 8185, 8563, 9733, 10440, 10835, 11728, 11939, 11956, 13356, 13749, 13761, 13880, 13939, 14065, 15126 and 15870. Cerebral spinal fluid also contains peaks that are oxidized forms of the peptides having +16, +32 or +48 mass units that correspond to the addition of 1, 2 or 3 oxygen atoms per peptide. Peaks having a +2 charge state are also included in the protein profile for CSF. Mass accuracy of the MALDI-TOF in linear mode is ±0.1%. Thus, a peak at 6631 m/z can appear at 6625 to 6637. Those of skill in the art understand this variation so that peaks can be correlated to each other and identified.

Those of skill in the art realize that protein profiles prepared from a biological sample can be analyzed and compared through use of numerous methods as described herein and known in the art.

### Determination of Protein Profile Deviations Caused by Contact of an Organism with a Mediator

The invention provides a method to determine if contact of an organism, cell or tissue with a mediator causes the protein profile of the organism, cell or tissue to change. The method is based on the discovery that the protein profile of an organism is maintained within a constant range over time. This discovery allows the response of an organism to a mediator to be determined through comparison of the organism's protein profile when the organism has not been contacted with a mediator to the organism's protein profile when the organism has been contacted with a mediator. As such, the method can be used for a variety of purposes, such as to determine if an organism produces an allergic response to a mediator. Accordingly, a protein profile can be prepared from a biological sample obtained from the organism before the organism was contacted with a mediator, and compared to a protein profile prepared from a biological sample obtained from the organism after the organism was contacted with a mediator, to determine if the mediator causes the protein profile of the organism to change. Alternatively, a protein profile can be prepared from a biological sample obtained from an organism soon after the organism was contacted with a mediator, and compared to a protein profile prepared from a biological sample obtained from the organism after a sufficient amount of time to negate or reduce any reaction the organism may have had to the mediator. This method may be used to assist in diagnosing whether a medical event experienced by an organism was due to reaction of the organism to a mediator. The mediator may be applied ex vivo to cells or tissues extracted from an organism and protein profiles obtained from the cells or bathing media.

A large variety of mediators may be used within the method of the invention. Examples of such mediators include, food, drugs, antigens, and the like. Accordingly, the invention provides a sensitive method that may be used to determine if an organism is allergic to a mediator, such as a food, drug, antigen, a protein, pollen, dander, metal, nut, shellfish, oil, venom, and the like. In some instances, a serum component having an m/z value of 4152 is increased in the serum of a human undergoing an immune response.

Those of skill in the art realize that the method may be used for a large variety of purposes where the reaction of an organism to a mediator is to be investigated.

### Method to Screen for an Agent that Modifies Alteration of a Protein Profile in an Organism Resulting from Contact with a Response Stimulator

The invention provides a method to screen for an agent that increases, reduces, or eliminates alteration of the protein profile of an organism that results from contact of the organism with a response stimulator. In one example, the method involves contacting a test organism with a response stimulator that causes an alteration in the protein profile of the organism, contacting the test organism with a candidate agent, and determining if the candidate agent reduces alteration of the protein profile due to contact of the test organism with the response stimulator. A control organism can be used that is contacted with a response stimulator, but that is not contacted with a candidate agent, to determine if the candidate agent increases, decreases or eliminates alteration of the protein profile in the test organism. In another example, the method involves contacting a test organism with a candidate agent, contacting the test organism with a response stimulator, and then determining if the candidate agent reduces alteration of the test organism's protein profile that is due to the response stimulator. A control organism can be used that is contacted with a response stimulator, but that is not contacted with a candidate agent, to determine if the candidate agent increases, decreases or eliminates alteration of the protein profile in the test organism. In another example, the method involves contacting a test organism with a candidate agent and a response stimulator, and determining if the candidate agent reduces alteration of the protein profile of the test organism that is due to the response stimulator, when compared to a control organism that was not contacted with the candidate agent. The mediator may be applied ex vivo to cells or tissues extracted from an organism and protein profiles obtained from the cells or bathing media.

The method may be used to identify a candidate agent that increases, decreases or eliminates the response of an organism to a response stimulator. For example, the method may be used to identify an agent that is useful for reducing the response of an organism to bee venom or a food allergy. The method may be used to screen for agents that increase the response of an organism to immunization with an antigen.

A variety of response stimulators can be used within the method of the invention. Examples of such response stimulators include, pollen, dander, toxins, venoms, foods, oils, nuts, metals, and the like. Those of skill in the art realize that nearly any material that produces a detectable change in the protein profile of an organism may be used as a response stimulator.

Numerous candidate agents can be screened for their ability to increase, decrease, or eliminate alteration of the protein profile of an organism due to contact of the organism with a response stimulator. Examples of such candidate agents include pharmaceuticals, proteins, peptides, hormones, growth factors, immune suppressive agents, antibodies, and the like. Numerous pharmaceutical agents are known in the art and have been reported (Merck Index, Merck Research Laboratories, 13th edition, Whitehouse Station, N.J. (2001); Physicians Desk Reference, Thompson PDR, 58th edition, Des Moines, Iowa (2004); Mosbys 2004 Drug Guide, Mosby Inc., St. Louis, Mo. (2004)).

The method may be conducted with a variety of organisms as described herein and used in the art. Mice, rats, rabbits and monkeys are examples of laboratory animals that are commonly used to screen candidate agents, however, other organisms may also be used within the method.

### Diagnosis and Monitoring of Disease

The invention provides a method that can be used to diagnose a disease, follow the progression of a disease, or determine if an organism is predisposed to develop a disease. Generally, the method relates to correlating changes in a protein profile from an organism to a specific disease, or to the development of a disease. The changes in the protein profile can be detected through use of methods described herein or known in the art. In some examples, mass spectroscopy is used to prepare a protein profile from an organism as is described herein.

While it has been discovered that the protein profile of an organism is constant, disease states cause the protein profile of an organism to become inconsistent. Inconsistency in an individual's protein profile may also result from long-term processes, such as aging. Thus, a person's protein profile may be used in several ways to characterize disease. For example, while an optimum protein profile is likely to depend on an individual, it is thought that specific characteristics of a protein profile can be correlated to the presence of a disease or the predisposition of a person or animal to develop a disease. Such diseases may be associated with age, metabolism, infection, immunity, and a variety of other disorders. Preferably, the method of the invention is used to diagnose, monitor, or evaluate the presence, absence, or severity of diabetes, pre-diabetes, insulin resistance, metabolic fitness level, allergy, autoimmune disorder, inflammatory response, urinary tract disease or dysfunction, kidney transplant rejection, kidney disease or damage, or hepatitis C.

Protein profiling may also be used to detect a change in health status, even if the resulting profile remains within the values displayed by other healthy individuals. Comparison of an individual's protein profile to a predetermined baseline is thought to be useful as a predictor of a change in the status of the individual. For example, a change in the protein profile of an individual may result from development of diabetes, graft versus host disease, exposure to a toxin or chemical, induction of an immune response, and the like.

Major profile changes are often associated with severe disease such as sepsis, which produce profiles that are unlike any that are found in a normal population. In the case of sepsis, a protein profile may be used for disease diagnosis without reference to a baseline value. However, lack of a baseline value may cause overestimation or underestimation of the protein profile change. For example, an individual with a steady state value for the 9713/9422 ratio of 0.2 will have a 4-fold change when the ratio is 0.8 and would be characterized as very aberrant, even though the actual value is within the range for healthy persons. This would result in underestimation of the illness level of that person. On the other hand, a person with a normal steady state ratio of 0.8 may show a value of 1.6 with less illness than the first individual with an actual value of 0.8. Accordingly, an advantage of the invention is that comparison of protein profiles prepared at different times may avoid overestimation or underestimation of disease. Thus, full recovery from sepsis is indicated when the protein profile reaches a steady state level that stops undergoing change, signifying that the individual has reached homeostasis with respect to the protein profile. Furthermore, the length of time a person spends in a highly altered protein state can also be used to predict the outcome of a disease. For example, a person is thought to be able to tolerate a short period of time with an extremely altered protein profile, but is thought to be less likely to survive if the protein profile is altered for an extended period of time. The length of time a patient may be able to survive with a severely altered protein profile will depend on health status, age and other factors at the time of illness.

A protein profile may also be followed over time to monitor a course of therapy. For example, the progress of a patient receiving treatment for graft rejection may be followed through monitoring the protein profile of the patient over time to determine if the treatment scheme is effective in reducing or eliminating graft rejection. In another example, a patient being treated for diabetes could be monitored using the methods described herein to determine if a therapeutic scheme was able to decrease the change in the patient's protein profile in response to caloric intake, such as ingestion of food or a food substitute. In another example, the protein profile of a patient being treated for emphysema could be monitored over time to determine if the treatment scheme decreased the quantity of protein degradation products present in a bodily fluid from the patient, such as bronchoalveolar lavage fluid or urine. In another example, the protein profile of a patient receiving chemotherapy could be followed to monitor whether the therapeutic scheme causes an undesired level of cell death within the patient based on the presence of protein degradation products in the bodily fluids of the patient. This can also apply to changes in the protein profile that suggest excessive damage resulting in aberrant ratios of normal proteins of the profile. Those of skill in the art realize that the method of the invention can be used to monitor and follow the progression of numerous treatment schemes and diseases.

Some disease states produce additional peaks in the protein profile of an individual that is suffering from a disease. These additional protein peaks can be used to diagnose the disease. C-reactive protein (CRP) analysis is commonly used to diagnose a disease involving an acute phase reactant. Acute phase reactants can be used as a test for inflammatory diseases, infections and neoplastic diseases. A major example of an acute phase reactant is serum amyloid A (SAA), which was determined to become a dominant protein in severe sepsis. The distribution of SAA isoforms was detected as well as several partial degradation products of SAA. It is thought that the distribution of these components is useful in diagnosis. While these forms of SAA have been detected by mass spectrometry after antibody precipitation (Kiernan et al., FEBS Lett., 537:166 (2003)), the mass spectroscopy based analysis method described herein offers the advantages over previous methods that include speed, greater cost effectiveness, and simultaneous analysis of additional components. CRP may be used to detect early postoperative wound infection and to follow therapeutic response to anti-inflammatory agents. Very sensitive assays for CRP are thought to be a useful indicator for susceptibility to cardiac disease. Additional diseases where CRP and by inference SAA, may prove useful as a diagnostic tool include, but are not limited to, heart disease/atherosclerosis, stroke, obesity, dental disease, blood sugar disorders, Alzheimer's disease, arthritis, cancer, viral diseases, smoking related disease, disease related to the use of estradiol with or without progestagens in post-menopausal women, bacterial infection and aging.

Analysis of the plasma protein profile revealed that, while plasma contains a limited number of components, a surprising number of features were detected in the protein profiles. For example, very accurate ratios of the apolipoprotein C family of proteins are thought to reflect lipoprotein structure and content so that changes in these proteins may be direct or indirect consequences of other events. The approach also detected several levels of glycosylation associated with O-linked N-acetylgalactosamine. The distribution of these glycoforms is thought to indicate the health of the organ of biosynthesis or may detect the presence of glycosidase enzymes in the blood. Transthyretin was found to represent the level of free sulfhydryl groups in the blood. Variations of sulflydryl modifications such as sulfonylation of TTr have been linked to a number of severe disease states, such as end stage liver disease and homocysteinuria (Lim et al., J. Biol. Chem., 278:49707-49713 (2003); Saraiva, Hum. Mutat., 17:493-503 (2001); Kishikawa et al., Biochim. Biophys. Acta., 1588:135-138 (2002), Zhang and Kelly, Biochemistry, 42: 8756-8761 (2003)). Lowered free sulfhydryl levels of TTr may also arise from oxidative activity in the blood, another aspect of disease. In the sample population studied to date, a high level of sulfonylated TTr was observed in graft versus host disease (GVHD) and adolescent obesity insulin resistance. Other mass spectrometry methods have evaluated TTr modifications after antibody precipitation or by an inline analysis (Lim et al., J. Biol. Chem., 278:49707-49713 (2003)). However, the method of the invention offers the advantages of speed and simplicity as well as simultaneous analysis of several other components.

The present invention may be used to diagnose and predict the outcome of graft versus host disease. Graft versus host disease (GVHD) is a frequent and life threatening complication of allogeneic hematopoietic cell transplantation (HCT). Murine studies demonstrate that GVHD is a multi-step process involving host tissue injury induced by the preparative chemotherapy regiment. This leads to the activation of resident antigen presenting cells (APCs) that in turn, activate donor T cells. Some of the T cells then recognize alloantigen on host tissues, proliferate and elaborate soluble proteins (cytokines, chemokines, etc.) that further recruit and activate lymphocytes. The process culminates in an immune mediated attack of recipient target tissues by donor T cells (Ferrara et al., Biol. Blood Marrow Trans., 5:347 (1999)). Clinically, acute GVHD manifests as a syndrome of skin rash, diarrhea and hepatic dysfunction. A number of clinical variables influence the incidence and severity of GVHD, including the degree of major histocompatibility complex (MHC) matching between donor and recipient, the graft source (peripheral blood stem cells (PBSC) versus umbilical cord blood (UCB) versus bone marrow (BM)) and the ages of the donor and recipient. Despite this, acute GVHD occurs frequently (about 10-40% of patients) and accounts for significant morbidity and mortality. Even though GVHD is a common complication there are no definitive tests other than tissue biopsy and even biopsy may yield equivocal results. This is a major obstacle since it is widely believed that GVHD should be promptly treated when detected. In fact, studies demonstrate that the early institution of GVHD treatment improves outcome (MacMillan et al., Biol. Blood Marrow Trans., 8:40 (2002)). Thus, serum based assays to detect sub-clinical GVHD or to establish the diagnosis, as described herein, are thought to have a considerable impact on the management of patients.

The method of the invention can be used to monitor stages or an immune response in an organism. For example, a mild immune response can be detected by the appearance of the new component at m/z=4152, an intermediate immune response can be detected by determining the level of protein oxidation of TTr and a strong immune response is characterized by SAA production.

It should be noted that for purposes of the present invention, the m/z values of 4150, 4151, 4152 and 4153 and values within ±4 thereof are used interchangeably herein, and refer to a unique mass spectrometry peak in a protein profile that represents residues 467-500 of C1 protease inhibitor (TLLVFEVQQPFLFVLWDQQHKFPVFMGRVYDPRA; SEQ ID NO:1), the activation peptide that is released when the inhibitor interacts with the protease (see Example VIIIB). The measurement of the m/z value for this peak is accurate to about ±0.1%, and can thus vary by up to ±4 depending on the instrument and other experimental conditions.

The ability to assay for varying levels of an immune response allows early events in an immune or inflammation related disease to be detected and monitored. Examples of disease states where inflammation can arise include, but are not limited to, asthma, allergies (such as hay fever, bee stings, poison ivy), arthritis, gout, and diseases such as Crohn's disease. Other diseases that can be monitored and detected through use of the method include autoimmune diseases such as lupus, rheumatoid arthritis, Hashimoto's disease, systemic lupus erythematosus, Sjögren's disease, antiphospholipid syndrome, primary biliary cirrhosis, mixed connective tissue disease, chronic active hepatitis, Graves' disease, type I diabetes, rheumatoid arthritis, scleroderma, myasthenia gravis, multiple sclerosis, chronic idiopathic thrombocytopenic purpura, Guillain-Barre syndrome, and the like. The ability to detect various levels of inflammation and immune response is also thought to be useful in early detection of pre-eclampsia during pregnancy.

Since many proteins associated with disease are synthesized in the liver, it is thought that the method of the invention is useful for monitoring liver disease. Examples of such diseases that might be diagnosed or monitored include, but are not limited to, alagille syndrome, alcoholic liver disease, autoimmune hepatitis, Budd-Chiari syndrome, biliary atresia, Byler disease, cancer of the liver, cirrhosis, Crigler-Najjar syndrome, Dubin-Johnson Syndrome, fatty liver, galactosemia, Gilbert syndrome, glycogen storage disease I, hemangioma, hemochromatosis, hepatitis A, hepatitis B, hepatitis C, hepatitis D, hepatitis E, hepatitis G, liver transplantation, porphyria cutanea tarda, primary biliary cirrhosis, protoporphyria, erythrohepatic, rotor, sclerosing cholangitis, and Wilson's disease.

Protein profiling of biological samples obtained from an organism can be readily used to diagnose and follow the progression of a disease that generates protein degradation products. Examples of such diseases include, but are not limited to, tuberculosis, lung cancer, chronic pulmonary obstructive diseases that include emphysema and transplant rejection. While any biological sample may be used in which protein degradation products can be detected, biological fluids that normally contain a lower level of abundant proteins provide the advantage of a lower background and less interference with the detection of protein degradation products. Bronchoalveolar lavage fluid (BALF) and urine are examples of biological fluids that normally contain lower levels of abundant protein and that can be readily analyzed for protein degradation products.

Additional examples of diseases that can be diagnosed and assessed using the method of the invention include, but are not limited to, diabetes, pre-diabetes, sepsis, transplant rejection, familial amyloid polyneuropathy, diseases related to levels of free sulfhydryl groups, ataxia, graft versus host disease, bronchiolitis-obliterans syndrome, autoimmune disease, and other diseases that produce an altered protein profile. Examples of disease states that may be diagnosed by protein profiles of the cerebrospinal fluid include Alpers disease, amyotrophic lateral sclerosis, Alzheimer's disease, Batten disease, Parkinson's disease, Huntington's disease, Creutzfeldt-Jacob disease, cockayne, corticobasal ganglionic degeneration, multiple system atrophy, olivopontocerebellar atrophy, postpoliomyelitis syndrome, prion diseases, progressive supranuclear palsy, Rett syndrome, Shy-Drager syndrome, tuberous sclerosis and neuropathy that is secondary to other diseases such as type I diabetes. Examples of methods that can be used to diagnose and monitor these diseases are described herein and include but are not limited to severe sepsis (Example I), graft vs. host disease (Example VI), exposure to endotoxin (Example VII), chronic lung transplant rejection (Example XI) and others.

Protein profile analysis can be used to determine if an organism has a disease state, such as diabetes or a predisposition to develop diabetes. As described in the examples, a protein profile prepared from a biological sample obtained from an organism following caloric intake, such as ingestion of food, can be compared to the protein profile prepared from a biological sample obtained from the organism before caloric intake. Alternatively, a protein profile prepared from a biological sample obtained from an organism following caloric intake, such as ingestion of food, can be compared to a protein profile prepared from a biological sample obtained from the organism following a fasting period. If comparison of the two protein profiles indicates that there is a large change in the peak ratios within the protein profiles, then the organism is deemed to have diabetes or is likely to develop diabetes. For humans, it is thought that protein profiles compared before and after caloric intake will normally exhibit a difference in the peaks contained therein that is less than about 5 percent in any peak ratio at 5 hours after caloric intake. A change of a single peak ratio of 5 to 10 percent at 5 hours after the caloric intake is considered undesirable but a minor condition. A change of about 10 to about 20 percent signifies a substantial problem either in the current health status, or indicates that the person is predisposed to develop a disease condition. Changes of about 20 to about 40 percent are high and require consideration of remedial action to prevent future health problems. Changes of over 40 percent are considered to be severe. Caloric intake can include ingestion of numerous food products or food equivalents. These can include for example sugars, carbohydrates, fats, proteins, and the like. An example of caloric intake that can be used within the method of the invention can include a high level of both carbohydrate and fatty deep fat fried foods. An example of caloric intake includes a large hamburger (¼ lb), French fries and a 20-ounce non-diet soft drink. Unstable protein profiles are thought to be linked to a number of disease states such as hyperlipidemia that leads to coronary heart disease or atherosclerosis. Selective choice of the content of the caloric intake may allow diagnosis of distinct disease states. Diseases such as hyperlipidemia, type 2 diabetes, atherosclerosis, hypercholesterolemia, liver disease and other metabolic dysfunctions may respond differently to the nature of the caloric intake, emphasizing carbohydrate, lipid or protein calories. As a result, those of skill in the art can readily use different challenges to target the basis for the protein profile changes. Disease states for which this test will be valuable include, but are not limited to, type 2 diabetes, the metabolic syndromes, type I diabetes, hyperlipidemia and various thyroid diseases such as hyperthyroid or hypothyroid conditions. Analysis of an individual's response to varied caloric intake may be used to determine outcome of a diet, weight loss, or exercise where recovery of a stable protein profile should be a major concern and outcome.

Results of a profile can be combined with other information to provide an improved diagnosis. Other information may be clinical data or tests that are commonly used to diagnose disease such as blood glucose level, blood insulin level, insulin sensitivity or other commonly measured parameters used in diagnosis.

Use of the method of the invention allowed detection of a surprisingly wide spectrum of proteome characteristics that can be linked to health and disease. A unique personal protein profile can be applied to numerous other proteins and offers detailed characteristics useful for evaluation of health of an individual and leading to individualized analysis of health and medication. A surprising element of effective protein profiling was precision and reproducibility. A small number of components, determined with high accuracy, are thought to be as effective as a very large number of proteins that are detected with lower precision. Even minor change in some features of the proteome can indicate a change in the health or metabolism of an individual. For example, polymorphisms among individuals are easily detected using the mass spectroscopy based method as described herein. Among the first 107 samples analyzed, 12 potential polymorphisms were found. These were characterized by a peak doublet for a particular protein and for each of the derivatives of that protein. Linear MALDI-TOF analysis easily detected a 5 atomic mass unit (amu) change. The doublets observed to date involve mass differences of about 10 to 30 amu. There are many candidate mutations or combinations that could produce these changes. Many variants of transthyretin are known, some of which are associated with the long term disease of familial amyloid polyneuropathy (Falk et al., N. Engl. J. Med., 337:898-909 (1997) and Saraiva, Hum. Mutat., 17:493-503 (2001)). The detection of polymorphisms is thought to be useful in many medical applications dealing with disease and treatment of disease. For example, patients that exhibit one form of an enzyme may be refractory to treatment with a certain type of drug but may response favorably to another drug for the treatment of a disease. Use of the methods described herein allows a biological sample to be taken from a patient and rapidly analyzed to determine if the patient will be refractory, or will respond favorably, to treatment with a drug. Such analysis will allow a medical practitioner to more effectively prescribe pharmaceutical agents of the treatment of disease.

### Mass Spectrometric Peaks Associated with Diabetes and Insulin Resistance

It was discovered that certain mass spectrometric peaks observed in a sample of biological fluid were indicative of the presence, absence or status of disease states associated with diabetes, pre-diabetes (a condition wherein an individual shows some property such as elevated fasting glucose or insulin, poor but not disease-level response in the glucose tolerance test or other risk factors for developing diabetes such as BMI and insulin resistance, making it likely that that person will develop diabetes in the future) and insulin resistance. Examples of these peaks include the pair of peaks at m/z 6433±3 and m/z 6631±3. These peaks represent full length apolipoproteinC1 (apoC1) and a truncated form of apolipoproteinC 1 which is missing the first two amino acids (threonine and proline) from the N-terminus (Bondarenko et al., J. Lipid Res., 40:543-555 (1999)). These two peaks can also be used more generally as a measure of metabolic fitness. For example, they can be used to measure the response of a subject to an exercise and/or nutrition program.

The relative ratio of these two peaks, or changes in their relative ratio, may indicate endoprotease activity associated with disease. Dipeptidylpeptidase IV (DPPIV) is an endopeptidase that is known to cleave the first two amino acids from the N-terminus of apolipoproteinC1 (converting the peak at 6631 m/z to 6433 m/z). DPPIV also is known to inactivate incretins, which are hormones associated with insulin production. Insulin-resistant diabetics can have a low level of DPPIV, leading to prolonged production of insulin. Thus, inhibition of DPPIV may be a treatment for diabetes. The activity of DDPIV can be conveniently monitored by watching the ratio of the mass spectrometry peaks at 6631 m/z to 6433 m/z, which in turn allows one to monitor any treatment designed to inhibit the activity of DDPIV.

It should be noted that the present technique can be readily extended to monitor the activity of any desired peptidase or protease, by monitoring an attribute of a mass spectrometric peak associated with a protein, which may be but need not be a full length protein, versus a mass spectrometric peak associated with a proteolytic thereof. For example, complement activation can be detected by monitoring changes in peak attributes of peaks having m/z values of 9715, 9644 and 9573 due to successive loss of amino acids from C-terminus as a result of the action of carboxypeptidase. See Bondarenko et al., J. Lipid Res., 40:543-555 (1999). Glycolytic and lipidolytic fragments of proteins can be detected in the same manner. This method permits monitoring of a subject for activity of proteases, peptidases, glycolases, glycosylases, lipidases, etc. that may be active during disease. In general, changes in the ratios of full length proteins compared to their truncated versions or fragments, particularly from time to time in an individual subject, may indicate the presence, absence or status of disease, such as kidney disease.

It should further be noted that mass spectrometry is not the only way to measure the relative amounts of apolipoproteinC1 and its truncated form in a biological fluid. Any available assay can be used determine the relative amounts of these biomolecules in the fluid. Such methods include electrophoresis, chromatography, immunological methods including immunoassay and Western blots, spectroscopic methods, and, if mRNA is to be measured, Northern blot analysis. Development of suitable methods that allow separation and quantification of the different forms of a protein of interest is well within the ordinary skill of the art. For example, apolipoprotein C1 and its truncated form can be separated by HPLC chromatography or distinguished by antibodies that recognize the amino terminal residues of the protein. Other methods that may separate the proteins include electrophoresis where the amino terminal aspartic acid will have a different ionization potential than when it is at position 3. The only requirement for measurement is that the method be suitably precise to detect the differences shown to be important in this document.

Similar approaches can be used to determine the presence of a mutant form of apolipoprotein C1 (full length and/or truncated) that is linked to metabolic disease. This mutant form is 14±1 mass unit lower than the analogous common form of apolipoprotein C1. The mutation can be detected and optionally quantified using, for example, protein chemistry, mass spectrometry, chromatography, DNA or RNA sequence analysis, and the like according to methods well known in the art.

Mass spectrometric peaks as early stage markers of disease It was discovered that certain mass spectrometric peaks observed in a sample of biological fluid were indicative of the presence, absence or status of disease states associated with inflammation. An example is the peak at m/z 4153±3 or its polymorphic form at m/z 4185±3. This peak was shown to greatly increase in subjects who received low doses in endotoxin in a controlled experiment (see Example VII), and is expected to serve as a signal for autoimmune disorders and allergies. The protein represented by this peak is described in Example VIIIB and represents a novel therapeutic target. This peak is expected to serve as an early stage marker of disease, as it appears prior to the acute proteins that follow in severe disease.

### Mass Spectrometric Peaks Associated with Polymorphisms

Mass spectrometry can be utilized to detect polymorphisms that may be associated with various disease states. For example, site-directed mutations in proteins or peptides can be detected. Likewise, oxidized and reduced states of a protein can be detected. Transthyretin, for example, typically contains a free sulfhydryl. The loss of this free sulfhydryl, for example by binding to a cysteine, is a marker for inflammation and other conditions. The redox state of transthyretin can be monitored by observing the relative peak attributes at m/z values of 13880 and 13761.

### Apolipoprotein CIII1 and CIII2

Mass spectrometric peaks associated with apolipoprotein CIII1 and CIII2 (m/z values of 9713 and 9421) represent two forms of this protein that differ by an additional sialic acid residue on the component at m/z 9713, observed in a sample of biological fluid were associated with disease. In severe liver disease and several other conditions, it was discovered that the sample contained more of the larger protein than the smaller version. An increase in the proteolytically degraded forms of apolipoprotein CIII1 and CIII2 (m/z values of 9642 and 9351, reflecting the loss of an alanine from the C-terminus) compared to the full-length forms may also indicate disease. The severity of disease can be assessed by the level of change from a person's normal profile

On the other hand, a low ratio of 9713/9421 can indicate mild stress or disease, for example mild diabetes.

### Serum Amyloid A as an Acute Disease Phase Marker

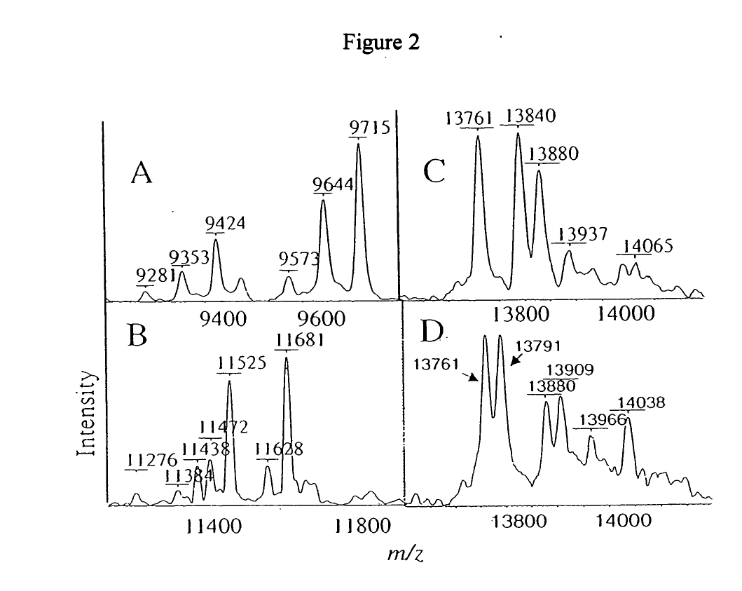

Examples of conditions having high levels of serum amyloid A include heart disease/atherosclerosis, stroke, obesity, dental disease, blood sugar disorders, Alzheimer's disease, arthritis, cancer, viral disease, smoking tobacco, use of estradiol with or without progestagens in post-menopausal women, hidden bacterial infections, aging, and the like. Serum amyloid A levels can be detected through its known degradation products, including loss of the amino terminal Arg (m/z=11525 and 11472 for alpha and beta forms, respectively, FIG. 2B), subsequent removal of serine (m/z=11438 and 11384, FIG. 2B) and further loss of tyrosine from the C-terminus of SAA-alpha (m/z=11,276).

### Monitoring for Kidney Disease using Biomarkers Found in Urine Profiles

Urine analysis can be used to detect kidney disease associated with any condition such as diabetes that often leads to kidney failure. The method can be used to detect the presence of disease and progression of the disease by analysis of proteins in the profile or analyzed by other means and comparison to earlier samples from the same individual. It can be used to monitor therapy and improvement in profile. It can be used to monitor kidney response to chemotherapy for cancer conditions or anti-rejection drugs. Physical damage to the kidney can also be detected using the method of the invention. Evidence of kidney disease can cause the physician to alter therapeutic treatments to prevent kidney damage. Other uses for profile analysis can include diagnosis of bladder conditions such as bladder cancer, or cancer or other disease or dysfunction of any related organs such as the kidney or prostate, including benign prostate hyperplasia (BPH). It can be used to monitor kidney stone development and related problems.

Diagnosis or monitoring of kidney disease is preferably accomplished by quantifying one or more of the following m/z components or peaks of a mass spectrometric protein profile determined from a urine sample of a patient: spectrum components of m/z values of 9742, 9070, 9480 and 10,350,±tolerances as described elsewhere herein. It should be noted that the mass spectrometry peak at m/z of 9070 is also referred to herein as a m/z of 9073; both fall within the instrument tolerance range of ±0.1%. It has been found that the presence of kidney disease can be detected by analyzing any peak that differs from standard components found in healthy individuals at m/z values of 9742±0.1% and/or 9073±0.1%. Examples of other useful diagnostic peaks from the mass spectrum of urine include peaks at m/z=2187, 2431, 2715, 2750, 2844, 2882, 2786, 3000, 3272, 3370, 3441, 3485, 3495, 3525, 3787, 3900, 3982, 4132, 4180, 4224, 4253, 4271, 4300, 4338, 4352, 4375, 4511, 4565, 4637, 4675, 4750, 4840, 4859, 4988, 5006, 5070, 5170, 5321, 5419, 5556, 5704, 5764, 5865, 6343, 6353, 6431, 6489, 6590, 6632, 6643, 6676, 6733, 6750, 6766, 6868, 6937, 7007, 7154, 7319, 7421, 7510, 7560, 7919, 7937, 8566, 8846, 8915, 9070, 9096, 9394, 9422, 9480, 9713, 9742, 10350, 10649, 10780, 10840, 10880, 11035, 11183, 11310, 11323, 11368, 11732, 12262, 12684, 12690, 13350, 13760, 13380, 15012, 15835, and 20950. In a particularly useful embodiment, a ratio of two peaks, m/z 9070 and m/z 9742, is determined and monitored or analyzed. Any of these measurements can be compared to other standard or control measurements, to measurements from other individuals (either healthy or diseased), or to the individual's own measurements taken earlier. In addition to monitoring m/z values, the identity of the proteins or peptides represented by those peaks can be determined, and biochemical or immunological assays can be developed, such as ELISAs, to detect and quantitate the amount of these components in a biological fluid of the patient, such as urine.

### Kits

The invention provides kits that are useful for collecting, storing or shipping a biological sample. Generally a kit of the invention includes a container and a matrix. A kit of the invention may also include packaging material, instructions, a storage buffer, or material on which the sample can be dried, one or more wash buffers, an elution buffer, a sharp, a MALDI target, and a dissociation buffer.

A kit of the invention may be used to collect numerous types of biological samples. Examples of such samples include blood, urine, saliva, tissue, serum, cerebral spinal fluid, semen, vaginal fluid, pulmonary fluid, tears, perspiration, mucus and the like.

Numerous types of containers may be included within a kit of the invention. Examples of such containers include test tubes, centrifuge tubes, bottles, jars, sealable bags, syringes, capillary tubes, columns, and many other containers known in the art. A container may be made from plastic, glass, ceramic material, nylon, numerous polymeric materials, and the like. In some examples, the container is treated to reduce or eliminate interaction or adherence of materials with the container. For example, a container may be silanized according to methods known in the art. A container can be sterilized according to many methods, such as use of chemicals, heat, radiation, and the like.

A kit may include a matrix to which components of the biological sample that come into contact with the matrix will adhere or adsorb. In one example, this matrix is a reverse phase matrix. Many types of reverse phase matrixes are known in the art (Pharmacia, Peapack, N.J.). Examples of such matrixes include, but are not limited to, C18, C2/C18, C4, C8, phenyl, and polystyrene (divinylbenzene) matrixes. Additional types of matrixes may be included within a kit of the invention. For example, an immune based matrix to which are coupled antibodies that bind to a component of a biological sample may be included within a kit. In another example, a ligand to which a component of a biological sample will bind may be coupled to a matrix that is included within a kit. The kit may contain a material onto which the sample is applied and dried for storage until analysis.

A kit can include one or more wash buffers. Generally, a wash buffer is used to remove any components of a biological sample that did not adhere or adsorb onto a matrix that was contacted with the biological sample. Wash buffers may be prepared according to the identity of a matrix included within a kit. Methods for preparing wash buffers are known in the chromatographic arts. In one example, a wash buffer includes 0.1% trifluoroacetic acid (TFA) in water.

A kit may also include a storage buffer. Generally a storage buffer is used to preserve components of a biological sample. In one example, a storage buffer is used to preserve components of a biological sample that have adhered or adsorbed onto a matrix. A storage buffer may contain numerous components that include, but are not limited to, preservatives, antibiotics, chelators, antimicrobials, anticoagulants, and the like. In one example, sodium citrate is included in a kit as an anticoagulant.

An elution buffer can be included within a kit of the invention. An elution buffer is generally used to elute components from biological sample from a matrix. Many types of elution buffers may be included in a kit. In some examples, an elution buffer includes a high concentration of salt. In other examples, the elution buffer can include a denaturing agent that serves to denature components of a biological sample that adhere or that are adsorbed onto a matrix. In one example, an elution buffer includes 75% acetonitrile in a 0.1% TFA solution.

Dissociation buffer may be included within a kit of the invention. Dissociation buffer is generally used to dissociate and disrupt cells of a biological sample that is a tissue. As such, a dissociation buffer may include agents such as detergents, lipases, collagenases, and the like that serve to allow proteins included within the biological sample to adhere or adsorb onto a matrix with which they come into contact. Methods to make such dissociation buffers are well known in the art.

A kit may also include a sharp. A sharp is generally described as a device that can be used to obtain a blood or serum sample. Examples of sharps include a pin, needle, scalpel, and the like.

A MALDI target can be included within a kit. Many MALDI targets are commercially available (Brucker, Billerica, Mass.; PerkinElmer, Wellesley, Mass.).

Packaging material may be included within a kit. This packaging material may contain all or some of the individual pieces of a kit of the invention. Packaging material may be made of a variety of materials that include, but are not limited to, cardboard, paper, plastic, and the like. Packaging material also includes a container that can be used to ship a biological sample.

Instructions may be included within a kit of the invention. In one example, these instructions may describe how to use the kit to obtain, process, and ship a biological sample to a laboratory for analysis. For example, the instructions may describe how to obtain a biological sample, apply the sample to a matrix, wash the matrix, place the matrix into a container, add storage buffer to the container, seal the container, and then ship the container to a laboratory for analysis of the biological sample. Many instructions may be included within a kit of the invention depending on the items that are included within the kit.

In one example, a kit includes a matrix that is in column format. In this example, a biological sample can be applied to the matrix within the column. The matrix can be washed with a wash buffer to remove components of the biological sample that did not adhere or adsorb onto the matrix. The components of the biological sample that did adhere or adsorb onto the matrix can then be eluted from the matrix using an elution buffer into another container. Those of skill in the art realize that numerous kits can be prepared for various types of biological samples.

The present invention is illustrated by the following examples. It is to be understood that the particular examples, materials, amounts, and procedures are to be interpreted broadly in accordance with the scope and spirit of the invention as set forth herein.

### EXAMPLES

### Example I

### Preparation of Protein Profiles by Matrix Assisted Laser Desorption Ionization-Time of Flight Mass Spectrometry (MALDI-TOF) and Identification of Protein Peaks

Blood samples from 18 subjects were obtained under approval by the Institutional Human Subjects Committee of the University of Vienna. Proteome analysis was conducted under the jurisdiction of the Institutional Review Board of the University of Minnesota. Written informed consent was obtained from 8 healthy male volunteers ages 18 to 35 (subjects 3-21). Determination of health status included medical history, physical examination, laboratory parameters, virological and standard drug screening. Exclusion criteria were regular or recent intake of medications, and relevant abnormal findings in medical history or laboratory parameters. The volunteers were admitted for the duration of the study after an overnight fast as described previously (Pernerstorfer et al., Blood, 95:1729-1734 (2000)). Venous blood samples were collected at zero time, 4 hours and 5 hours. The blood was immediately anti-coagulated by mixing 9 volumes of blood with I volume of 0.1 M sodium citrate. Platelet-free plasma was obtained by centrifugation at 12,000×g for 12 minutes at 20° C. Aliquots were frozen at −70° C. for later assay.

Plasma was also obtained from two healthy adult volunteers under informed consent. Subject 1 was a 58 year male and subject 2 a 24 year old female. The blood from these subjects was anti-coagulated and centrifuged as described above and the plasma was stored and used in the same manner. Samples were obtained at random time points over a period of two years for subject 1 and four months for subject 2. In addition, several samples were obtained from individuals with severe sepsis.

Plasma was thawed and 0.1 to 2.0 microliters were diluted into 15 microliters of a reconstitution solution (5% acetonitrile in 0.1% trifluoroacetic acid). To assure acid conditions, 0.5 microliters of 10% TFA was added to the samples containing 2.0 microliters of plasma. Unless indicated, all studies utilized 0.5 microliters of plasma. After 1-hour incubation at room temperature, the samples were extracted through use of C4 Zip Tips (Millipore, Inc., MA). While the one-hour incubation had little impact on the protein profile, it assured consistent treatment of each sample. The Zip Tip was activated by sequential wash with 2×10 microliters of 50% acetonitrile in 0.1% TFA followed by 2×10 microliters of 0.1% TFA. The sample in reconstitution buffer was drawn into and expelled from the Zip Tip for 1.0 minute (approximately 15×10 microliter exchanges). The tip was washed seven times with 10 microliters of 0.1% TFA. The adsorbed proteins were eluted with 1.6 microliters of 75% acetonitrile in 0.1% TFA by drawing the elution fluid into and out of the pipette 8 times. The extract (0.75 microliters) was applied to the MALDI target and mixed with 0.75 microliters of a saturated solution of sinipinic acid (Sigma Chemical Co., St. Louis, Mo.) in 50% Acetonitrile-0.1% TFA. After drying, analysis was conducted with the Bruker Biflex III MALDI-TOF mass spectrometer operated in the linear mode and at a power setting of 38±1% attenuation, with collection of 500 laser shots per analysis. The site of laser impact was changed at least 10 times during data acquisition. Increments of 100 shots were evaluated and those with poor signal to noise were discarded.

An alternative method for preparation of a profile does not require ZipTip extraction. An example is a profile obtained by dilution of plasma or serum directly into the reconstitution buffer, application of the sample to the MALDI-TOF target, followed by addition of Matrix and profile analysis in the MALDI-TOF mass spectrometer. An example was addition of 0.5 microliters of plasma in 15 microliters of reconstitution buffer, application of 0.75 microliters to the MALDI-TOF target along with 0.75 microliters of sinipinic acid matrix. The profile obtained was of somewhat lower intensity but was otherwise very similar to the profile obtained after ZipTip extraction. Extraction of larger amounts of plasma or use of different laser intensity settings will improve signal intensity.

An alternative approach to sample shipping and storage is illustrated by use of dried serum or plasma. Blood was obtained by a finger stick and a drop (0.05 mL) was collected in a small plastic cup. The blood was allowed to stand in the cover of a sealed tube (Eppendorf plastic tube) set at room temperature for 2 hours without being disturbed. Use of a sealed tube prevents evaporation. After 2 hours, a small piece of Whatman 3mm filter paper (approximately 3×3 mm) was placed against the clear liquid that had collected around the edge of the droplet and approximately 2 microliters were absorbed onto the filter paper. The paper was dried and stored at room temperature. For analysis, the serum was re-hydrated by soaking the paper in 20 microliters of water for 2 hours followed by acidification with 0.5 microliters of 10% trifluoroacetic acid and incubation for another hour at room temperature. The liquid was then used for ZipTip extraction and the MALDI-TOF profile was obtained as usual. All of the major peaks of the profile were found and the ratio of 6631/6433 was similar to that obtained from the same serum sample before drying. Some peak ratios were altered. For example, the 13762 peak was greatly reduced. This is expected due to oxidative activity in a sample that was exposed to air. Consequently, depending on the target proteins for diagnosis, it is possible to obtain small amounts of serum by convenient methods, store the serum in a dried state and then rehydrate and extract for MALDI-TOF profile analysis. In several tests, the porous nature of Whatman 3mm paper gave better results than serum dried on standard writing paper. Many materials could be tested to find the one that gives the best outcome for dried serum. Many variations can be considered. For example, the serum could be dried directly onto a surface that is introduced into the MALDI instrument. Matrix would be applied to the sample before analysis. The sample could be rehydrated on the target, MALDI matrix could be applied and a profile obtained. Storage and shipping in a dried state is very convenient and requires very small amounts of material. Any method that can detect the 6631/6433 peaks can also be used to detect polymorphisms in this important blood protein that are described below.

To obtain a profile, the mass spectrometer was calibrated externally with the +1 and +2 charge states of cytochrome C. When used, internal calibration was accomplished with the m/z=6433 peak of apolipoprotein CI and the m/z=9422 peak of apolipoprotein CIII1. The raw data was smoothed according to the Golay-Savitzky formula using 25 points and the baseline then subtracted with tools provided by the Bruker Xtof processing software version 5.1.1. The peaks were labeled and peak intensity lists were generated. Peak areas were obtained by integration of each peak using the standard programs provided with the software.

Comparison of two samples was accomplished by intensity ratios or by analysis by ‘composite analysis’ (as described below). For analysis by peak intensity ratio, averages and standard deviations of peak intensity ratios were obtained for multiple spectra from the same individual. The resulting average ratios were compared to those of another individual and significant differences were determined. Significance was based on values that differed at the >95% confidence level (p<0.05) as estimated by Student's 2-tail test. For composite analysis, the intensities of all peaks in the MALDI-TOF spectrum were divided by the sum of intensities of 5 peaks (0.3*I₆₆₃₁+I₈₇₆₅+I₈₉₁₅+I₉₄₂₂+I₉₇₁₃). The intensity of the peak at m/z=6631 was multiplied by 0.3 to avoid over-emphasis of this intense peak. The averages and standard deviations for several spectra from each individual were obtained and compared with the spectra from other subjects. Significant differences (p<0.05) were noted.

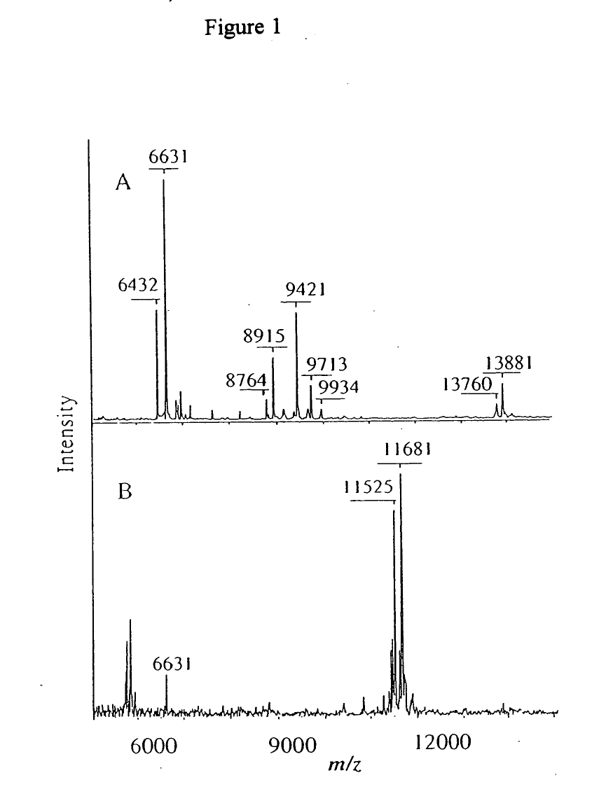

The profile of normal plasmas showed 18 peaks in all samples (FIG. 1A). Serum gave similar results. Additional peaks were detected in some disease states. For example, plasma from a patient with severe sepsis (FIG. 1B) showed nearly complete loss of the normal peaks and appearance of new components. Loss of normal peaks was not the result of peak suppression in the mass spectrometer as a mixture of normal and sepsis plasmas showed all of the normal peaks as well as those of the sepsis plasma.

Protein peaks were identified from the observed m/z values and the known masses of plasma proteins (Table 1). Identification was aided by the relationship of each peak to others in the same spectrum. Such internal comparisons provided very accurate differences (±1 amu) between the components of the spectrum. The parent polypeptides included apolipoproteins CI (m/z=6632), CII (m/z=8916), CIII (ApoCIII0, m/z=8765) (Bondarenko et al., J. Lipid Res., 40:543-555 (1999)) and transthyretin (m/z=13762) (Lim et al., J. Biol. Chem., 278:49707-49713 (2003)). Additional proteins in disease included the alpha (m/z=11681) and beta (m/z=11623) forms of serum amyloid A (SAA).

TABLE 1
Peak identification

| m/z | Proposed Identity | Theoretical mass^{c} |
|---|---|---|
| 6434 | ApoCI minus amino terminal ThrPro | 6433^{d} |
| 6632 | ApoCI | 6631^{d} |
| 6838 | Sinapinic Acid adduct of ApoCI | 6837 |
| 6881 | +2 charge for Transthyretin (TTr) | 6882 |
| 6941 | +2 charge of TTr-Cys | 6942 |
| 7157 | Residues 1-65 of ApoCIII^{a} | 7156 |
| 8201 | ApoC II, the mature protein | 8200^{d} |
| 8680 | ApoCII minus amino terminal ThrGln^{b} | 8687 |
| 8766 | ApoCIII0 (no Carbohydrate) | 8765^{d} |
| 8809 | Unknown | |
| 8914 | ApoCII Preprotein | 8915^{d} |
| 9132 | ApoCIII + GalNAc/Gal | 9131^{d} |
| 9299 | An isoform of ApoCII^{b} | |
| 9352 | ApoCIII1 minus C-terminal Ala | 9351^{d} |
| 9423 | ApoCIII1 (GalNAc/Gal/SA) | 9422^{d} |
| 9643 | ApoCIII2 minus C-terminal Ala | 9642^{d} |
| 9714 | ApoCIII2 (apoCIII1 + additional Sialic acid) | 9713^{d} |
| 9934 | An isoform of ApoCIII^{a} | |
| 11277 | SAA1 minus amino-Term ArgSer and | 11276^{e} |
| | C-Term Tyr | |
| 11385 | SAA2 minus ArgSer | 11385^{e} |
| 11439 | SAA1 minus ArgSer | 11439^{e} |
| 11473 | SAA2 minus Arg | 11472^{e} |
| 11526 | Alpha-SAA minus Arg | 11527^{e} |
| 11629 | SAA2 | 11629^{e} |
| 11682 | SAA1 | 11683^{e} |
| 11732 | Beta 2 microglobulin | 11732 |
| 13764 | Transthyretin (TTr) | 13761^{f} |
| 13841 | Sulfonylated TTr | 13841^{f} |
| 13883 | Cysteinylated TTr (+119 amu) | 13880^{f} |
| 13938 | Cys-Gly TTr | 13937^{f} |
| 14046 | Unidentified | |
| 14067 | Glutathionylated TTr | 14066^{f} |

^{a}Identification made from individuals who were polymorphic with respect to the parent protein. These showed two peaks for each polypeptide arising from that protein.
^{b}Parent polypeptide was identified from the oxidation state unique to apolipoprotein CII. Peptides at 9933 and 9298 may arise from alternative splice sites for the respective parent proteins.
^{c}Citations are to identification of the mass spectrometry peak listed.
^{d}Bondarenko et al., J. Lipid Res., 40: 543-555 (1999).
^{e}Kiernan et al., FEBS Lett., 537: 166-170 (2003).
^{f}Lim et al., J. Biol. Chem., 278: 49707-49713 (2003).

ApoCIII is heterogeneous with respect to glycosylation. The peak at m/z=9131 correlated with apolipoprotein CIII0′ (containing GalNAc-Gal), the peak at 9422 with ApoCIII1 (GalNAc-Gal-Sialic Acid) and the peak at 9713 with apolipoprotein CIII2 (CIII1 containing a second sialic acid residue, +291 amu) (Bondarenko et al., J. Lipid Res., 40:543-555 (1999)).

Other peaks correlated with proteolytic digestion products. The peak at m/z=6433 corresponded with loss of Ser-Pro from the amino terminus of ApoCI (−198 amu). The peak at 9642 corresponded to loss of C-terminal Ala from ApoCIII2. A minor component at m/z=9351 corresponded to loss of C-terminal Ala from ApoCIII1. In some disease states, additional peaks suggested loss of a second alanine from the carboxy-terminus of both ApoCIII1 and ApoCIII2 (FIG. 2A). This produced a ladder of −71 and −142 amu for each of these components (Bondarenko et al., J. Lipid Res., 40:543-555 (1999)).

In disease states with very high levels of serum amyloid A (SAA), known degradation products include loss of the amino terminal Arg (m/z=11525 and 11472 for alpha and beta forms, respectively (FIG. 2B), subsequent removal of serine (m/z=11438 and 11384, FIG. 2B) and further loss of tyrosine from the C-terminus of SAA-alpha (m/z=11,276) (Kiernan et al., FEBS Lett., 537:166-170 (2003)). Additional peaks in this region of the spectrum were not identified. Examples of conditions having high levels of serum amyloid A include heart disease/atherosclerosis, stroke, obesity, dental disease, blood sugar disorders, Alzheimer's disease, arthritis, cancer, viral disease, smoking tobacco, use of estradiol with or without progestagens in post-menopausal women, hidden bacterial infections, aging, and the like.

Modifications of transthyretin (TTr) occur through the single sulfhydryl of this protein (Lim et al., J. Biol. Chem., 278:49707-49713 (2003)). The protein with a free sulfhydryl occurred at m/z=13761 (FIG. 2C) and a second major component corresponded to the cysteinyl-TTr (m/z=13880). Minor components included Cysteinyl-Glycyl-TTr (m/z=13937, FIG. 2C) and glutathionyl-TTr (m/z=14066). Another modification was sulfonylated TTr (m/z=13841). The latter was a minor component in normal individuals but was abundant in some severe disease states (Lim et al., J. Biol. Chem., 278:49707-49713 (2003)). This component was evident in an individual with graft versus host disease (FIG. 2C).

Additional support for peak identification was obtained from apparent polymorphism that occurred in some samples. An example for transthyretin showed equal abundance of the normal component and a second at +30 amu (m/z=13791, FIG. 2D). An identical doublet for both the free sulfhydryl (m/z=13791) and cysteinylated species (m/z=13909) supported the relationship of these components. There are several known isoforms of transthyretin that result in mass changes of between 28 and 32 mass units (Falk et al., N. Engl. J. Med., 337:898-909 (1997)).

Doublet peaks can also arise from chemical modification. An example was suspected oxidation of apolipoprotein CII, resulting in peaks at 8915 and 8931. ApoCII is especially vulnerable to oxygenation during sample preparation (Bondarenko et al., J. Lipid Res., 40:543-555 (1999)). In this case, peak intensities of the doublet were not identical. However, similar oxidation levels for all isoforms of ApoCII suggested the relationship of the proteins to each other. The same samples showed little or no oxidation of other components of the spectrum. In a limited number of samples, a novel form of ApoCII was found m/z=9298. While the identity of this peak was not established with certainty, equal susceptibility to oxidation suggested a structure common to ApoCII. This peak, as well as an apparent isoform of ApoCIII appearing at m/z=9932 (Bondarenko et al., J. Lipid Res., 40:543-555 (1999), Table 1), may arise from alternative splice products of the corresponding genes.

Establishment of the basis for a peak doublet was not necessary for use of this information to establish a relationship between two components of the spectrum. For example, similar doublets for multiple components of a spectrum provided evidence for a structural relationship between those components.

Several peaks in the spectrum may be redundant. The peak at 6837 is thought to correspond to the sinipinic acid adduct of ApoCI (add 206 mass units, equal to the mass of sinipinic acid minus water). The peaks at 6880 and 6940 correlated with the +2 charge states of the the13761 and 13880 components, respectively. Several unidentified peaks occurred below m/z=5000 that were not included in this analysis.

Quantitative evaluation of MALDI-TOF spectra: Peaks were classified into two categories. Homologous peaks were those containing the same parent polypeptide while heterologous peaks were those containing different polypeptides. One example of a homologous relationship was the ApoCI components at m/z values of 6433 and 6631. Other examples include the different glycosylation and proteolysis products of ApoCIII, of SAA and of free versus modified transthyretin.

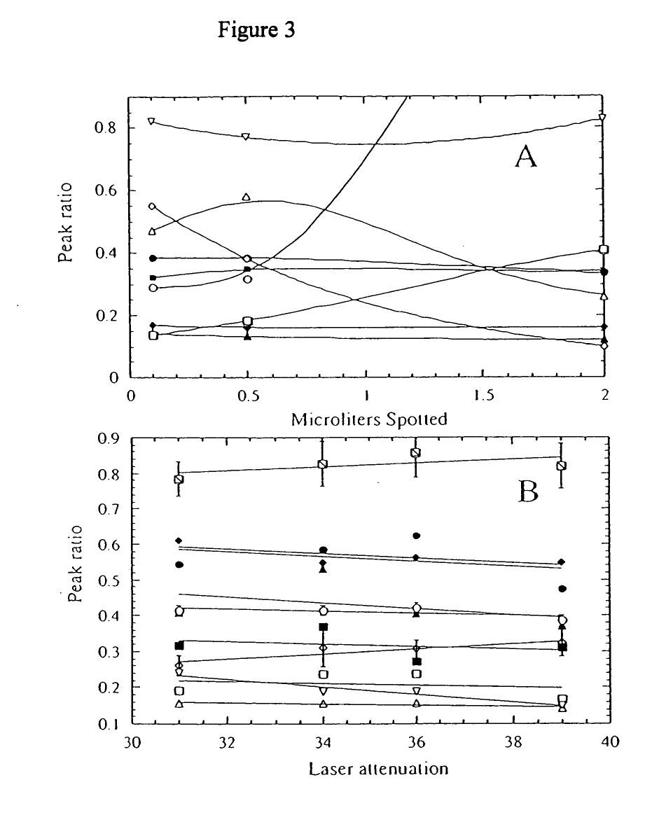

The total MALDI-TOF signal intensity of a sample is dependent on many factors that cannot be accurately reproduced. This requires an internal calibration of each spectrum. One approach to internal calibration used peak ratios. Homologous peak ratios showed small standard deviation for multiple measurements (approximately 3 to 10 percent, Table 2). The ratios were virtually independent of the amount of sample extracted (FIG. 3A) or of the instrument laser power used (FIG. 3B). As a result, homologous peak ratios provided highly dependable information about proteins in the sample. It is thought that homologous peak intensity ratios were representative of protein abundance. For example, extraction may apply to only a subpopulation of the total pool of protein. As a consequence, information provided by homologous peak ratios was best interpreted as a very accurate and reproducible feature of a given protein sample.

TABLE 2
Coefficient of variation (CV) for replicates of one sample
versus different samples from one individual

| | | | |
|---|---|---|---|
| | | | One assay each of |
| | | | 6 samples from |
| | | One assay each of 6 | one individual |
| | 6 Assays of one | spots from one | collected over 2 |
| Ratio | spot | sample | year period. |

Homologous peak ratios

| | | | |
|---|---|---|---|
| CI′/CI^{a} | 4 | 3 | 14 |
| CIII2/CIII1 | 6 | 7 | 7.5 |
| CIII0/CIII1 | 11 | 5 | 26 |
| CIII2′/CIII1 | 5 | 11 | 18 |
| TTr/Cys-TTr | 6 | 17 | 22 |

Heterologous peak ratios

| | | | |
|---|---|---|---|
| CIII1/CI | 22 | 27 | 23 |
| CII/CIII1 | 17 | 12 | 14 |
| CII/CI | 32 | 21 | 21 |
| TTr/CIII1 | 14 | 13 | 17 |

^{a}CI, CII, etc. refer to apolipoproteins CI, CII, etc.

Intensity ratios of heterologous peaks gave higher standard deviations (about 20%, Table 2) but were relatively constant at low sample application (FIG. 3A) and at most laser intensity levels (FIG. 3B). The ratios changed substantially as the amount of sample was increased beyond a critical level (FIG. 3A). In fact, all heterologous peak ratios appeared sensitive to high sample extraction. This included the ratios of 9422/6631 (ApoCIII1 /ApoCI), 8915/6631 (ApoCII/ApoCI), 8915/942 (ApoCII/ApoCIII1) and 13675/9422 (TTr/ApoCIII1) (FIG. 3A). Therefore, it was unlikely that heterologous peak intensity ratios represented absolute protein concentration ratios. Despite this limitation, the heterologous peak ratios of two samples still suggest similarity or difference between the samples. The difference could arise from actual protein levels in the two samples or from the presence of other components that influence protein extraction. Either result provided information about a difference or a characteristic of an individual sample.

Standard deviations were determined for several types of analyses. The first was 6 evaluations of a single extraction of one MALDI spot (Table 2). The second was the average of a single analysis of 6 separate extractions of the same plasma sample. There was little difference in reproducibility of these two approaches, suggesting that extraction contributed less error than the subsequent MALDI-TOF analysis and that multiple evaluations of one extraction was a satisfactory method for determination of standard deviation.

A third comparison consisted of six plasma samples taken from the same individual over a 2-year period. Standard deviations for these samples were only slightly larger than those for multiple assays of the same sample (Table 2). This indicated that the protein profile was resistant to change. A similar outcome was obtained for a second individual from whom 6 samples were obtained over a 4-month period (see below). Thus, each of these individuals had a characteristic protein profile that was very stable over time.

A second approach for internal calibration of the MALDI-TOF spectrum is described as a ‘composite analysis’. The sum of several peaks constituted the internal standard to which all other peaks were compared. The standard consisted of: 0.3 times the intensity of ApoCI (m/z=6631) plus the intensities of ApoCII (m/z=8915), ApoCIII0 (m/z=8765), ApoCIII1 (m/z=9422) and ApoCIII2 (m/z=9713).

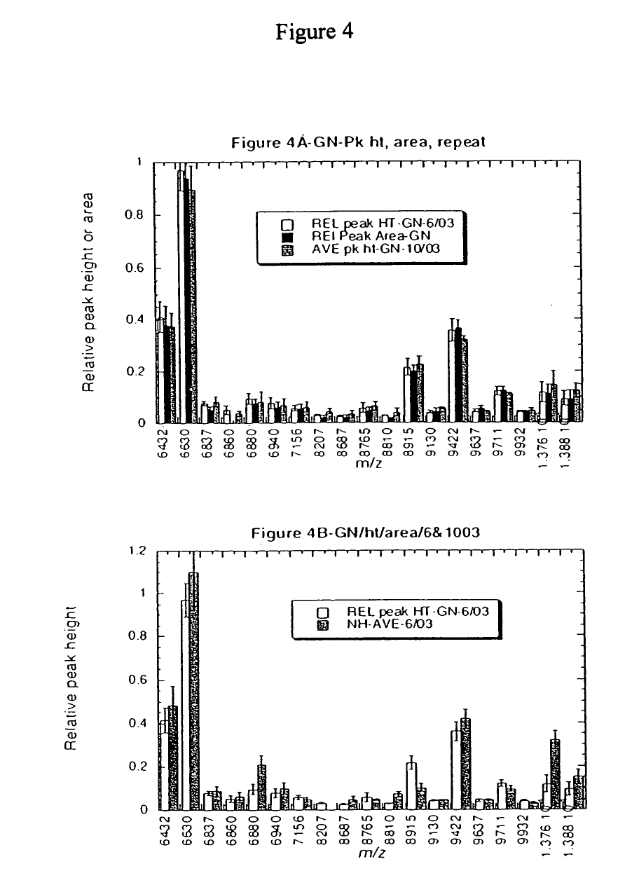

Protein profiles showed little change due to sample handling. The six samples from subject 1 gave standard deviations of about 10 to 20 percent for all peaks except 13761 and 13880, which gave 30 percent (FIG. 4A). Re-analysis of these samples after 4 months of storage and up to 12 freeze-thaw cycles gave results that were nearly indistinguishable from the earlier analysis (FIG. 4A). The only significant change was an increase of intensity of the peak at m/z=9130. This corresponds to asialo-ApoCIII1. Sialic acid is labile and may be hydrolyzed during storage. An earlier study suggested that the 9130 species arose entirely by hydrolysis in vitro (Bondarenko et al., J. Lipid Res., 40:543-555 (1999)).

A third method of data analysis used peak areas. In this case, the respective peaks were integrated and each was expressed relative to the same standard as was used for peak intensity, the sum of peak areas: 0.3*I₆₆₃₁+I₈₇₆₅+I₈₉₁₅+I₉₄₂₂+I₉₇₁₃. Peak areas gave results that were very similar to peak intensities (FIG. 4A).

Six samples from subject 2, gathered over a four-month period, were also analyzed by the composite method. Once again, standard deviations for individual peaks ranged from about 10 to 25 percent (FIG. 4B). Of the 18 peaks common to the two individuals, 9 were significantly different (FIG. 4B). Thus, each of these individuals displayed a consistent protein profile that differed substantially from the other individual. Once again, reanalysis of samples from subject 2 after 4 months of storage gave virtually identical results. Analysis of the spectra of subject 2 by peak area gave composite profiles that were virtually identical to those obtained by peak height.

Protein profile comparison in a larger population: Three samples were obtained from eighteen individuals over a 5-hour period as described above. The three MALDI-TOF spectra of each individual were treated as triplicate, identical samples and were used to obtain averages and standard deviations for that individual. The protein profiles were first evaluated by peak ratios. This included the 18 common peaks (FIG. 1A) minus redundant peaks (see above). The range of values for each peak ratio is illustrated for a homologous peak ratio (FIG. 5A) and a heterologous peak ratio (FIG. 5B). These results once again showed that the standard deviation was larger for heterologous peak ratios. The range of values for each ratio among the 18 individuals was 2 to 4-fold but occasionally higher (FIG. 5, Table 3).

TABLE 3
Range and median of selected peak ratios

| Peak ratio | Median value | Range |
|---|---|---|
| 6631/6433 (CI/CI′) | 2.02 | 1.45-3.14 |
| 8765/9422 (CIII0/CIII1) | 0.12 | 0.07-0..35 |
| 9131/9422(CIII0′/CIII1) | 0.10 | 0.07-0.13 |
| 9713/9422 (CIII2/CIII1) | 0.33 | 0.17-0.63 |
| 9642/9713 (CIII2′/CIII2) | 0.37 | 0.23-0.78 |
| 13880/13761 | 0.87 | 0.60-1.30 |
| (TTrCys/TTr) | | |
| 1.3013761/9422 | 0.46 | 0.23-0.96 |
| (TTr/CIII1) | | |
| 8915/9422 (CII/CIII1) | 0.52 | 0.23-0.84 |
| 6631/9422 CI/CIII1) | 1.70 | 0.51-3.22 |

Fifteen non-redundant peaks provided 105 peak ratios for each sample. These were compared with the ratios of other samples. Eighteen individuals in the Vienna study provided 153 total comparisons. Significant difference was defined as non-overlapping standard deviation (p<0.05). All individuals could be distinguished from each other by this approach. The number of significant differences ranged from 22 to 55. In fact, 5 homologous peak ratios were sufficient to discriminate all 153 comparisons with an average of 3.5 differences per comparison.

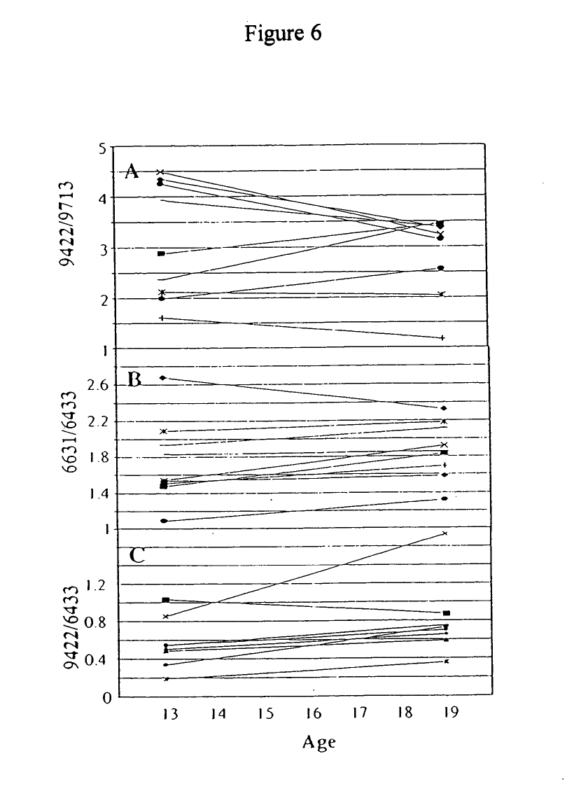

Consistency of peak ratios for individuals was also illustrated by the peak ratios shown in FIG. 6 for individuals at age 13 and 19. Each line and symbol indicated a different individual. As can be seen most individuals retained their own rank among the individuals.

Comparison of a profile from a normal individual with that of a severe sepsis patient (FIGS. 1A and 1B) illustrates the extreme ability to detect change. Quantification of intermediate stages is only limited by signal to noise and reproducibility of peak ratio measurements. A typical signal to noise value for the peak at 6631 was 100, providing approximately a similar number of quantifiable stages for measuring its disappearance relative to another peak. As shown in FIGS. 2B and 2C, even the lower intensity peaks can be measured at signal to noise ratios of 20 to 50, providing a similar number of quantifiable stages for disappearance of each from the profile. Given 15 non-redundant peaks in each profile and 105 peak ratios possible from these 15 peaks, it is apparent that there are thousands of quantifiable stages between a normal profile of a healthy person and the severe sepsis individual in FIG. 1B. Of course, the number of peaks is greater than 15 due to the new peaks that appear in the profile such as those from SAA.

In subsequent examples, profile analysis often focuses on a single peak ratio for disease diagnosis. This is done either because a single peak ratio appears adequate to diagnose diseases or for purposes of illustration. It is clear that many other peak ratios could be used, depending on the needs of effective disease diagnosis.

### Example II

### Determination of Protein Profile Deviations Caused by Food Ingestion

Determination of the plasma or serum protein profile before and after a meal provides a rapid and highly sensitive method for detecting persons subject to metabolic disease, or related disorders. The method includes obtaining blood though use of a standard method, such as a finger stick. The blood is then anticoagulated through use of any standard method and plasma is obtained by centrifugation and drawing off the clear plasma. Alternatively, the blood can be allowed to clot in a tube and serum obtained as the clot retracts and extrudes the serum. A convenient method to obtain serum in a non-hospital setting consists of performing a finger stick and collecting a large drop of blood, preferably in a plastic container, preferably containing a small glass or metal surface such as a glass bead. The glass or metal surface stimulates coagulation and the clot will retract toward that surface, leaving serum in the remainder of the container. The container can be a tube in which one part is glass and the other plastic. After the clot has retracted, the plastic part of the tube, containing the clear serum, can be separated from the glass and stored frozen until assayed. If the container is a cup-like shape, the serum can be removed and stored in a capillary tube. One convenient method that can separate the serum is to fill the capillary by touching the surface of the clear serum with the open end of the capillary. The serum will automatically fill the capillary. Capillary size can range from 0.5 to 10 microliters or any convenient size. The serum or plasma is stored in a frozen state until assay.

This process of obtaining plasma or serum is conducted before a meal. The process is repeated after ingestion of the meal. A typical meal may contain a high caloric intake, such as a meal that includes a hamburger (¼ pound) French fries and a soft drink (non-diet, 12 to 24 ounces), or a meal that includes 2 large slices of pizza and a soft drink. It may be desirable to test the protein profile response of an individual to many different meals and diets to determine those most healthful versus those most damaging to the protein profile of the individual. Plasma or serum samples are obtained at various times after the meal, such as from 1 to 10 hours, or at 2 and 5 hours after the meal.

Protein profiles are then obtained by MALDI-TOF analysis or any other appropriate method that detects a profile sensitive food intake as described herein and peak ratios obtained. Peak ratios are then used to determine the health status and the impact of the meal on the individual. A healthy response will be a small or negligible change in peak ratios after the meal with return to the initial protein profile by about 5 hours. An unsatisfactory response will consist of large changes in the profiles that are not corrected by 5 hours.

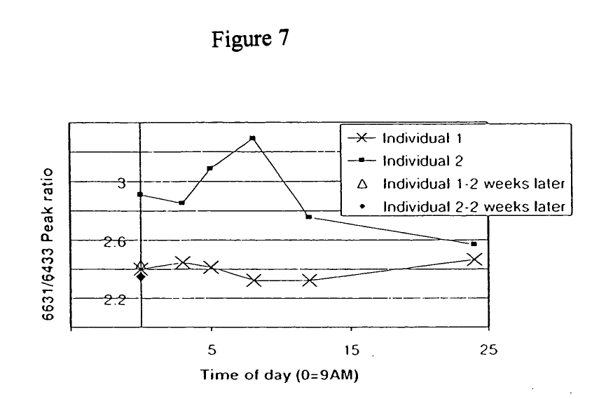

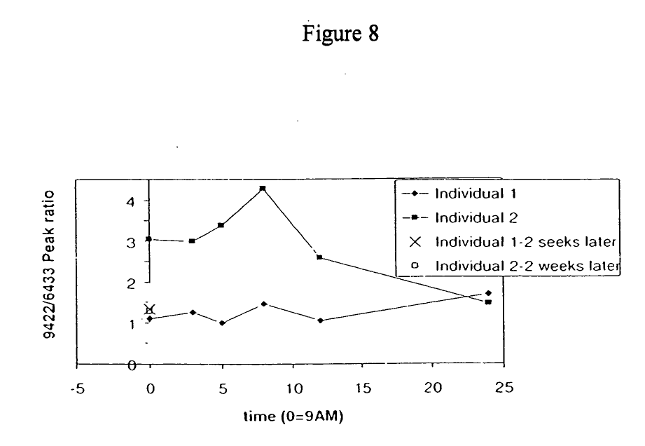

Examples of protein profiles obtained by MALDI-TOF analysis before and after a meal are shown in FIGS. 7 and 8. Protein profiles for individuals 1 and 2 were taken over a 24 hour period of a normal day, with a meal at noon (after the 3 hour time point). Individual 1 showed a healthy profile with little change in the peak ratios over this time. Furthermore, samples taken from this same individual on another occasion 2 weeks later gave the same value. In contrast, individual 2 showed a great change in protein profile over a 24 hour period, especially after the noon meal (3 hours was just before the noon meal). This same individual had a large difference in peak ratios on the second occasion, 2 weeks later. These variations are an unhealthy response and demonstrate a need for change in diet, life style or medication to stabilize the individual's protein profile. Finally, it can be noted that the absolute values for individual 2 were consistent with the insulin resistant population. As a result, this individual showed a protein profile suggestive of insulin resistance and also showed instability of the profile, two measures for potential development of metabolic and circulatory problems in the future. At the time of the assay, this individual did not have diabetes type 2 and was not considered obese (Body mass index of 26). However, this individual has a high rate of diabetes type 2 in the immediate family. The test indicated the potential to develop the problem in the future. For potential usefulness of this diagnostic tool, it can be noted that this individual started an immediate physical training program to improve health status.

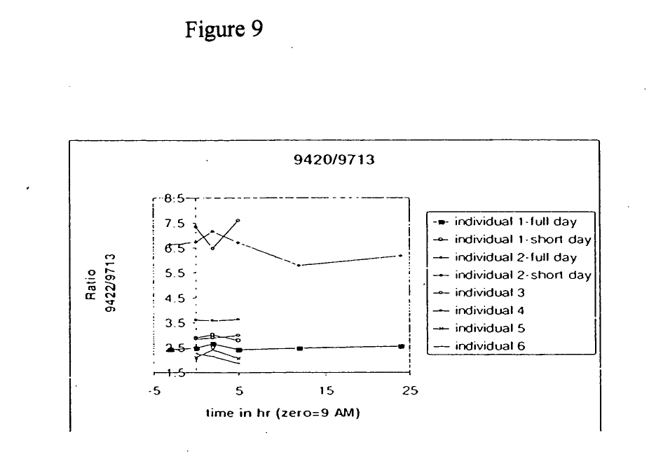

In another peak ratio of 9422/9713, these individuals were studied along with 4 others (FIG. 9). Again, individual 2 showed a high ratio, consistent with insulin, resistance while individual I had a low value. This particular ratio showed less variation due to a meal than the others shown in FIGS. 7 and 8.

The results of a meal were evaluated for all six individuals (FIG. 10). All consumed the same noon-day meal and peak ratios were determined before (zero time) and at 2 and 5 hours after the meal. The meal consisted of deep fat fried food, a large rice krispy bar and a 20-ounce soft drink. For ratios such as 9422/6433, three individuals showed little or no change after the meal and they returned to their initial status at 5 hours. Individuals 2, 3 and 4 showed unhealthy response and failed to re-establish their personal protein profile by 5 hours after the meal (FIG. 10A). Another peak ratio was 6631/6433 (FIG. 10B). The peak ratio from the individual before the meal was set at 1.0 and subsequent assays were expressed relative to this value. As can be seen, three individuals maintained a constant peak ratio while the other 3 showed significant change. Those who showed significant change had a higher incidence of metabolic disease in their families than those who showed no change.

Although the result can be expressed in many ways, for illustration purposes the alteration in protein ratio was calculated as a ‘delta value’ (FIG. 11). This is equal to the ratio of the 9422/6433 peaks at five hours after the meal to the ratio before the meal minus 1.0. Subtraction of 1.0 makes the delta value a measure of fractional change in protein profile at the 5-hour time point. The same calculation was made for the peaks at m/z=6631/6433. The sum of the delta values is presented in FIG. 11. This manner of adding values assumes equal importance of each peak ratio. However, some peak ratios may be more important than others and each can be multiplied by a weighting factor before the values are added. In the current calculation, individuals 1, 5 and 6 gave delta values of approximately zero. In fact, individual I overcompensated slightly at the 5-hour time point and the delta value was slightly negative.

Individuals 2, 3 and 4 showed substantial change in protein profile after the meal And their delta values were all quite large (FIG. 11). All three of these individuals had substantial linkage to type 2 diabetes. Thus, this diagnostic test can detect propensity to develop type 2 diabetes and can be used to monitor success of therapy or life style changes that are made to correct the syndrome.

Since healthy individuals have very constant protein profiles, the diagnostic test might consist of as few as two samples, one taken before breakfast and another at 5 hours after a large noon meal. Samples taken around the evening meal can also be considered or samples before and after a large breakfast may be used. Since the profiles of persons susceptible to metabolic disease vary from day to day, another approach would be to analyze samples taken on different days for a time period sufficient to detect an individual's variation. With proper analysis, even a single test may be sufficient to detect persons with unhealthful response to a high caloric meal. This test could be administered at 5 hours after a large meal. This time point is thought to maximize the difference between persons who have healthy versus non-healthy responses to the meal and who have actual protein ratios characteristic of the metabolic syndrome.

### Example III

### Protein Profiles and Insulin Resistance

From a larger group of samples obtained from adolescents (age 13±1 year) a subgroup of 40 were selected. Each of 10 were taken from the four quadrants of the population. The four quadrants were defined by the average BMI, half are above this value and are characterized as obese and half are below this value and are characterized as thin. Sensitivity to insulin was also established and those above average sensitivity were characterized as insulin sensitive while those below average were characterized as insulin resistant. These characteristics have been previously described (Sinaiko et al., J. Pediatr., 139:700 (2001)). Serum samples from 10 individuals in each of the four quadrants (thin-insulin sensitive, thin insulin resistant, obese-insulin sensitive and obese-insulin resistant) were extracted and protein profiles obtained by the procedures outlined in Example I. Specific peak ratios in the protein profile were used to detect differences that might diagnose precursors to a metabolic syndrome. This analysis was also applied to a group of 40 adults, 10 in each of the four quadrants for adults.

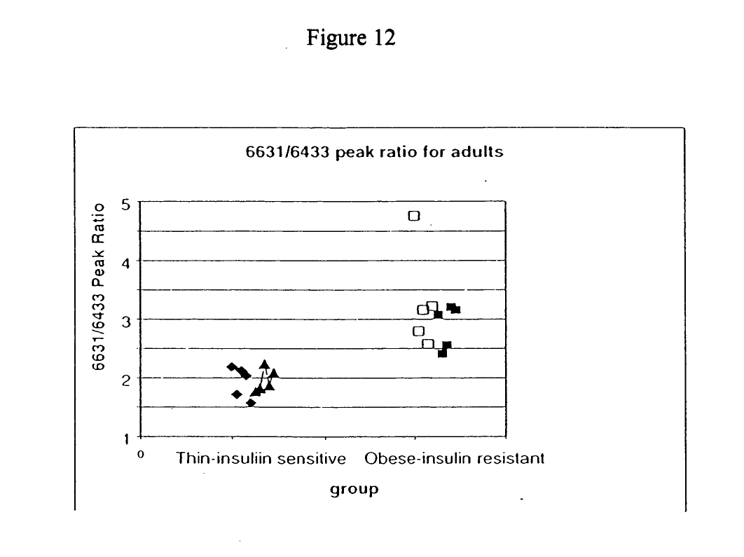

FIG. 12 shows the 6631/6433 peak ratio for thin-insulin sensitive adults (solid diamonds=females, and solid triangles=males) with thin insulin resistant adults (Open squares=female, solid squares=males). Insulin resistance in adults was easily detected by several peaks in addition to those given in this figure. Obesity without insulin resistance had much less impact on the protein profiles but was detectable from others. It was possible to diagnose insulin resistance from the 6631/6433 peak ratio. Previous studies have shown that this peak ratio was lower in an individual with hyperlipidemia (Bondarenko et al., J. Lipid Res., 40:543(1999)). In fact, since these peaks represent apolipoprotein CI, it might be expected that persons with abnormal lipid content could have altered peak ratios. It was surprising therefore to find that the peak ratio correlated very well with insulin resistance, a property not as intimately associated with lipoprotein structure.

This peak ratio was examined in larger populations of individuals. It was interesting that the proportion of individuals with high values correlated well with the known rate of development of type 2 diabetes in the respective population. Two groups of adults from Europe, one from Austria (18 individuals) and the other from Norway (80 individuals) showed 13 and 15 percent of individuals above a 6631/6433 peak ratio of 2.5, the approximate cutoff for the insulin sensitive vs. insulin resistant populations shown in FIG. 12. Sixty samples from Native Americans revealed 68% of individuals above the 2.5 value with many giving a very high ratio. Of forty American Medical students, 38% gave a peak above 2.5. High ratio of 6631/6433 does correlate with highest rate of diabetes in Native Americans, second in Americans in general and third in European populations.

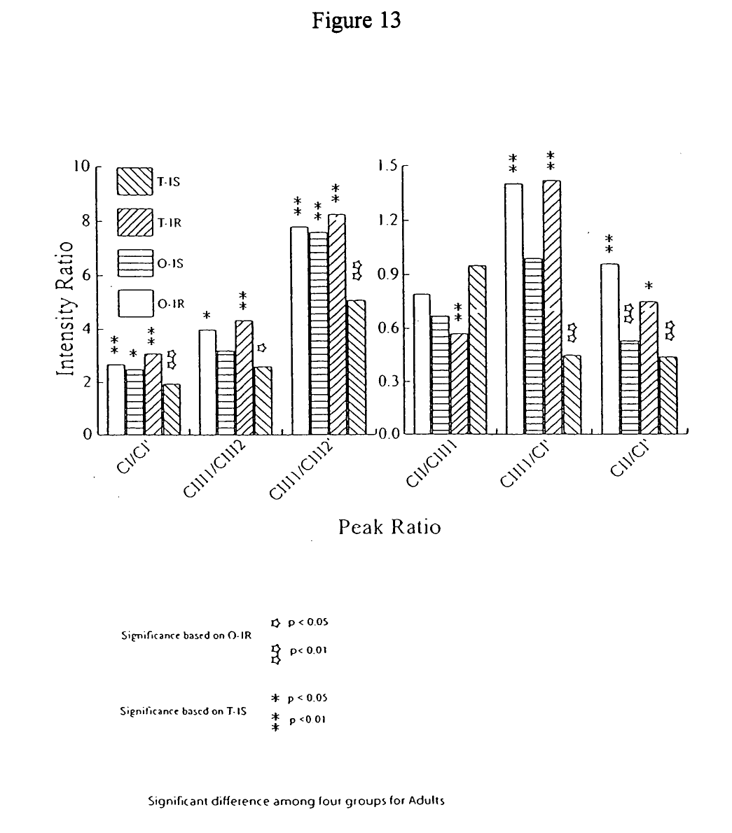

A number of significant differences exist in peak ratios of the profile that can be used to distinguish insulin resistant from insulin sensitive adults. Some of these ratios are summarized in FIG. 13. FIG. 13 shows that significant differences can be detected between the four quadrants for adults. The groups are as described. Highly significant difference (p<0.01) of a peak ratio relative to the obese insulin resistant population are shown by double stars while a highly significant difference relative to the thin-insulin sensitive group are shown by a double asterisk. Significant differences (p<0.05) are indicated by a single star or asterisk. The peak ratios are shown along the bottom of the axis. Peak identity is as given in Example I, Table 1).

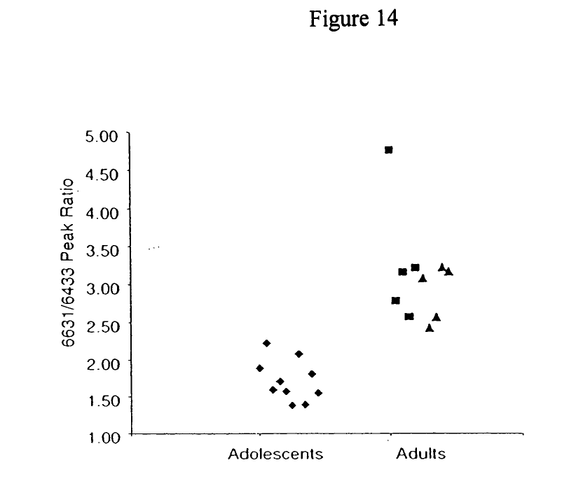

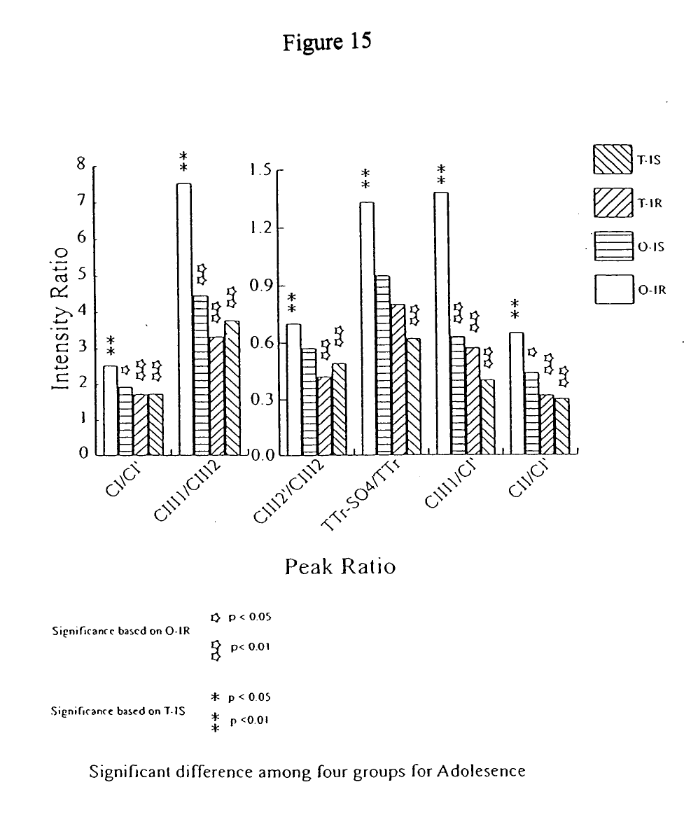

Adolescents also showed significant difference among these populations with some difference from adults. For example, FIG. 14 shows the 6631/6433 ratio for thin-insulin resistant adolescents versus the corresponding adults through comparison of adolescents with adults for the 6631/6433 peak. Thin-insulin resistant individuals in both categories were compared. Adolescents (solid diamonds) were similar to the values for thin insulin sensitive adults and adolescents. Adults (solid squares=females, solid triangles=males) were clearly different from thin-insulin sensitive individuals of either age group. Adolescents cannot be differentiated by this peak ratio but show others that can diagnose obese insulin resistant individuals. This shows however that age difference in disease can be detected by this method. Significant differences in peak ratios for adolescents are shown in FIG. 15. Average values for peak ratios in the four quadrants for adolescents are shown. Highly significant difference (p<0.01) of a peak ratio relative to the obese insulin resistant population are shown by double stars while a highly significant difference relative to the thin-insulin sensitive group are shown by a double asterisk. Significant differences (p<0.05) are indicated by a single star or asterisk.

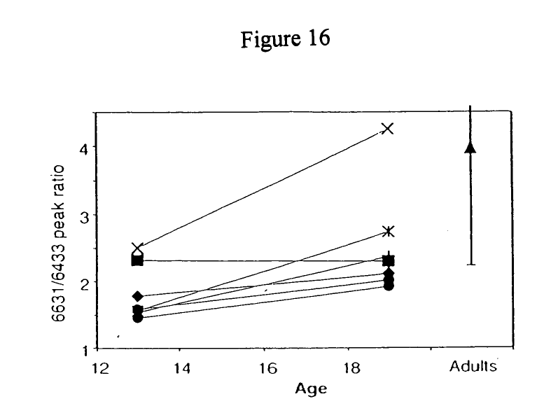

In contrast to the stability of profiles for thin, insulin sensitive adolescents between ages 13 and 19 (FIG. 6A), the 6631/6433 peak ratio underwent substantial change among adolescents who were obese and insulin resistant in this age change (FIG. 16). This shows that obesity can destabilize protein profiles, an unhealthy development for obese individuals.

### Example IV

### Profile Analysis Combined with Other Clinical Information

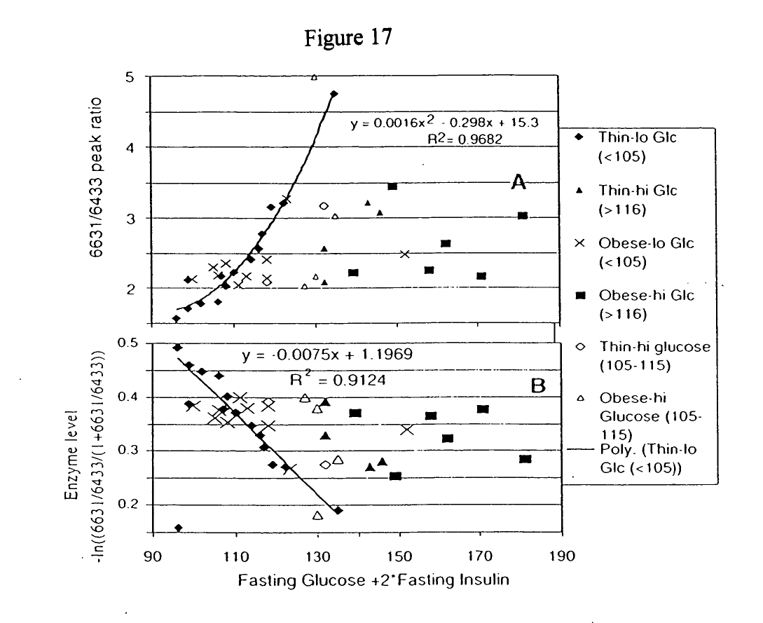

Results from protein profile analysis can be combined with other types of data to provide improved diagnosis. ‘Metabolic fitness’ is meant to be a general term that describes relative health with respect to metabolism of glucose and lipids. For example, at one extreme is type 2 diabetes and at the other extreme a thin, insulin sensitive individual with low fasting glucose levels and low increase in glucose after a meal or as a result of the glucose tolerance test. A number of peak ratios were correlated with insulin resistance, for example. The 9422/9713, 9422/6433, 6631/6433 peak ratios are special examples. A detailed example of how these may be used is illustrated by determination of metabolic fitness by a combination of the peak ratio at 6631/6433 and some combination of the blood glucose, insulin sensitivity and/or insulin level. These parameters might be combined after a fast, before and after a meal or in combination with the glucose tolerance test. There are many ways in which various standard blood tests can be combined to provide a diagnosis of metabolic fitness. For example, a positive correlation was found between the 6631/6433 peak ratio and fasting insulin, fasting glucose level and insulin resistance. Any combination with protein ratios in the profile might be useful for diagnosis of metabolic health. The explicit example shown in FIG. 17A gives the 6631/6433 peak ratio plotted versus the concentration of fasting glucose plus two times the level of fasting insulin. Although many ways of combining the data can be considered, the manner shown produces an excellent correlation. The sum of fasting glucose plus fasting insulin in the blood shows the level of insulin needed to maintain the glucose level measured. The fasting insulin level was multiplied by 2 in order to give these terms equal weight in the analysis. That is, the range of values for fasting glucose was about 2-times greater than the range of values for fasting insulin. Multiplication of the latter by 2 equalized the importance of these terms. Naturally, other multipliers or ways of combining the data can apply. The terms might be combined by multiplication with weighting factors for each term.

The results show that thin individuals (BMI<25) who have low fasting glucose (<105) accurately follow a specific curve and can be described by the relationship provided by the equation in the Panel A of FIG. 17. With only one exception, obese individuals who had low fasting glucose also fit this curve. As blood glucose increased for both thin and obese individuals, there was a gradual displacement from this correlation. Individuals with moderately high glucose (106-115 mg/dL) were displaced to a lesser extent than persons with high glucose (>115). Obese individuals were farther displaced than thin individuals.

From this curve it is apparent that the correlation between the 6631/6433 peak ratio cannot fit the curve for any values for fasting glucose+2 times fasting insulin of above about 130. Thus, rather than using fasting glucose alone, fasting insulin alone or glucose resistance alone, an improved diagnosis of metabolic fitness may be to use fasting glucose+2times fasting insulin along with protein profile results. Persons above a value of 130 for glucose plus 2 times insulin can be assured of poor metabolic fitness. This might be considered a prediabetic condition.

It is evident that the relationship of these three measurements can provide a very accurate measure of metabolic fitness. Those individuals who are metabolically fit are defined first as having low fasting glucose levels (<1 05 mg/dL) and second of being thin (BMI<25). The results for these individuals were combined to produce the extremely accurate relationship in FIG. 17. This method of analysis can be used to evaluate current health as well as an individual's response to therapy, exercise, change in diet, and other life style modification. The objective should be for every healthy person to fit onto the line defined by those individuals who are thin and have low glucose. The combined information obtained from the protein profile and blood glucose and insulin can be used to diagnose change in metabolism. For example, it is apparent that a person can develop high blood glucose levels by becoming insulin resistant and moving further out on the horizontal scale shown in FIG. 17A. However, a person might also develop high blood sugar by having too high a ratio of 6631/6433. Temporary elevation of the 6631/6433 peak ratio might be responsible for temporary development of high blood glucose. An example might be diabetes associated with pregnancy (gestational diabetes) or any other health condition that is known to produce high blood sugar and inappropriate metabolism. The protein profile can assist in diagnosis of these conditions and can help determine the exact basis for the diabetes condition.

Although an accurate explanation for the results in FIG. 17A is not necessary for its use in diagnosis, one speculation suggests a potential importance to glucose metabolism. The 6433 peak arises from enzyme degradation of the peak at 6631 by removal of the amino terminal two residues. A candidate enzyme is dipeptidyl peptidase IV (DPPase IV), a protease found on cell surfaces in the blood. This suggestion was supported by an experiment in which human plasma was incubated with hog kidney DPPase IV (purchased from the Sigma Chemical Company) and the resulting sample was subjected to MALDI-TOF profile analysis. The enzyme converted all of the material in the peak at 6631 to material in the 6433 peak. The link to diabetes may occur through the incretin hormones that are released after a meal and are thought to cause release of insulin from the pancreas. Incretins are thought to be inactivated by DPPase IV. In this case, a low level of DPPase enzyme should result in a high ratio of 6631/6433. Low DPPase IV enzyme should have the effect of increasing the length of time that incretins are present in the blood stream and, thereby, the strength of an insulin response to a meal. Consequently, it is possible that individuals who might be characterized as insulin resistant solely on the basis of a high level of fasting insulin, may in fact be relatively healthy and have normal blood sugar, if they have low levels of DPPase IV. In effect, a low responsiveness to insulin might be compensated by a low level of the DPPase IV that prolongs the insulin response. This explanation is not essential to the obvious value of the combined data in FIG. 17A to evaluate metabolic fitness. However, this correlation illustrates that diabetes may arise from an imbalance of any of several components. These include insulin levels, insulin sensitivity and the level of DPPase IV enzyme. Temporary diabetes such as gestational diabetes might arise from elevation of DPPase IV, which could be monitored by changes in the 6631/6433 peak ratio. Diabetes from other disease states may also arise from such change, making protein profile analysis a very valuable tool for diagnosis.

In work by others, a lowered level of plasma DPPase was found in middle aged obese persons with diabetes versus obese persons without diabetes (Meneilly, G. S., Demuth, H.-U., McIntosh, C. Hs. S. and Pederson, R. A. (2000) Diabetic Medicine 17, 346-350). A suggested conclusion was that lowered plasma DPPase may be a natural adjustment to overcome low response to insulin in persons with diabetes type 2. However, it is not clear that plasma DPPase enzyme is responsible for cleavage of the m/z=6631 to 6433 component. The 6631/6433 peak ratio showed little change upon storage of undiluted plasma at room temperature for up to 24 hours. Fifty-fold dilution of plasma resulted in only a 20% decrease in the 6631/6433 peak ratio after incubation at room temperature for 3 hours. A hypothetical explanation for this property is that dilution allowed dissociation of the 6631 component from the lipoprotein particles, making it subject to enzyme cleavage. This result suggested that the important DPPase enzyme, if responsible for the 6631 cleavage to the 6433 peak, is not the low activity found in plasma but another pool of enzyme such as that on cell surfaces. The utility of the 6631/6433 peak ratio for diagnosis was discovered by random search of protein composition in the blood and explanations for its origin and theoretical basis for diagnosis remain hypothetical. The 6631/6433 peak ratio may arise by any of several mechanisms and only correlative results are able to suggest that it might be useful in determining metabolic fitness or other property.

Increase or decrease of DPPase IV enzyme has been suggested to be involved in many other conditions including various tumors, hematological malignancies, immunological, inflammatory, psychoneuroendocrine disorders, and viral infections (reviewed by Lambeir, A.-M., Duinx, C., Scharpe, S., and De Meester, I, 2003) Critical Reviews in Clinical Laboratory Sciences 40, 209-294). Consequently, if DPPase IV is responsible for cleavage of the 6631 peak to the 6433 peak, the 6631/6433 peak ratio may be a biomarker for several conditions. FIG. 17B shows another way to plot the result. The ratio of 6631/6433 can be converted to a measure of the relative amount of enzyme action by the relationship, −ln((6631/6433/(1+6631/6433)). This relationship provides an approximately linear correlation versus the sum of fasting glucose plus 2 times fasting insulin (FIG. 17B). Linear graphs are often preferred for analysis. The equation that fits the line is given in FIG. 17B along with the R squared value.

It is suggested by others that synthetic inhibitors of the DPPase IV enzyme may provide a good therapy for type 2 diabetes since the incretins would persist for a longer time and larger amounts of insulin would be produced. It is apparent that the protein profile and specifically the 6631/6433 peak ratio could be used monitor therapy by inhibitors of DPPase IV since inhibition would result in a higher ratio of 6631/6433. Dosage of a DPP inhibitor can be adjusted until the proper ratio of 6631/6433 is reached. The optimum ratio would be determined by the individual's responsiveness to insulin. Lower responsiveness will require higher dosage levels of inhibitor that result in lower levels of 6631/6433.

Plasma can be extracted by any of a number of methods to obtain the 6631/6433 peak ratio. For example, extraction of 0.5 uL of plasma with magnetic beads coated with a weak cation exchange matrix was carried out with a commercial kit from Bruker Daltonics, Inc. The important peaks at 6631 and 6433 were very evident in the resulting profile and the ratio obtained was indistinguishable from the ratio obtained with ZipTip extraction. Virtually any extraction method that accurately detects the 6631/6433 peak ratio by MALDI-TOF analysis can also determine the presence of the low mass variant or the polymorphic form of apolipoprotein C1.

Alternative peptides in the plasma may also represent the activity of DPPase. An example that was observed in some individuals with a peak at m/z=5082±4. A second peak with a relative intensity of 0.2 when compared with the 5082 peak occurred 198 mass units lower (m/z=4885±4). These peaks were related in a manner similar to that of the 6631/6433 peaks. To fully demonstrate this relationship, 0.5 microliters of plasma were diluted to 20 uL of buffer (pH 7.5) and 1 unit of hog kidney DPPase (Sigma Chemical Co., St. Louis Mo.) was added. After 2 hours at room temperature the sample was acidified and extracted with the ZipTip as usual. The 5082 peak had been completely digested to the 4885 peak. Therefore, the 5082/4885 peak ratio found in serum or plasma may present a measure of DPPase activity in that individual. The 5082 peak was most abundant in persons with the highest levels of the 4150 peak. Consequently, the 5082 and 4885 peaks are a useful biomarker of the conditions linked to the 4150 peak.

The ratio of 6631/6433 can also be detected by methods other than mass spectrometry. For example, the plasma can be applied to a chromatographic column such as reverse phase and the ratio determined by protein absorption of ultraviolet light as the proteins elute from the column. Thus, knowledge that the relationship of the 6631/6433 peak ratio to metabolic fitness and to type 2 diabetes is a key discovery that can stimulate development of alternative methods to analyze these components.

Peak ratios of the protein profile can be used to monitor health benefits from exercise. An example is the ratio of m/z=6631/6433. Before start of a new exercise program, this ratio (9 samples taken over a 3-week period) in a healthy adult male was 2.59±0.07. After 3 months of added physical activity (100 miles of bicycle riding per week), the ratio declined to 2.29±0.07 (3 samples taken over a period of 7 days). This change was detected on three other occasions due to seasonal change in physical activity. The average for three other instances before the exercise program was: m/z=6631/6433=2.54±0.09. The average after 4 months of the exercise program was 2.26±0.13. These changes show an enhancement of metabolic fitness. The change due to exercise moved the average for the peak ratio farther from the insulin resistant phenotype that is shown elsewhere in this document (m/z=6631/6433>2.5). Addition of fasting glucose and fasting insulin levels to analysis of response to exercise will provide a more comprehensive diagnosis of metabolic fitness.

It is evident that this approach can be used to monitor any type of lifestyle change such as diet, weight loss or gain, advancing disease that produces diabetes, and other conditions resulting in a modification of metabolic fitness.

### Example V

### Peaks Produced by Disulfide Reduction of Plasma or Other Fluids

Different polypeptide chains of some proteins are covalently linked by disulfide bonds. These can be reduced to release the individual polypeptide chains. Common reduction agents are sulfhydryl compounds such as mercaptoethanol or dithiothreitol. Other reducing agents can also be used. Another common practice after disulfide bond reduction is alkylation of the free sulfhydryl groups by agents such as iodoacetic acid or iodoacetamide. This eliminates the free sulflhydryls and the possibility of further, unwanted reactions of these active groups in subsequent steps of an extraction. Reaction conditions that allow these reagents to modify only the sulfhydryl groups of a protein are well known.

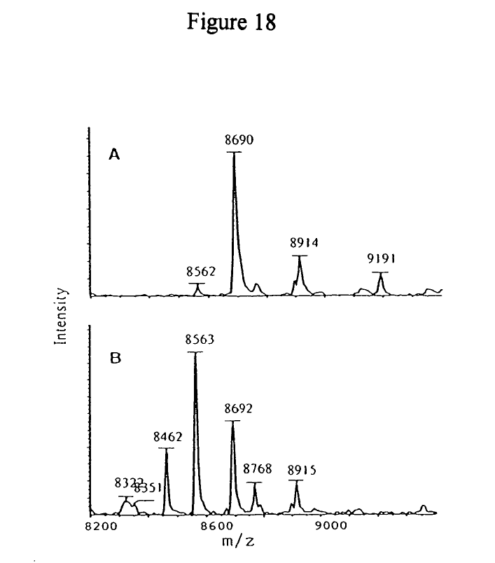

In the preferred method shown in FIG. 18, plasma reduction was accomplished by mixing 0.5 microliters of plasma with 3 microliters of 0.1 M sodium bicarbonate and 1 microliter of 0.1 M dithiothreitol. The mixture was incubated for 30 minutes at 37 degrees centigrade and was then acidified by addition of 0.5 microliters of 10% TFA and extracted by C4 ZipTip as described elsewhere in this document.

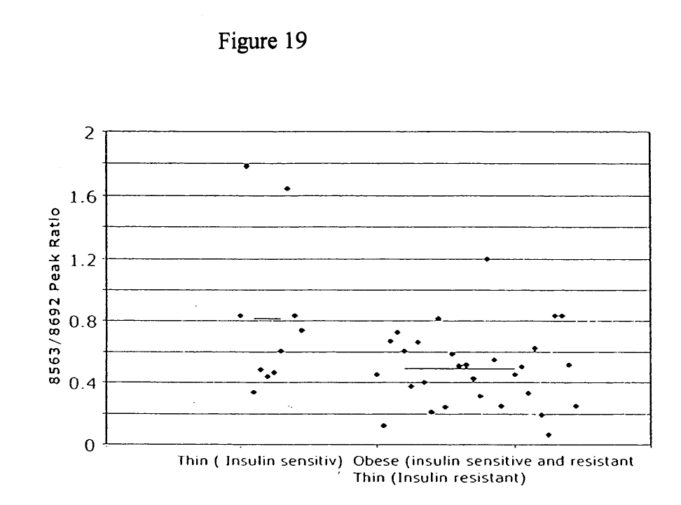

Disulfide reduction of plasma followed by MALDI-TOF profile analysis revealed several new and very important components of the profile. One has a m/z of 8692 and is shown in FIG. 18. This corresponds to the mass of Apolipoprotein All with amino terminal pyrrolidone carboxylic acid. A second peak arises from removal of a single amino acid residu, glutamine, from carboxy-terminus of the parent peptide to generate a peptide with m/z=8563. A third peak is also derived by removal of a second amino acid, threonine, from the parent protein to give an m/z=8462. Individuals differ greatly in the distribution of these peaks as shown by FIG. 18A vs. 18B. Among individuals who do not suffer from major disease, a higher level of proteolytic degradation represents greater health. This is seen in FIG. 19 where thin insulin-sensitive individuals have a higher level of the breakdown products of the protein (m/z=8563, 8462). Comparison of the Thin insulin-sensitive population with thin-insulin resistant+Obese insulin sensitive/resistant groups showed a p-value of 0.02, indicating a significant difference. Visual inspection of the results indicate that the Thin insulin sensitive group had some individuals who gave very high ratios for 8563/8692 while the other groups had more individuals with very low ratios. As for homologous peaks of other proteins, these peak ratios were highly reproducible with standard deviation for replicate samples of ±4 percent or less of the average. Overall, for purposes of disease diagnosis, ratios of peaks from reduced plasma at m/z=8692, 8563 and 8462 provide a highly accurate measure that can be related to certain types of health status. One example of their use is in detection of factors related to obesity and insulin resistance.

### Example VI

### Prediction and Diagnosis of Graft Versus Host Disease

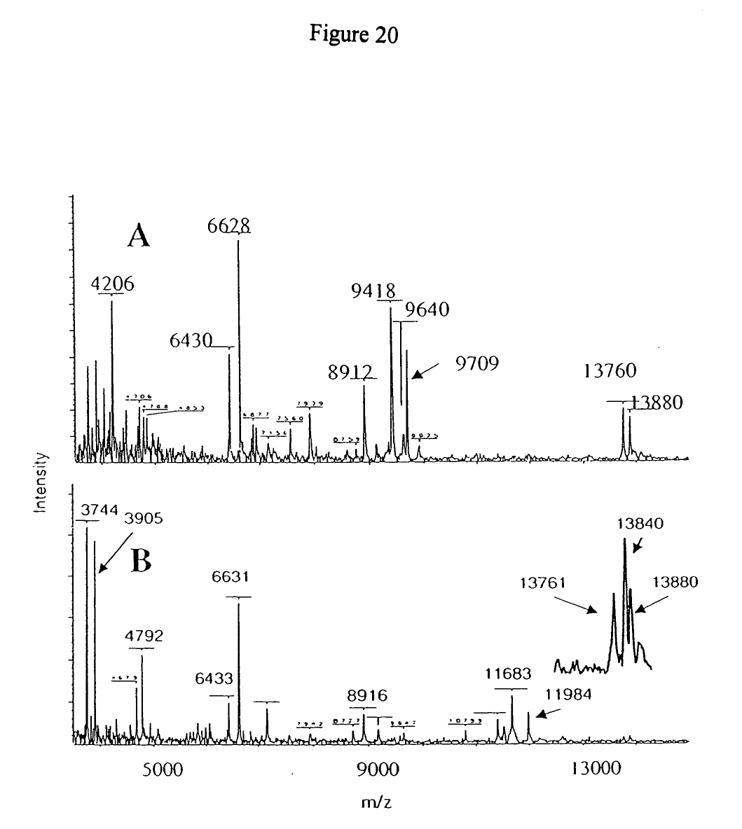

Patient plasma was extracted according to methods described herein and analyzed by matrix assisted laser desorption ionization-time of flight mass spectrometry (MALDI-TOF). This procedure produced highly reproducible protein profiles (FIG. 20A). To date, several hundred samples have been analyzed by this method. The method is highly robust, sensitive, reproducible and relatively unaffected by multiple free-thaw cycles of the sample. Eighteen peaks have been identified that are common to all healthy individuals. Ultimately, the data are analyzed by the ratio of one peak intensity to another within each spectrum (for instance, intensity of the peak at 6628 to that at 6430, etc., FIG. 20A). The values were very constant for healthy individuals. For example, eight samples from one individual over a 2-year period showed standard deviations for peak intensity ratios of ±10 to 20 percent. Each individual was unique and the range for values of a particular peak ratio among healthy individuals was about 4-fold.

Analysis of serum obtained from patients at various time points after umbilical cord blood (UCB) bone marrow transplant (BMT) was carried out. A cohort of patients who experienced severe intestinal GVHD (n=5) and those that did not (n=6) was selected. FIG. 20A shows the result for a patient at day +30 who did not experience GVHD. This profile is within the range of patterns observed for healthy individuals without transplant. In contrast, persons with GVHD showed many features that were outside the range of healthy individuals. For example, the GVHD sample (FIG. 20B) shows complete loss of the peaks for transthyretin (TTr) at 13700-13900. Normally, this family of peaks includes the native structure at 13760 (±0.1%), which has a free sulfhydryl, and TTr-Cys, with a cysteine linked to the sulfhydryl group (FIG. 20A, m/z=13880±0.1%). Nearly lost is the peak from apolipoprotein CIII1 at 9422. The peaks at 11683 and 11401 in the GVHD patient arise from serum amyloid A (SAA), an acute phase reactant. A sulfonylated form of TTr-SO4 (m/z=13846, inset FIG. 20B) has been observed in other severe disease states such as end stage kidney disease. In GVHD patients, sulfonylated TTr-SO₄ was found among those with lower disease level or who were recovering. Also noted in FIG. 20B are a number of new, abundant components that are yet to be identified, including the peaks at 3744, 3905, 4792, 9176 and 11984. These peaks offer additional methods for detection of disease or recovery. Other novel peaks appear below the cutoff of this spectrum (m/z=3500).

Serum can be collected from patients pre-transplant and at intervals, such as weekly or more frequent intervals. Spectral patterns can be analyzed by peak intensity ratios (see below) to better define specific changes that correlate with GVHD severity (grade) and location (intestinal versus skin). Controls can include allo-HCT recipients without GVHD and auto-HCT patients. During this analysis particular focus can be placed on abnormalities identified in samples collected at the time of GVHD. It can be determined whether changes (gains or loses of spectral peaks) were present prior to the onset of clinical disease, assessing whether this technique has predictive value. Novel biomarkers for GVHD can be identified and spectral peaks (i.e., identify the protein sequence) that are unique to GVHD patients can be identified.

Data analysis: The spectra shown in FIG. 20 was first converted to a peak list of m/z versus intensity. All spectra were aligned so that every spectrum gave the exact value of m/z for the appropriate peak. The error of linear MALDI-TOF is approximately ±0.1% so the peak at 6631 can appear between 6625 to 6639. A computer program to accomplish this has been constructed, but all results must still be examined by manual methods to ensure that peak assignments are correct. The peak ratios are then calculated. A total of 15 peaks per spectrum will provide 105 peak ratios. A subset of these can be used, which will be identified by inspection of the data. Additional peaks may be considered as a group (the sum of intensities from new peaks, relative to the intensity of a known peak may be used). Peak ratios, singly and in combination, are correlated with clinical data to identify biomarkers that are useful for specific aspects of disease, such as pre-diagnosis, prognosis or recovery. Correlations will be accomplished using standard statistical methods. Repeated measures analysis will be used to take into account measurements over time as well as measurements of multiple proteins within the same patient at a single time point.

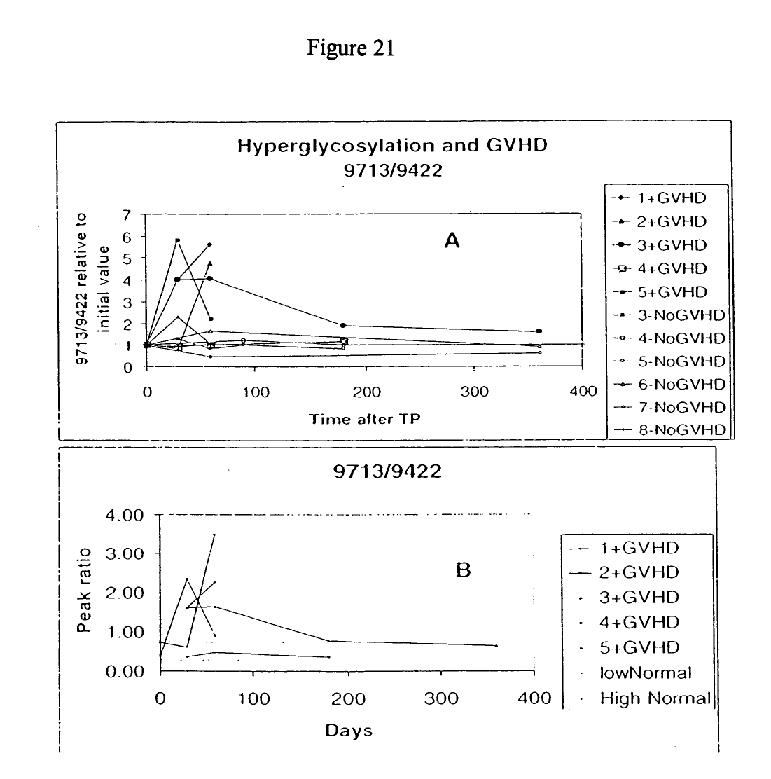

Glycosylation state as a biomarker. Among the components observed in the protein profile are the glyco-isoforms of apolipoprotein CIII. Glycosylation state can be used to detect health or disease of the blood or cells of the protein's origin. As an example, five individuals with graft versus host disease (GVHD) were analyzed at multiple time points. The peaks at 8765, 9131, 9422 and 9713 represent the four glycosylation states of apolipoprotein CIII, with increasing levels of carbohydrate from low to high mass. Protein profiles can be analyzed by numerous ways. The ratio of the peak at 9713 to that at 9422 was compared for the various samples. FIG. 21A shows one peak ratio of m/z=9713/9422. This method of analysis can be applied to any of the peak ratios in the spectrum. The peak ratio is expressed relative to the initial value taken before BMT. Thus, zero time gives a value of 1.0. Full recovery should result in a value of 1.0 for the subjects after BMT. Normally, this peak ratio is extremely stable with less than 7.5 percent standard deviation for a healthy individual over a time period of 2 years (Table 2 of Example I).

For the 6 individuals who did not develop GVHD, there was little change in this peak ratio (<50%, FIG. 21 A) over the course of the time shown. In fact, many deviated less than 10% from their initial value. Individual 8 showed the largest change of 2-fold, but rapidly corrected to that individual's baseline value at 60 days. Four of the 5 who developed GVHD showed extreme change in this value that was sustained over time. Three of these individuals died (1+GVHD, 2+GVHD and 5+GVHD). One survived but has not returned to normal by 360 days and still would be unhealthy by this criterion (3+GVHD). One individual (4+GVHD, FIG. 21A) who was diagnosed with GVHD did not show large alteration in this peak ratio and diagnosis on this basis would suggest that disease was not serious. In fact, this individual survived.

Large changes in this peak ratio are associated with severe states such as GVHD and are also found in cases of severe sepsis. Such large changes produce peak ratios that are far from those of healthy individuals (generally 0.2 to 0.8) and the raw peak ratio alone, without reference to the initial value before BMT, can be used in diagnosis of the disease. FIG. 21B shows this approach and gives the raw ratios without correction for the individual's personal profile taken before BMT. It is clear that individuals 1, 2, 3 and 5 have values far from the range of normal values. Diagnosis would be possible without reference to initial scores for these individuals. However, use of a protein ratio that is uncorrected for the individual's normal value may over-estimate or under-estimate the extent of disease. For example, the raw value indicates that individual 3 has returned to normal status by 200 days. More accurate analysis by comparison to pre-BMT status shows that this individual is still on a healing state up to day 360 but is slowly returning to normal status (FIG. 21A). The raw score indicates that individual 5 is nearly normal at day 60 (FIG. 21B) but the relative score (FIG. 21A) shows that this individual is still far from his/her personal normal value and is therefore still quite ill at day 60. This individual did not survive. This example shows that comparison to a person's personal profile is a more accurate method of diagnosis than is comparison of the ratio to the values characteristic of the range for all healthy individuals, even when values are outside of the range for normal individuals.

The results show that high and increasing levels of the hyper-glycosylated form of apolipoprotein CIII represent a biomarker of disease. Surviving individuals showed recovery of a normal distribution for glycosylation. A similar pattern was obtained for the 9713/8765 peak ratio from these individuals. Six transplant individuals who did not develop GVHD were all showed ratios of 0.6 or lower for this ratio over all time points. Thus, glycosylation state can be used to diagnose GVHD and the advance of this condition. Many other components of the profile can be used as well.

### Example VII

### Determination of a Response to Endotoxin

Healthy subjects received a low dose of endotoxin (lipopolysaccharide from E. coli) (Sigma Chemical Company, St. Louis, Mo.) at time=0. The procedure for administration has been described (Pernerstorfer et al., Blood, 95:1729-1734 (2000)). Blood samples were taken three hours before administration of the endotoxin and at 1, 2, 4, 8 and 24 hours after administration. Plasma was frozen until assayed. The assay was that described in Example I. Plasma (0.5 microliters, was added to 15 microliters of water:acetonitrile:TFA (95:5:0.1) and the solution allowed to stand at room temperature for 60 minutes. The sample was extracted with a C4 ZipTip and spotted on the MALDI target along with a sinipinic acid matrix. The profile was obtained in the usual manner.

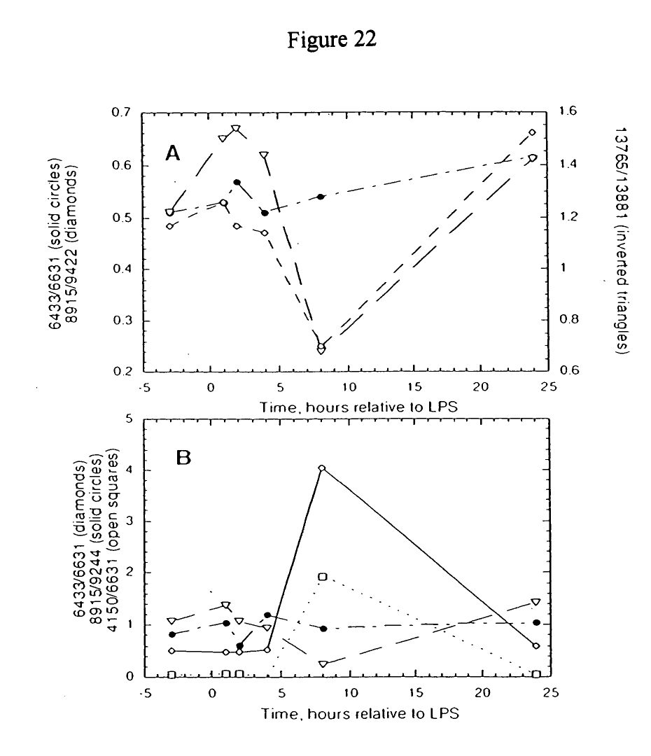

Eighteen individuals were analyzed and protein profiles obtained. Some individuals showed a mild response to endotoxin, with relatively small change over a 24 hour period. The change in specific peak ratios for such an individual is shown in FIG. 22A. Even the smaller impacts were substantial as indicated by the alteration in profiles documented in FIG. 22A. This subject did not show a 4150 m/z peak or evidence of protein mass increases due to oxidation.

A radical response to endotoxin is shown in FIG. 22B. This subject showed major changes in protein profile, especially evident at 8 hours, although also evident at earlier times. There were many additional changes in the profiles that are not shown. For example, at 8 hours, the ratio of 4150/6433 is plotted instead of 4150/6631 since the latter was virtually absent from the spectrum. At 8 hours nearly all peaks were oxidized as evidenced by increased mass by +16 or +32 mass units. All other times gave normal m/z values for these peptides.

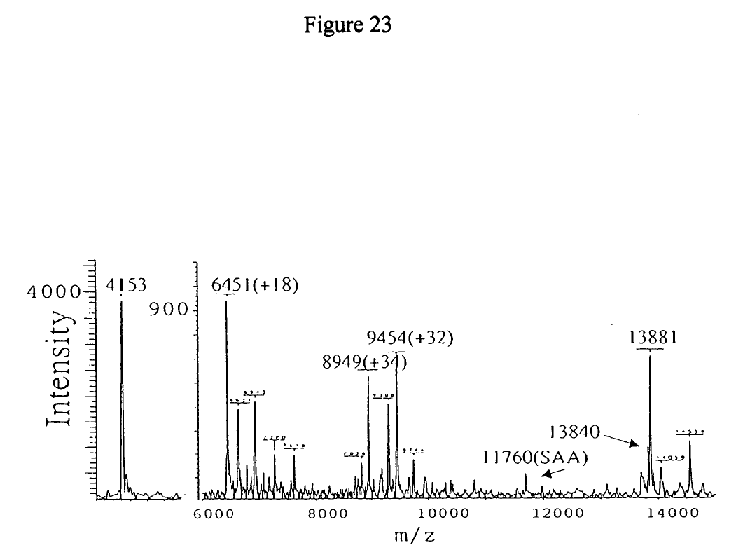

Six individuals also demonstrated an enormous profile change at the 8 hour time point (FIG. 23). The changes included complete loss of the most abundant peak m/z=663 1. This suggested an increase in the level of the protease that cleaves the 6631 component to form the 6433 component. There was appearance of a new, extremely abundant peak at m/z=4153 (see intensity of 4000 versus 900 on the other scale). This is also found in cases of allergic reaction and is a marker of immune response. There was complete loss of the reduced transthyretin peak at 13765. This suggests oxidation of the sample in which the free sulfhydryl of TTr-SH is easily destroyed by oxidation. There was also a substantial level of the TTr-SO₄ peak at 13840. This peak is associated with disease. In this case, response to a specific stimulus creates specificity for diagnosis of that stimulus. There was virtually complete loss of all of the normal peaks corresponding to apolipoproteins CI, II and III. The results can be rationalized if it is assumed that these proteins were all oxidized, adding either 16 or 32 mass units for one or two oxygen atoms added per polypeptide. In this case, the peak at 6451 would correspond to the 6433 peak that has one additional oxygen atom. The peak at m/z=8949 could correspond to the normal peak at 8915 but with addition of two oxygen atoms, the peak at 9454 would correspond to the normal peak at 9422 plus two oxygen atoms. This same type of analysis can be used with other peaks. In short, there is abundant evidence that there is oxidation of extreme levels in these samples. FIG. 22B depicts a portion of the peak ratios for this individual over time. For many cases, peak ratios at 8 hours use the intensity of the oxidized components (e.g. 6459) rather than the normal components (e.g. 6433) to obtain a ratio since the ratio of the 6433 peak is zero. At 24 hours, the indications of severe oxidation were gone but actual peak ratios had not returned to normal.

Thus, some individuals experienced extreme response to endotoxin while others had a more muted response. This was expected for response of diverse individuals to a biological stimulus. The following analysis of the final values at 24 hours demonstrates the value of basing diagnosis on an individual's personal profile rather than on comparison to the range of values for normal individuals.

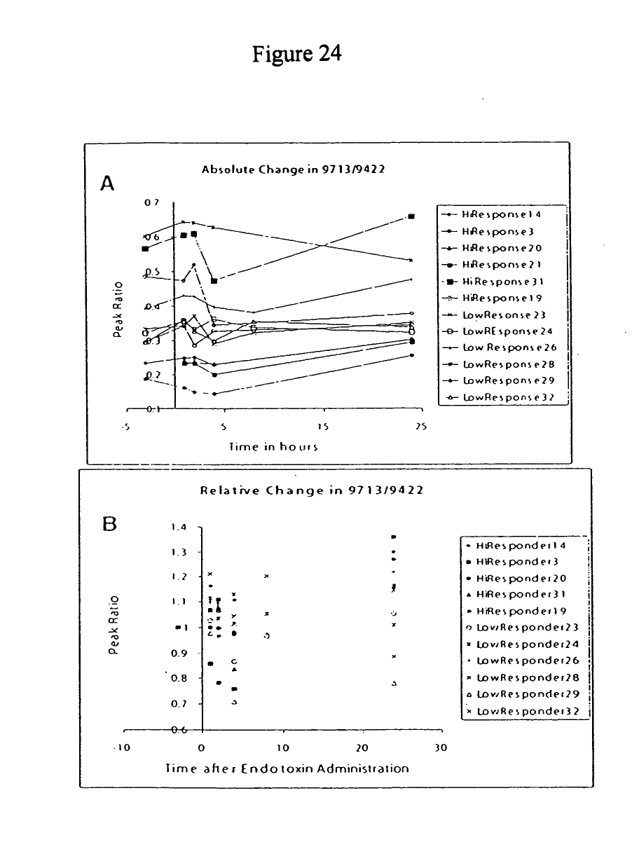

FIG. 24A shows the values for the 6 individuals with high response to endotoxin (solid symbols) and 6 individuals without the high oxidation state at 8 hours and therefore a lower response to endotoxin. These results show that all individuals are mixed with no apparent trend for the initial values among high versus low responders to endotoxin. The range is characteristic of a much larger population of healthy individuals that has been examined by this method (see FIG. 5A). All of the values are characteristic of healthy individuals, although some of the steady state values may be linked to long-term health problems such as insulin resistance. At no time other than at 8 hours and for the 6 individuals with high response to endotoxin did any of these individuals show values outside of the range for healthy individuals. Thus, analysis of any single point versus the range for healthy individuals did not allow diagnosis that any of these individuals had suffered a health challenge. It was also impossible to distinguish high responders from low from the raw value for the peak ratio at 24 hours. However, the results in FIG. 24B show that when analyzed by change relative to the individual's personal profile, established before administration of endotoxin, it was clear that almost all individuals had suffered a health challenge and that the high responders to endotoxin clustered at a high increase from their personal profile value while the low responders clustered at lower values at 24 hours. In other words, at 24 hours the health history of the individuals is apparent and the relative change helps identify those individuals who had experienced a major oxidative response from those who had lower response. A decrease in this peak ratio, observed for several of the low responders, is also a sign of an unhealthy condition. Overall, the relative peak ratio at 24 hours detected that 10 of 12 individuals had suffered some health challenge (FIG. 24B). Only individuals 23 and 24 had final values within the range expected for their healthy status. Even then, if other peak ratios in the total profile were considered, it was clear that individuals 23 and 24 had altered profiles at 24 hours and had suffered a health challenge. Thus, this example has focused on one peak ratio for illustrative purposes. Full consideration of the profiles provides additional evidence of health versus experience of a health challenge. The absolute values for this peak at 24 hours (FIG. 24A) were within the range for healthy individuals and this value alone did not detect a health challenge to any of these individuals.

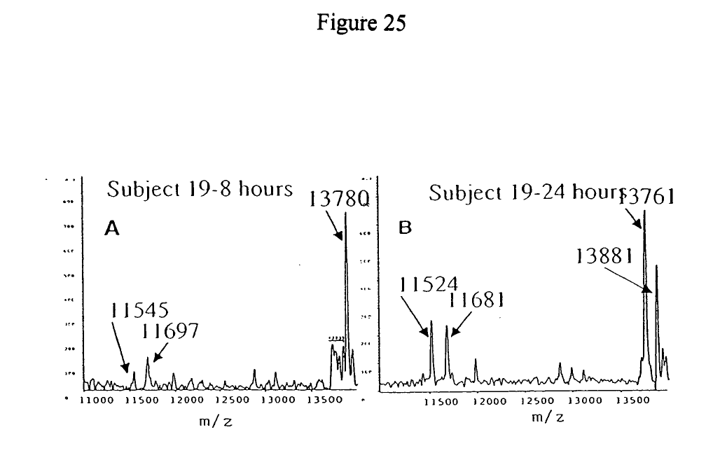

Another protein that appeared as a result of endotoxin was serum amyloid A. This first became detectable at 8 hours and was more pronounced at 24 hours. FIG. 25 shows an example of these time points for subject 19. SAA1 appears at m/z=11681 but has a higher mass and therefore appears to be oxidized at the 8 hour time point. The proteolytic digestion product (minus C-terminal Arg) appears at m/z=11524. The SAA appears after severe oxidation event that resulted in loss of the 13761 peak (see 8 hour sample). Initially, the intact protein predominates but with time its proteolytic product appears. The ratio of intact to proteolytic product can be used to estimate the rate of SAA production and/or the level of protease in the blood stream. This can be useful to determine whether the pathology that results in SAA production is still in effect or if the SAA is residual material that will soon be removed by protein turnover.

It was clear that the SAA appeared after the severe oxidation event, which took place at 8 hours. All 18 of the subjects who received endotoxin showed SAA production at 24 hours. The level of SAA, estimated by peak intensity ratio to transthyretin (m/z=13761) did not follow the high versus low response to endotoxin. That is, the ratio of 11681/13761 at 24 hours for high responding individuals ranged from 0.5 to 1.0 while that for the low responders was 0.3 to 2.0. Thus, SAA and probably other acute phase reactant proteins are valuable for detection of pathology. In combination with other peak ratios in the profile a more detailed history of the patient's health status is apparent.

SAA is an acute phase reactant and will be useful in all of the roles currently used by C-reactive protein (CRP), the primary acute phase reactant that is used to detect myocardial infarction, severe infection such as tuberculosis and other severe disease states that result in tissue damage. Complete protein profile analysis that includes the apolipoproteins will enhance diagnostic capability, and the greatest enhancement will occur if the steady state levels of these proteins in this individual during health are known.

If the baseline for a peak ratio is not known before the health challenge event, peak ratios of the profile, such as m/z=9713/9422, 6631/6433, and others, can still be used to monitor return of the individual to a healthy status. The peak ratios of the protein profile can be monitored over time until they become stable and remain stable to stimuli that are known to alter the profiles of diseased individuals.

### Example VIIIA

### Sequential Detection of the Intensity of Immune and Inflammation Responses

The method described herein provides four stages for detection of an immune or inflammation response. The first is appearance of a peak at 4150 mass units. At high intensity, this is followed by decrease in the TTr-SH protein (m/z=13761) and, at extreme levels, there is oxidation of proteins such as those found from m/z=6000 to 10000. Finally SAA appears in the profile. SAA may appear whether or not oxidation has occurred.

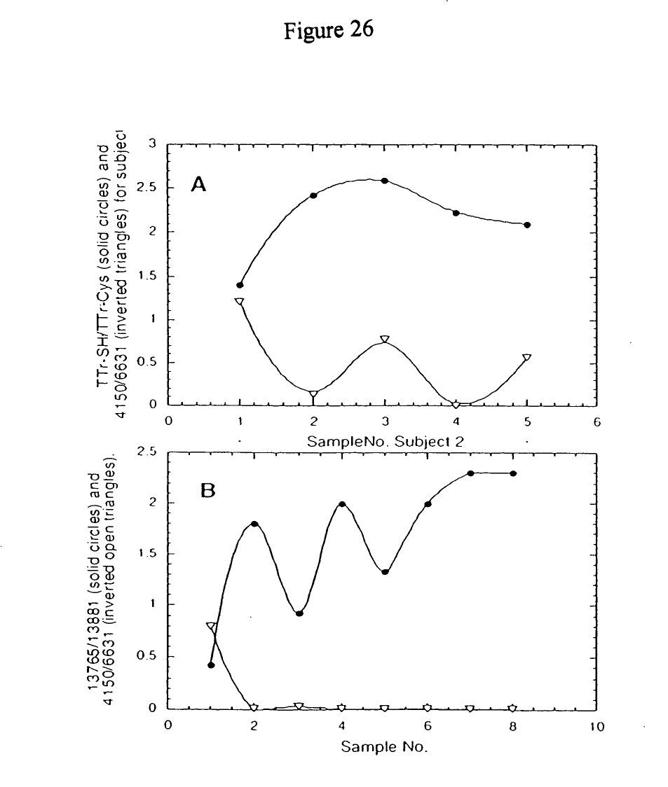

Plasma samples were taken from two healthy individuals over a several month period and were analyzed for protein profile by the procedure outlined in Example I. Relevant results for individual 2 are shown in FIG. 26A. This individual showed frequent high levels of the peak at 4150. This is unusual for an adult. In another adult population, only 4 of 40 adults showed detectable levels of this component. This component is expressed in adults under immune or inflammation challenge as indicated by the individuals who displayed high response to low dose endotoxin (Example VII). The level of the peak at 4150 in FIG. 26A is still lower than the endotoxin examples, where the ratio of m/z=4150/6631 reached a value of 2:1. The individual in FIG. 26A had allergic reactions that appeared to be responsible for appearance of the 4150 component. At no time was this person seriously ill and at no time was there significant levels of oxidation of the polypeptides from m/z=6000 to 10000. Only the highest level of 4150 correlated with a decrease in the 13761 peak.

FIG. 26A illustrates the relationship of the 4150 (expressed as its ratio to the 6631 peak) component to TTrSH content for subject 2. The 4153 (±0.1%) appeared in some cases. Note that the highest value for 4150 corresponded to lowest value for TTr-SH. Since 4150 appears to represent an immune response, it follows that oxidative damage, documented by a lower value for 13765 peak (TTr-Cys), often accompanies an immune response. Subject 2 had frequent high levels of 4150. This subject also had substantial allergic responses that manifested themselves during the time in which these samples were taken. Thus, proteome patterns obtained by this method may be useful in diagnosis of allergy or immune responses of various types.

Individual 1 showed a more typical distribution of the 4150 peak with high levels at only one occasion of six (FIG. 26B). FIG. 26B shows the relationship between the m/z=4150 peak, expressed as the ratio of 4150/6631, and the TTr-SH component, expressed as the ratio of m/z=13765/13881 for subject 1. This subject showed a more normal, low level of the 4150 peak but had one instance of a high level that corresponded to lowest level of TTr-SH (m/z=13765). Once again, this correlated with allergic symptoms so the health challenge was not great. However, the highest expression of 4150 correlated with a lowered level of reduced transthyretin (m/z=13761).

Thus, protein profile analysis clearly signals at least four stages of an immune and/or inflammation response. The first level is the appearance of low levels of the 4150 component. Many individuals show an apparent polymorphism with respect to this peak with equal intensity of a peak at about 4180. Several apparent homozygotes for this polymorphic state have been observed with a peak at 4180 only. In any event, low expression of this peak suggests an immune-active response such as an allergy. These components were found in 13 of 40 13-year olds who were analyzed in a separate study. It was much less common in adults with only 4 of 40 showing this peak. The second level of detection consists of a lowered level of reduced transthyretin (m/z=13761) versus oxidized transthyretin (m/z=13880). This was observed in both individual 1 and 2 but occurred only at the highest level of the 4150 component. The third level of immune or inflammation response was characterized by oxidation of the protein peaks at m/z=6000-10,000. This third level of severe oxidation was observed in 6 of 28 individuals (the 18 described above plus 10 others) who received low dose endotoxin and in one individual with diabetes type 1, an autoimmune disease. Again, these individuals were not severely ill and such major change may be commonly ignored. Oxidative damage may only be detected by direct analysis. For those individuals receiving low dose endotoxin, the oxidative damage was short-lived, although evidence of health challenge remained in the form of an altered personal profile. A fourth symptom of inflammation was the appearance of SAA in the profile.

The extent of oxidative damage after endotoxin was severe, leading to the potential for long-term damage due to repeated episodes. Diagnosis of these events will be important to prevent long-term health deterioration. Surprisingly, medical parameters for the 6 individuals at the time of severe oxidative damage did not stand out among other individuals. Thus, severity of a health challenge and detection of possible long-term effects may require frequent analysis. Therefore, a preferred approach will be to provide a home kit for persons suspected of having immune or inflammation responses that allows an individual to obtain serum at the time of the immune or inflammation episode so it can be tested for severity and for possible contributions to long-term health problems. This will allow the severity of the disease to be evaluated more accurately than at set times that are set by the convenience of the health care provider.

The protein profile therefore provides sequential levels of immune activity analysis, some of which appear at low disease states, when clinical symptoms are very minor. This sequential process will be valuable for monitoring persons subject to immune challenge and for early detection of problems to allow early therapy intervention. Examples of use may include autoimmune response, asthma, pregnancy, and others. In the case of pregnancy the protein profile analysis may provide early diagnosis of pre-eclampsia and allow for early intervention in development of that disease state.

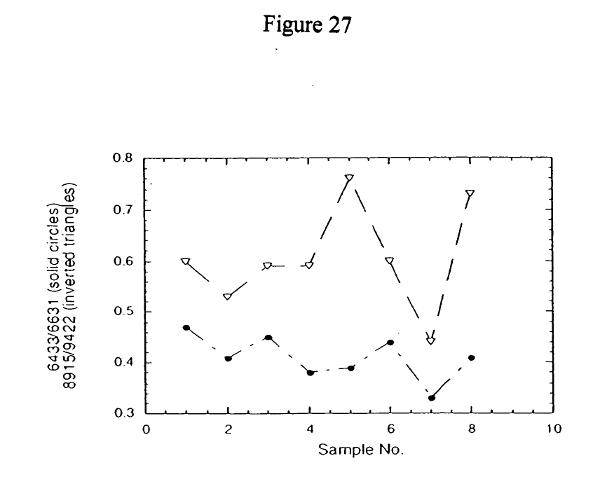

Another example of the utility of protein profiles for long term evaluation of health state is illustrated in FIG. 27. Blood samples were obtained from individual 1 over a 3-year period. The plasma was frozen and analyzed by the protein profile method by ZipTip extraction and MALDI-TOF profile analysis that is outlined in Example 1. The m/z=6433/6631 (solid circles) and the 8915/9422 ratios for this individual are shown in FIG. 27. The stability of this ratio in most samples is apparent. One exception was the low value at time point 7. This correlated with documented illness in the form of a low-grade fever. Illness was not severe but clearly established. This protein ratio was more than 3 standard deviations from the average value established for this individual by the 7 other samples taken over a 3-year period. The same observation applied to the 8915/9422 peak ratio. Samples 6 and 8 were taken about one month before and one month after sample 7, respectively. A low value for this ratio is characteristic of insulin resistant individuals (as described herein). It was also found in some who were subjected to low dose endotoxin (Example VII) and to individuals after bone marrow transplant (Example VI). Lowered values also occurred in some individuals after caloric ingestion (Example II). Thus, comparison of a value to the individual's baseline profile can be used to diagnose disease or a predisposition to develop a disease. The methods described herein can also be applied to correlate a specific condition to the peak ratio. Examples include analysis of the profile before and after a specific stimulus such as caloric intake or exposure to an immunogen.

While experiencing the low grade fever, the profile of individual I did not show the peak at 4150 or decline of the peak at 13761. This can be an important difference for a viral condition versus bacterial infection or inflammation, which results in a large increase in the peak at 4150 as well as a decrease in the peak at 13761. Viral infections may provide very distinct profile changes from bacterial infections. This distinction is especially important for newborns who present a fever in their first 1-3 months. A viral condition is not serious while a bacterial infection may lead rapidly to very serious health problems. It may be advantageous to obtain a baseline profile for the newborn so that subsequent profiles taken in the case of a fever can detect a viral versus bacterial infection.

### Example VIIIB

### The Activation Peptide of C1 Protease Inhibitor: a Potent Biomarker of Complement Activation and Methods for its Quantification

The mass spectrometric peak described in Example VIIIA as the “peak at 4150” and, in some instances, 4153 (which encompasses m/z=4150, 4151, 4152, and 4153, ±4) was characterized using sequential profile analysis after Edman degradation of the sample. Mass changes after each round of degradation showed the amino acid removed. The N-terminal sequence was TL(I)L(I)VF. Blast™ search showed the only one peptide match with the correct sequence and m/z value. This consisted of residues 467-500 of C1 protease Inhibitor. Residues 467-500 constitute the activation peptide that is released when the inhibitor interacts with the protease. Thus, appearance of this peptide (referred to as the biomarker) detects activation of complement in real time. The major polymorphism observed at m/z=4184 is most likely a known variant, Val480Met. This variant has no known effect and was observed in about 20% of our population. The presence of either or both of these peptides constitutes a biomarker that can be used to monitor activation of complement.

Sequence of the 4152 peak:

| | |
|---|---|
| (residue 467)TLLV FEVQQPFLFV | (SEQ ID NO:1) |
| LWDQQHKFPV FMGRVYDPRA(500) | |

An example of a coding sequence for the activation peptide of C1 protease inhibitor includes residues from GenBank accession number X07577:

| | |
|---|---|
| (870)a ccctgctggt ctttgaagtg | (SEQ ID NO:2) |
| cagcagccct tcctcttcgt gctctgggac | |
| cagcagcaca agttccctgt cttcatgggg | |
| cgagtatatg accccagggc c(971) | |

The amount of biomarker in a sample can be quantified using any convenient method. For example, a known amount of a peptide of similar composition (referred to as a marker or reference peptide), but different mass than the peptide found in the sample (referred to as the biomarker), can be added to the sample as an internal standard, followed by equilibration of the mixture and analysis by MALDI-TOF mass spectrometry and quantification of the biomarker by comparison of the relative intensities of the biomarker and marker peptides.

The marker peptide can have an identical sequence to the biomarker but contain heavy atoms such as deuterium instead of hydrogen or ¹³C instead of ¹²C at several sites. This marker can be generated by chemical synthesis using known technologies with amino acids containing deuterium at non-exchangeable positions or ¹³C instead of ¹²C at key sites. Amino acids with heavy atoms are available from commercial sources. The increase in mass of the marker peptide must be sufficient to give a separate peak in the mass spectrometer but should not produce a peak that is easily obscured by another component of the profile. A marker peptide with 10 mass unit increase would be sufficient to separate the marker peak from the biomarker but would not result in overlap of the heavy atom derivative with the common polymorphism at m/z=4184. Marker peptides can also be produced by introduction of an appropriate DNA sequence into an organism such as Eschericia coli, by an appropriate vector, and the organism grown in a medium containing the appropriate amino acids containing heavy atoms. The marker peptide is then purified and used as above.

The nucleic acid sequence to be used for biosynthesis of a marker peptide may consist of the coding region for the biomarker peptide, isolated from human or closely related species, or it can be a synthetic nucleic acid sequence that codes for the appropriate marker peptide sequence shown above or for a modified marker peptide described below. In addition, the DNA sequence must include a promotor and stop codon operably linked to the coding sequence and appropriate for the organism in which the marker peptide is expressed. Furthermore, the DNA must be incorporated into the organism by appropriate means such as a vector, many of which are available.

An alternative approach to creation of a marker peptide is to introduce a small number of amino acid additions, subtractions or substitutions such that the marker peptide has nearly identical properties in the MALDI-TOF mass spectrometer as the biomarker but has a different mass. Generally, addition or subtraction of one or two amino acids will have very little impact on the properties of a peptide in the MALDI-TOF so that the ratio of peak intensity for a modified marker peptide to that of the biomarker will give accurate estimation of the actual concentration ratio of the components in the sample. Many examples of modification can be used. A specific example is a peptide with an additional Methionine at the amino terminus and with substitution of Met492Val, as shown here:

| | |
|---|---|
| MTLLVFEVQQPFLFVLWDQQHKFPVFVGRVYDPRA | (SEQ ID NO:3) |

This marker peptide will be 99 amu higher than the biomarker, avoiding confusion with the polymorphic biomarker at m/z=4184. This mass also does not overlap with other peaks commonly found in the profile. A similar substitution is a peptide that does not contain the extra methionine at the amino terminal and has the Met492Val substitution. This peptide has a mass of approximately 4120 and will not interfere with other peaks of the profile.

For quantification of the amount of the biomarker in a sample, the marker peptide is added and the mixture incubation to reach equilibrium (generally about one hour at room temperature). The sample is then extracted and/or diluted by methods described elsewhere and analyzed in the MALDI-TOF mass spectrometer. The areas or peak heights of the biomarker and of the marker peptide are measured and the quantity of the biomarker in the sample determined from the known concentration of marker peptide added to the sample and the peak intensity or area ratios of the marker peptide to the biomarker. The amount of biomarker in the sample is then used as a diagnostic for disease states that produce complement activation. Alternatively, it can predict future development of disease or response to a therapy.

### Example IX

### Protein Profiles in Sepsis, Kidney Disease, Liver Disease and Other Severe Conditions

FIG. 1B shows the enormous changes that accompany severe sepsis. In fact, profiles can be used in virtually any disease. Kidney disease provides one example. The results showed a great deal of individual variation, and may be used to detect specific types of conditions leading to kidney failure. Twelve individuals with severe kidney disease were evaluated on 3 or 4 occasions. In general, advanced disease resulted in loss of TTr-SH (either partially or totally), an increase of TTr-SO4, appearance if a series of 3 peaks at 4789, 4821 and 4855, increase of the 9713/9422 peak ratio, occasional increase of the 9642/9713 peak ratio (resulting from proteolytic cleavage of the carboxyterminal residue), occasional appearance of the 4150 peak, increase of ApoCIII1/ApoCI (9422/6631) peak ratio, appearance of beta 2 microglobulin (m/z=11732) and occasional appearance of SAA. Individuals were highly variable. One showed an enormous level of TTtr-S04 (10-fold higher than 13880). The next highest level was about 1.5/1.0 among the 12 individuals and some showed virtually none of this component. Two individuals were exceptionally high in carboxypeptidase activity and one individual showed a 9642/9713 ratio of >2.0. The peak at 4150 did was not highly active in kidney disease with 4150/6631 peak ratios always less than 1.0. In 3 cases, the 6631/6433 peak ratio decreased. The 9422/6631 peak ratio often increased with advanced disease. Elevation of this peak ratio was also common to diabetes. The beta 2 microglobulin was elevated in 7 of the patients. SAA was relatively low and absent in most individuals. From these trends and findings, it was clear that each individual had a different alteration of protein profile in association with kidney failure. Individual variation detected by protein profile analysis may offer an opportunity to develop individual treatments that depend on protein profile changes.

Other disease states also produced a variety of changes in the profile. Mild liver disease caused significant change in the profile. One example was the ratio of 9422/9713. This ratio declined and became less than 1.0. Again, it would be preferable to compare the profile of the same person before contracting the disease to the same individual with the disease. Changes in one's own profile are a more sensitive method of analysis. However, profiles alone can detect disease. For example, the peak ratio of 9713/9422 for all healthy individuals ranges from approximately 0.15 to 0.8. Two individuals with beginning stages of liver disease had ratios of 1.25 and 1.33. This ratio is sensitive to liver changes that result in differences in glycosylation. The 9422 and 9713 peaks differ by one sialic acid residue per protein molecule. Profiles can thus be used to detect long-term disease states, development and advancement of the disease as well as to monitor the outcome of therapy. As in all situations, determination of a change in a peak ratio for an individual is more sensitive than detection of disease by comparing a peak ratio to the entire population. In the cases given above, the ratio was outside of the values for normal individuals and diagnosis is possible. However, a person with a normal peak ratio of 0.2 would be diagnosed upon change to a value of 0.6, a very large increase but a ratio that remains within the range for healthy individuals.

### Example X

### Analysis of Protein Profiles in Cerebral Spinal Fluid

As an example of the utility of this technology in analysis of other bodily fluids, cerebral spinal fluid was obtained from patients with disease. CSF was taken from patients and frozen until analyzed. Fifteen microliters of CSF were acidified by addition of 0.5 microliters of 10% TFA solution and the sample was immediately subjected to ZipTip extraction by the procedure outlined in Example I.

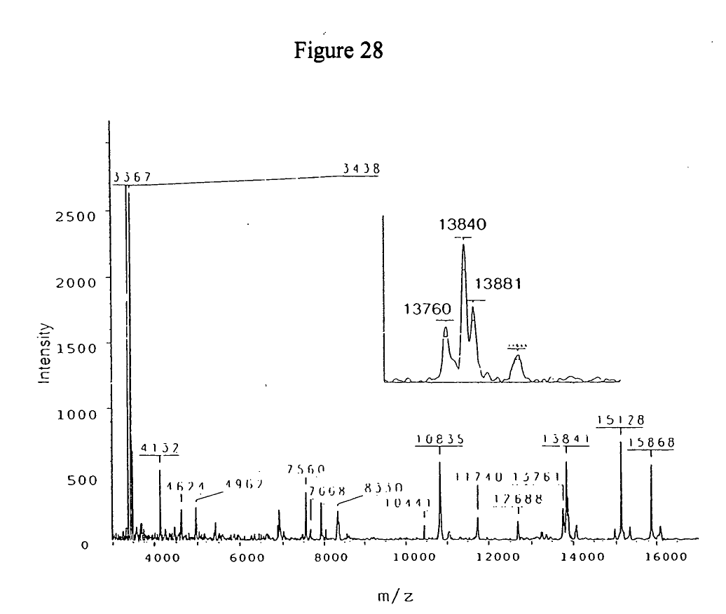

The protein profile of cerebral spinal fluid (CSF) obtained from a patient having tumor hydrocephaly was determined (FIG. 28). The spectrum shows many unusual properties, some of which can be related to lung lavage fluid or to plasma. The peaks at 3367, 3428 and 3472 correspond to human neutrophil defensins. The peaks at 10441 and 10835 are similar to components found in chronic lung transplant rejection and may correspond to members of the calgranulin family of proteins. The transthyretin peak (insert in FIG. 28) shows the presence of normal transthyretin at 13781 and the cysteinylated TTr at 13879 but also the sulfonylated TTr at 13841. Low TTr-SH and high sulfonylated TTr are associated with many disease states. Hemoglobin, the result of bleeding, is also apparent at 15128 and 15868. The appearance of this component is thought to be useful to diagnose or follow the course of progression in many disease states. The peak at 11740 may be an oxidized form of a peak with a normal m/z of about 11725 and which is also found in lung lavage fluid. This component is a standard to which most other peaks can be compared.

Profiles of CSF from patients with various disease states include cancer of the meninges, ventriculoperitoneal (VP) Shunt malfunction, AMV and ALL. A peak at m/z=13350 is unidentified but a valuable tool for detecting disease since it varies widely when compared with other components in the spectrum. These disease states showed several additional features that might be used to detect disease. The peak at 13765±10 corresponds to TTr while the peak at 13847 is the sulfonylated form of the protein and the peak at 13878 is the cysteinylated form. Some samples show a novel peak at about 13741, which appears in some samples but not others. While this is not identified, it is present in only some samples and therefore is valuable in detecting disease of an individual. These examples show widely varying levels of the different forms of TTr that can be used in disease diagnosis.

Frequently in disease there is a high abundance of lower m/z peaks in this spectrum that are absent from profiles of healthy individuals. These are thought to be valuable for diagnosing disease, either as specific peaks or as a sum of all low molecular weight components. Among other properties, some of these components represent protease digestion products that diagnose cellular death and/or destruction. Specific in ataxia was an abnormal distribution of TTr isoforms. For example, ataxia showed an altered distribution of the Cys-TTr (m/z=13880) and the cys-Gly-TTr(M/z=13937) when compared with control samples. This difference can indicate a difference in metabolites (Cys vs. Cys-Gly) in the CSF and can also indicate differences in the Oxidation state of the CSF. Higher levels of the disulfide products indicates a higher oxidation state. The importance of Ttr in the CSF is illustrated by the fact that polymorphisms of this protein are often accompanied by Familial amyloid neuropathy. Polymorphisms can be detected by differences in the mass of the Ttr peaks and/or by peak doublets that appear in persons with polymorphisms. Protein profiles of CSF from normal individuals shows an extremely high level of Ttr that also signals its importance for this body fluid.

The extreme intensity of the 13350 peak, the presence of hemoglobin, the normal m/z value of the 11725 peak and the presence of a peak at 4151 in CSF of a patient with a ventriculoperitoneal (VP) shunt malfunction was observed. The 4150 peak may correspond with the component observed in plasma in other studies shown elsewhere in this document. Overall, evaluation of CSF shows change in specific markers associated with disease states and that protein profile analysis of CSF may be used for diagnosis of a variety of disease states of the nervous system.

### Example XI

### Additional Approaches to Monitor Lung Disease such as Chronic Transplant Rejection

Extraction of bronchoalveolar lavage fluid (BALF) of 1) healthy individuals, 2) lung transplant individuals who do not develop chronic rejection within 100 months and 3) persons that develop chronic lung transplant rejection (also referred to as broncholitis obliterans syndrome, BOS) within 15 months provides an important source to develop methods to diagnose the potential future development of chronic lung transplant rejection. BALF was obtained by well-known clinical procedures. The fluid was filtered to remove mucous and centrifuged to remove cells. Several procedures can limit the adverse impact of sample handling such as freeze-thaw. The samples should be maintained in volumes that minimize the surface to volume ratio. It is best to use siliconized tubes for sample storage. Optionally, additives to the solution can help stabilize the sample to handling such as free-thaw. One additive is an aqueous suspension of phosphatidylcholine (PC) and a convenient concentration is 50 micrograms per mL of solution. Suitable PC preparations include commercially available preparations from chicken egg or synthetic PC containing oleic acid or a combination of oleic acid and palmitic acid or another suitable distribution of fatty acids. To prepare the PC, it is first dried to remove all organic solvents. A stream of nitrogen blown over the surface of 100 microliters or less of an organic solvent such as chloroform for 30 minutes is usually adequate. The PC is suspended in a suitable solution such as 0.1 M sodium chloride by rigorous mixing. A final concentration of about 1 mg per mL is desirable. The solution is then subjected to several freeze-thaw cycles to convert most of the PC to single bilayer PC vesicles. This PC suspension is stored at 4 degrees or in frozen state. The BALF is stored at −70 degrees centigrade.

Protein concentration of the BALF solutions can be measured by any standard procedure such as the BioRad protein assay. In a preferred method, a volume of BALF, adequate to provide 3 micrograms of protein, or 150 microliters of BALF, whichever is less, is acidified to pH<3 by addition of a solution of 10% trifluoroacetic acid (TFA). The solution was immediately extracted by the C4 ZipTip procedure described elsewhere in this document. Minor modifications were that the solution was extracted by passing through the ZipTip for 2 minutes rather than one and the final elution of proteins and peptides from the ZipTip was with 1.6 microliters of acetonitrile:water:TFA (80:20:0.1). The eluted protein solution (0.75 microliters) was applied to the MALDI-TOF target as described elsewhere in this document and 0.75 microliters of matrix solution (usually sinipinic acid) was added. The solutions were mixed with the micropipette and crystallization of the matrix was enhanced by rubbing the pipette tip on the surface of the target until crystallization was well established. Alternative methods can be employed. For example, analysis of the profiles is accomplished by internal peak ratios so that protein concentration need not be measured. One or more standard amounts of BALF may be acidified and extracted as above and analyzed. Preferred amounts are 20 and 100 microliters from each BALF sample.

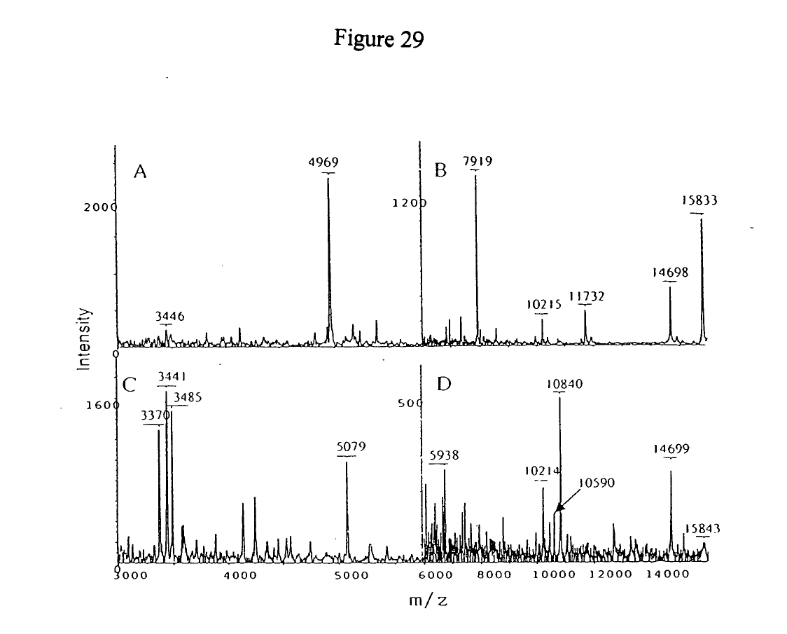

FIG. 29A/B shows a profile (in two sections) of a successful lung transplant patient. There are relatively few components in the spectrum, especially notable are peaks at m/z values of 4966, 7917, 11730, 14700 and 15835 (error limits for m/z are ±0.2%). These components characterize a healthy lung. FIG. 29C/D shows the profile of an individual who developed chronic rejection (also referred to as broncholitis-obiterans syndrome, BOS) 5 months after the sample was taken. Many differences in the profiles are evident. Especially notable are loss of nearly all of the peaks characteristic of the healthy lung and appearance of new peaks. Study of a number of profiles of individuals before developing BOS show especial intense peaks at m/z values of 3371, 3442, 3486, 4135, 10190, 10450, 10585, 10597, 10840, 12700, 11045, 5420, 6345, and 8838. These are the most common and abundant peaks that characterize individuals who will develop the disease. However, other peaks are of lower intensity and appear less frequently but may be useful in diagnosis of individuals by this procedure.

The proteins at m/z of 3371, 3442, and 3486 are human neutrophil alpha-defensins (HNP). Very high levels of these proteins are known to be cytotoxic to epithelial cells of the lung. This cytotoxicity may underlie future development of chronic rejection. The levels of HNP in the BALF were measured by an ELISA assay available from commercial sources. The results indicated that a level of HNP in excess of 0.3 nanograms per microgram of BALF protein was predictive of the development of BOS within 15 months (lower horizontal line, FIG. 30). The accuracy for predicting BOS was 60% and for predicting the absence of BOS in 100 months was 86%. Another approach is the use of multiple readings from the same individual. Nine individual patients who developed BOS within 6 months had multiple readings (average 2.8) and 11 individuals who did not develop BOS within 100 months had an average of 2.7 readings each. Accuracy for diagnosis on the basis of 2 or more positive readings for an individual was 66% for those developing BOS within 15 months. Accuracy for those who did not develop BOS within 100 months (less than 2 positive readings) was 91%. Another important property of this reading was that values above 6 nanograms per microgram of protein virtually guaranteed BOS development (upper horizontal line, FIG. 30). Thus, analysis of BALF from lung transplant for HNP by ELISA or other assay is a valuable approach to diagnosis of future development of the disease.

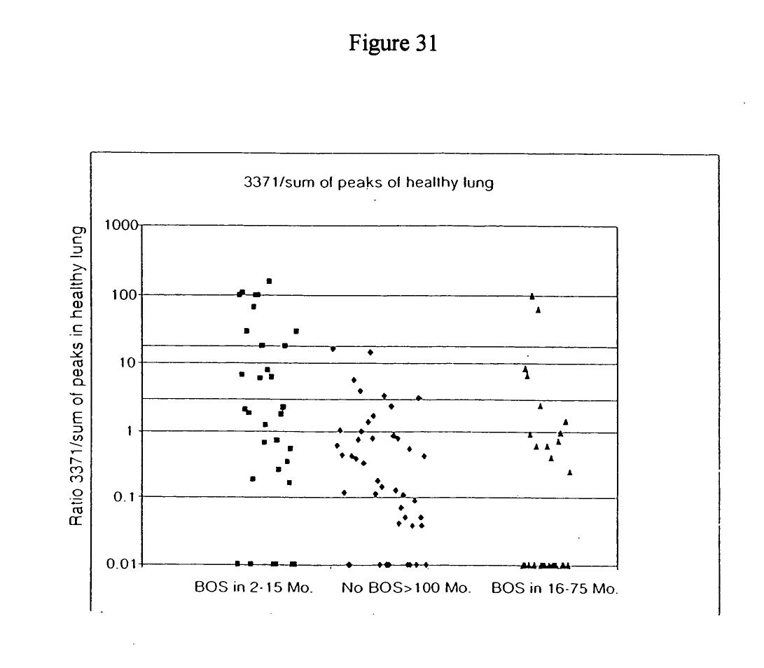

A shortcoming of assay by a specific method such as ELISA is that only one component is detected. The MALDI-TOF profile gives much more information regarding the condition of lung proteins than does the ELISA assay. This information can be combined in many ways and the following illustrates some possible approaches. There are numerous ways to evaluate the profiles and only selected methods for data analysis are provided to illustrate the use of profiles in diagnosis. A peak may be analyzed by calculation of the ratio to another peak in the spectrum in a manner similar to that described elsewhere in this document for components extracted from human plasma. For HNP, peak ratios may include HNP peaks at m/z=3371, 3442 and/or 3486 relative to any other peak in the spectrum such as those from proteins found in the healthy lung. These may include, for example, ratios of 3371/4966, 3371/7917, 3371/11730, 3371/14700, 3371/15835. The same ratios can be taken for peaks at 3442 and 3486. Alternatively, the HNP peaks may be used in any combination and the ratio can be calculated with respect to any combination of peaks in the spectrum. One example would be to calculate the ratio of HNP to the sum of intensity of peaks found in healthy individuals. This approach is illustrated in FIG. 31 as the ratio of the 3371 peak to the sum of the peak intensities of components found in healthy individuals (such as 3371/(4966+7917+11730+15835)). High values for this ratio will tend to predict disease. The peak at 14700 may also be included but was not in this example since it remains relatively constant in healthy and rejection patients. Any or all of the HNP components may be included in this analysis and any combination of other peaks in the spectrum can be used. FIG. 31 shows that the ratio of 3371 peak intensity to the sum of peaks for healthy lung is a valuable predictor of future chronic lung transplant rejection. A value of greater than 3 for positive diagnosis provided the highest accuracy for predicting development or not of BOS (lower horizontal line FIG. 31). Accuracy for this cut-point was 44% for prediction of BOS within 15 months by a single reading and 88% for predicting no BOS within 100 mo. For 2 or more positive readings in different samples, the accuracy for individuals who developed BOS within 15 months was 56% and was 100% for those who did not develop BOS within 100 Mo. Another valuable observation was that a value of >20 virtually guaranteed development of BOS within 15 months (upper horizontal line, FIG. 31).

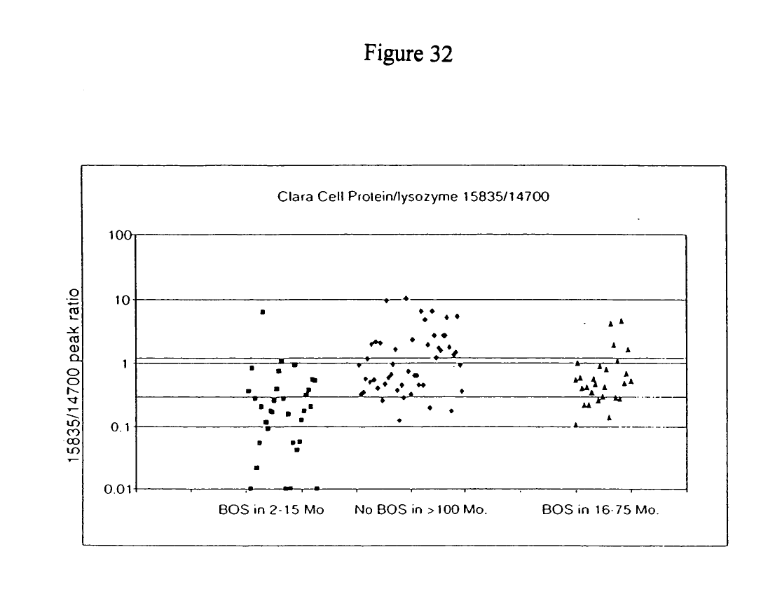

Another important protein for healthy lung is Clara Cell Protein (CCP) at m/z=15835 and its +2 charge species at m/z=7917. Clara cell protein is a homo-dimer linked by disulfide bonds and the monomer will appear at 7917. The disulfide bonds in the protein can be reduced with any of several reagents such as dithiothreitol prior to extraction and the CCP all appears at m/z=7917. One approach to diagnosis is to measure the ratio of CCP to lysozyme (m/z=15835/14700). Since lysozyme remains relatively constant in all sample populations, it provides a good internal standard for comparison. However, other peaks in the spectrum can also be used. FIG. 32 shows that the ratio of m/z=15835/14700 is a good predictor of future development of BOS. In this sample group, a ratio of less than 0.3 (middle horizontal line, FIG. 32) provided the best cut-point for prediction of BOS within 15 months. Accuracy for diagnosis of future BOS by a single sample was 65% and accuracy for prediction of no BOS in 100 months was 90%. Use of 2 or more positive scores per person gave accuracy of 66% for prediction of BOS within 15 months and 82% for prediction of no BOS within 100 mo. A peak ratio of less than 0.1 virtually guaranteed future development of BOS and a value of >1.2 virtually guaranteed the absence of BOS within 15 months (lowermost and uppermost horizontal lines in FIG. 32, respectively). Consequently, the information provided by this ratio can be used to schedule future analysis of a lung transplant patient.

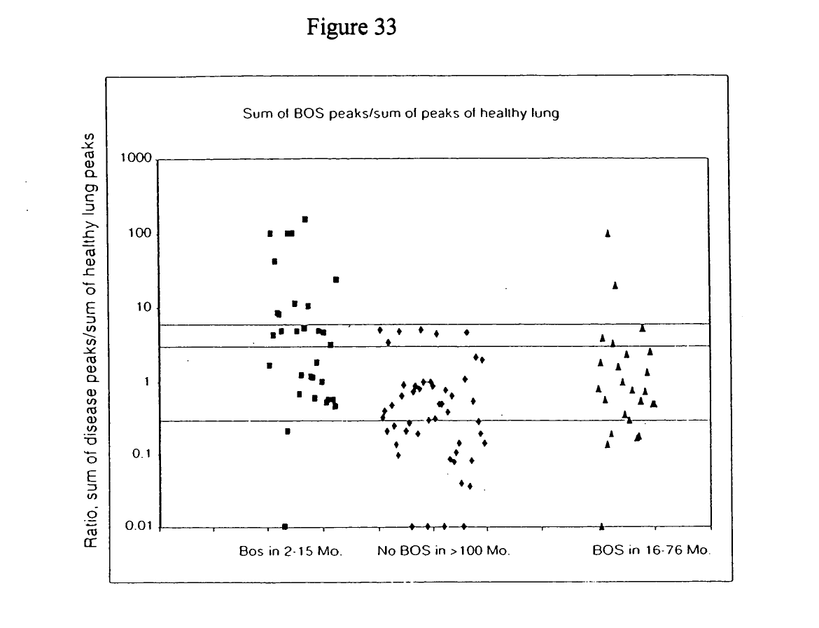

While there are numerous ways to analyze the many peaks of the spectrum for purposes of diagnosis, a third specific illustration is presented. This is the ratio of the sum of peak intensities of the profile, other than HNP, that characterize future disease, divided by the sum of the peak intensities that characterize health. The results in FIG. 33 show that, for this sample population, a ratio of 3 (middle horizontal line in FIG. 33) provided the optimum accuracy for predicting development of BOS or not. Accuracy for predicting BOS within 15 months was 56% and accuracy for predicting no BOS within 100 months was 88%. Diagnosis on the basis of 2 positive readings gave an accuracy of 56% for development of BOS within 15 months and 91% for no BOS within 100 Mo. A value of greater than 6 virtually guaranteed BOS within 15 months and a value of less than 0.3 virtually guaranteed no BOS within 15 months (uppermost and lowermost horizontal lines in FIG. 33).

There are many ways combinations of peak intensity or area in the profile that can be combined to provide an overall prediction of future BOS development. One example of a global score will be shown for illustration. For most diagnostic tests, results are graded either positive or negative and the samples are separated into two classes. The results shown above suggest that single measurements in FIGS. 30 to 33 do provide an optimum cut-point for the highest accuracy in predicting BOS within 15 months (positive) or no BOS within 100 months (negative). In every case, use of a simple cutpoint produced some false positive and some false negative values. As pointed out above, additional information was that some values were so extreme that they virtually guaranteed BOS within 15 months and others were at the other extreme and virtually guaranteed no BOS in 15 months. A simple way to combine these results is to assign a graded score to the values in FIGS. 30-33. The ratio in FIGS. 30-33 that virtually guaranteed BOS within 15 months was assigned a score of 100 and the ratio that guaranteed non-BOS was assigned a value of zero. Intermediate scores can be assigned values between 0 and 100. There are many ways to arrive at an intermediate score. One simple approach was to consider a linear relationship between the scores of 0 and 100. The result is equation 1. In this equation, any level of HNP for example, receives a score greater than 0. The optimum cutpoint (solid line) did not guarantee development of BOS so that this relationship considers that any level of HNP may be a risk factor for BOS. The relationship for other components is more complex as these have two extremes, one that virtually guaranteed no BOS within 15 months and the other that did guarantee BOS within 15 months. “Total score” in equation 1 is the overall score for the ratios in FIGS. 31-33 for an individual sample where X is the ratio for that individual for the measurement shown in FIG. 31, Y is the ratio for that individual in FIG. 32 and Z is the ratio in FIG. 33.
TOTAL SCORE=(X*5)+(100−(Y*91-9.1))+(Z*17.5-5.25) (Equation 1)

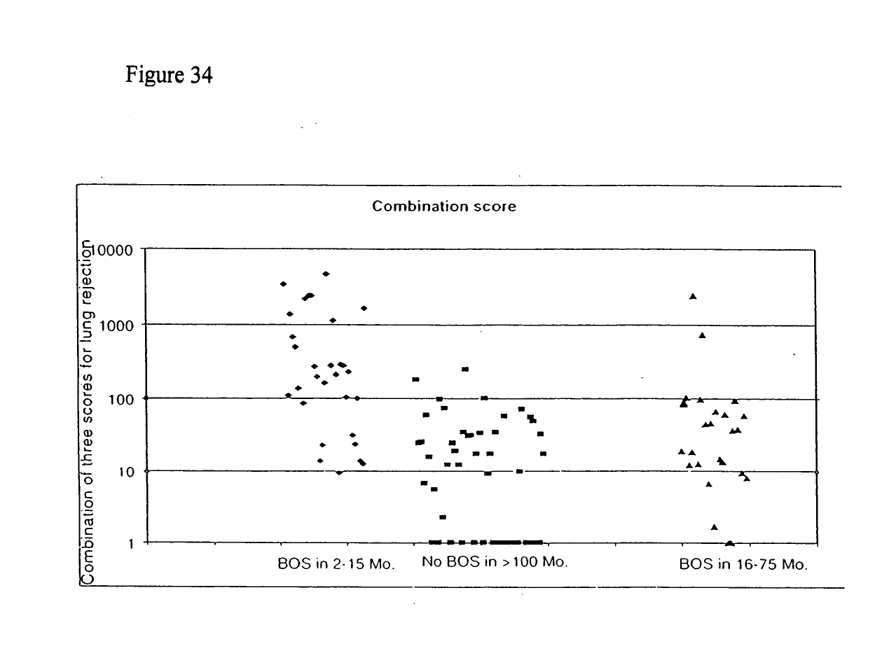

The outcome of this combined score is presented in FIG. 34 and shows that combination of these several scores in this manner provided an excellent approach to diagnosis of future disease. Accuracy for predicting BOS within 15 months on the basis of a single sample was 78% and for predicting no BOS within 15 months was 78%. For diagnosis on the basis of multiple (2 or more) positive readings, the accuracy for predicting BOS within 15 months was 89% (8 of 9 patients) and for predicting no BOS within 15 months was 100% (1 1 of 11 patients). Overall accuracy when multiple assays were used was 95%.

Analysis of sequential BALF samples from transplant patients will provide a nearly perfect ability to diagnose those who will develop the disease. For example, analysis every 5 months will provide three samples from each individual in a 15 month period and the results suggest that 89% of those who go on to develop BOS will be diagnosed positive on at least 2 occasions.

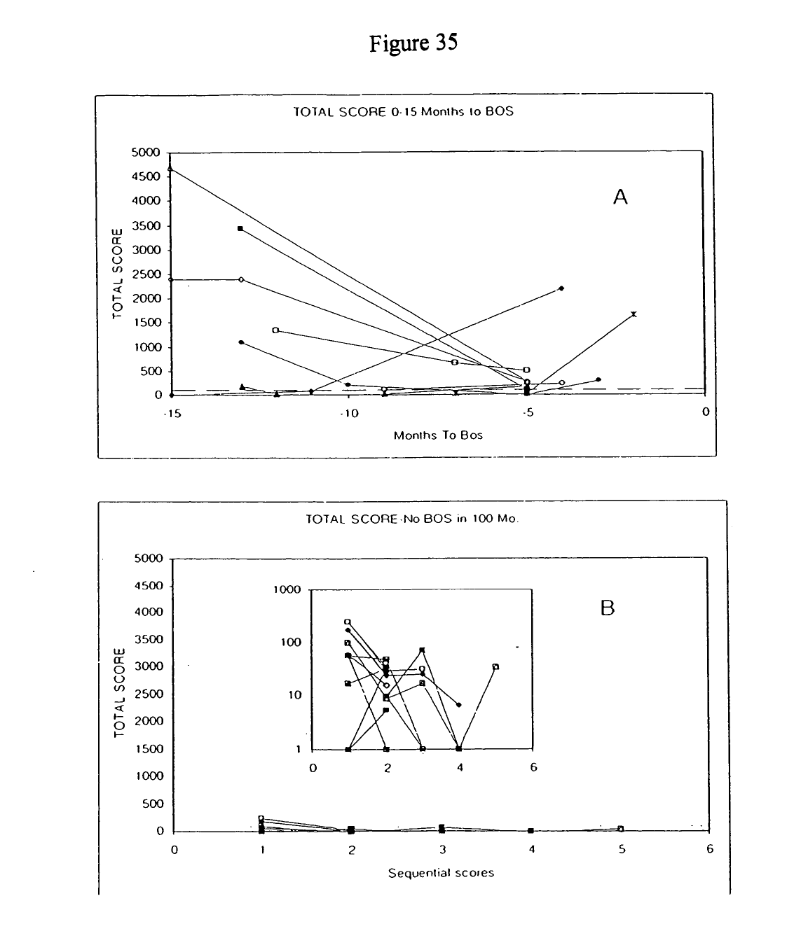

A further value of the graded approach to diagnosis is illustrated in FIG. 35. This result shows that most individuals who develop BOS have extremely high total scores, far above 100 (FIG. 35A). These extreme values provide a truly unquestionable diagnosis for most individuals. In many cases, the high total score occurred a year before clinical diagnosis of BOS, providing adequate time for therapeutic intervention to prevent the development of future BOS. In contrast, those who did not develop BOS within 100 months but who had a total score above 100 were barely above 100 and quickly returned to lower values (FIG. 35B).

Overall, MALDI-TOF profiles provide highly valuable approaches to diagnosis of lung transplant rejection. The method of analysis can be varied. For example, the peaks listed here can be used in any combination to produce a diagnosis. In some cases, minor peaks of the spectrum that are not discussed in this document can be used. Computer programs can be developed to analyze the peaks. These programs may use peak area, signal to noise measurements or another aspect of the profile. Whatever the method used to analyze the profile, the peaks that will contribute most to diagnosis are those listed in this document.

Still other changes in procedure may be the use of different extraction media (other than C4 ZipTips) such as ion exchange and hydrophilic adsorption surfaces, the use of mass spectrometry methods other than MALDI-TOF, such as those listed in other parts of this document, the use of extraction devices other than a ZipTip and other changes. All of these modifications will remain based on the general methods outlined in this document and will therefore mimic the approaches used here. Most aspects of the modifications will be recognized from descriptions provided in this document.

The absolute values for the cutpoint, for a guarantee of BOS in 15 months and for a guarantee of no BOS in 15 months may vary as assay methods are altered and improved. Nevertheless, the fundamental approach will remain as described here. The method for obtaining a total score may differ from equation 1, and may include weighting of different peak ratios or use of non-linear relationships for peak ratios between those that guarantee no BOS vs. those that guarantee BOS. Such changes may improve diagnosis. However, these analysis methods will use the fundamental approaches described in this document.

It is evident that the method described herein could be applied to BALF, breath condensate or sputum. Furthermore, it will have utility in diagnosis of lung diseases including asthma, infections such as pneumonia, and degenerative diseases such as emphysema or COPD.

### Example XII

### Polymorphisms

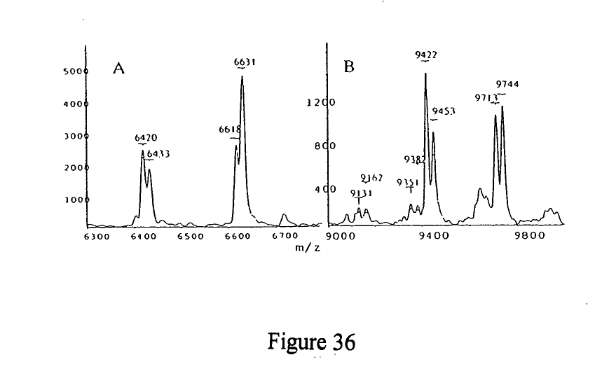

Survey of over 500 persons of European descent identified polymorphisms in TTr, as shown in Example I. Certain polymorphisms of TTr are causes of familial amyloid neuropathy. Another abundant polymorphism found in this subject population was in the 4150 peak. A second component at m/z=4186 appeared with about a 20% frequency. A single case of polymorphism was found in Apolipoprotein CIII that gave a second component at 30 amu higher than is commonly found (FIG. 36B).

A very interesting polymorphism was found only in persons of Native American descent. Of 30 persons, 6 showed a polymorphism with respect to apolipoprotein CI (FIG. 36A). The polymorphism was shown by a second peak at about 14 amu lower than the most common form of this protein. This appeared to be a functional polymorphism. That is, it showed substantially more protease digestion to the form with two amino terminal residues removed. This is shown by the higher ratio of 6631/6433 (the common form) versus 6618/6420 (the new polymorphism) in FIG. 36A. This suggested that the apolipoprotein CI at m/z=6618 had a function difference that was detected by its susceptibility to proteolytic degradation. In earlier examples, we showed that the degree of cleavage of apolipoprotein CI was strongly related to insulin resistance. It is known that Native Americans have a higher incidence of diabetes than Europeans. Of the 6 Native Americans who showed this trait, 2 were diagnosed with type 2 diabetes and a third had an extremely high plasma lipid level demonstrated by extremely turbid plasma. Only three of the other 24 Native American subjects had been diagnosed with diabetes 2 or about 12% of that population tested. The presence of three serious metabolic disturbances in 6 individuals shows the importance of this polymorphism to metabolic health. Analysis for this polymorphism is therefore an important health issue for Native Americans, including Hispanic, American Indian and Inuit populations.

The low mass variant of apolipoprotein C1 (m/z=6617; also observed as m/z=6618) differed functionally from the more common form of the protein, indicating that it is an important metabolic factor. This was shown by digestion of these forms of apolipoprotein C1 by hog kidney DPPase enzyme (Sigma Chemical Co., St. Louis Mo.). Plasma from individuals showing both forms of apolipoprotein C1 were diluted 20-fold and DPPase from hog kidney was added. The reactions were sampled at various times and the ratio of truncated apolipoprotein C1 to intact C1 was determined for the common form of apolipoprotein C1 (m/z=6631) and the low mass form (m/z=6617). The rate of enzyme cleavage of the low mass form (m/z=6618 conversion to m/z=6420) was 3.1 times the rate of degradation of the more common form of apolipoprotein C1 (m/z=6631 conversion to m/z=6433). This indicated a different exposure of the low mass variant of apolipoprotein C1 and an altered interaction with lipoproteins. Consequently, the low mass variant of apolipoprotein C1 will provide altered properties that will affect metabolic functions in the individual.

Analysis of the polymorphism can be conducted by the mass spectrometry method outlined here. However, this modification can also be monitored by standard methods that evaluate DNA composition. These can include several approaches that begin with sequence of the DNA encoding the mutant apolipoprotein C1. Several commercial firms currently conduct such sequence analysis on a fee basis. The affected gene is then compared to the common gene sequence to determine the mutation that results in a protein with reduced mass such as the protein in FIG. 36A. Analysis of target individuals may then be conducted by sequence of this portion of the gene or the mRNA in each individual. Ultimately, the information obtained can be used to design a method currently described as SNP analysis. Commercial approaches are available for such an analysis. Examples include methods provided by Sequenom, Inc. and Applied Biosystems, Inc. A specific assay for the mutation can also be designed by use of restriction enzymes that detect the site of mutation on the basis of known specificity of the restriction enzyme. Overall, a number of well-described methods are available to assay any mutation that produces the low mass form of apolipoprotein C1, or any of the polymorphisms discovered by protein profile analysis. The important information is the discovery of a mutation that is of functional importance.

The importance of the 6631/6433 peak ratio to diagnosis of diabetes or pre-diabetes is also illustrated by distribution of this peak ratio among the Native American population described above. A questionnaire given to these individuals determined the family history of each individual with respect to type 2 diabetes. Each individual was given a score of 1, 2, 3 or 4 depending on the level of diabetes in their families. A score of 4 (10 individuals) indicated no known family members with the disease, a score of 3 (9 individuals) indicated one immediate family member with the disease, a score of 2 (8 individuals) indicated more than one family member with diabetes 2 and a score of 1 (3 individuals) was given to persons who had been diagnosed with the disease. Persons with a family score of 2 (2 or more family members with type 2 diabetes) had an average 6631/6433 peak ratio of 3.93, those with a family score of 3 had an average of 2.55 (p<0.001, relative to those with a score of 2) and those with a score of 4 had an average of 2.95 (p<0.01, relative to those with a score of 2). Two of the three individuals diagnosed with diabetes had scores of 2.54. These values were considered low due to the polymorphism. The three individuals with diabetes and normal apolipoprotein C1 structure showed 6631/6433 peak ratios of 3.77, 2.14 and 2.53. These were lower than those individuals with abundant family history but without disease themselves. Thus, individuals with the highest level of family history of diabetes but who had not been diagnosed with diabetes themselves showed a high peak ratio. This high ratio may represent a physiological mechanism that prevents diabetes in the short term. A high probability of future diabetes is referred to as the pre-diabetic state. As shown elsewhere in this document, diabetes is the result of an imbalance of fasting glucose and insulin and the parameter measured by the 6631/6433 peak ratio. Persons who develop diabetes may have a lower than optimum ratio that signals the actual cause of diabetes.

In a larger study of 228 persons of American Indian ancestry, 38 instances of the polymorphism were found. These individuals had an average BMI that was 9% higher (p<0.02) than that of persons who only had the common form of apolipoprotein C1. In a separate family study, four age- and gender-matched sibling pairs were found in which one had the polymorphism and the other did not. The BMI of siblings with only the common protein was 26±2.4 (SD) while the average for the siblings with the modified protein was 37.1±5.8 (SD) (p<0.003). These studies make it apparent that early detection of the polymorphism would be important to avoid development of obesity and subsequent diabetes.

Thus, protein profiles can be used to detect polymorphisms and determine linkage to disease as well as likelihood of developing disease themselves.

### Example XIII

### Gene Coding for the Mutated Form of Apolipoprotein C

The variant of Apolipoprotein C1 having a mass 14 atomic mass units below the normal protein (m/z=6617) and found in persons of Native American Descent (Example XII) was sequenced, and it was determined that it contains a threonine to serine single site mutation at position 45. This low mass variant is referred to herein as the “T45S variant.” This variant is characterized by a peak at lower mass (m/z=6618) than the normal form of human apolipoprotein Cl (m/z=6632) in the MALDI-TOF protein profile analysis of plasma.

| | |
|---|---|
| Sequence of human Apolipoprotein C1 | |
| (GenBank Acc. No. P02654) | |
| MRLFLSLPVLVVVLSIVLEGPAPAQG/Signal/TPD | (SEQ ID NO:4) |
| VSSALDKLKEFGNTLEDKARELISRIKQSELSAKMRE | |
| WFSETFQKVKEKLKIDS | |

| | |
|---|---|
| Sequence of the T45S variant. | |
| MRLFLSLPVLVVVLSIVLEGPAPAQG/Signal/TPD | (SEQ ID NO:5) |
| VSSALDKLKEFGNTLEDKARELISRIKQSELSAKMRE | |
| WFSESFQKVKEKLKIDS | |

This variant of Apolipoprotein C1 can be detected by profile analysis or any of a number of approaches currently used to detect a change in the DNA, including direct DNA sequence analysis. Alternatives include kits and instrumentation for SNP analysis such as those provided by Sequenom Inc. and by Applied Biosystems.

The sequence for the gene encoded by GenBank accession number X00570 is shown below. The substitution is A467T in this gene produces the T45S variant of ApoC1. The ATG sequence in the first line indicates the beginning of the coding region. The A to T substitution is highlighted using parentheses.

T45S cDNA Variant (SEQ ID NO:6)

| | |
|---|---|
| 1 | cccgcagctc agccacggca cagatcagca ccacgacccc tccctcgggc ctcgccatga |
| 61 | ggctcttcct gtcgctcccg gtcctggtgg tggttctgtc gatcgtcttg gaaggcccag |
| 121 | ccccagccca ggggacccca gacgtctcca gtgccttgga taagctgaag gagtttggaa |
| 181 | acacactgga ggacaaggct cgggaactca tcagccgcat caaacagagt gaactttctg |
| 241 | ccaagatgcg ggagtggttt tcagag(t)cat ttcagaaagt gaaggagaaa ctcaagattg |
| 301 | actcatgagg acctgaaggg tgacatccag gaggggcctc tgaaatttcc cacaccccag |
| 361 | cgcctgtgct gaggactccc gccatgtggc cccaggtgcc accaataaaa atcctaccg |

Native cDNA for X00570 (SEQ ID NO:7)

| | |
|---|---|
| 1 | cccgcagctc agccacggca cagatcagca ccacgacccc tccctcgggc ctcgccatga |
| 61 | ggctcttcct gtcgctcccg gtcctggtgg tggttctgtc gatcgtcttg gaaggcccag |
| 121 | ccccagccca ggggacccca gacgtctcca gtgccttgga taagctgaag gagtttggaa |
| 181 | acacactgga ggacaaggct cgggaactca tcagccgcat caaacagagt gaactttctg |
| 241 | ccaagatgcg ggagtggttt tcagag(a)cat ttcagaaagt gaaggagaaa ctcaagattg |
| 301 | actcatgagg acctgaaggg tgacatccag gaggggcctc tgaaatttcc cacaccccag |
| 361 | cgcctgtgct gaggactccc gccatgtggc cccaggtgcc accaataaaa atcctaccg |

The gene variant may be produced by any of several methods, including chemical synthesis or the modification of the DNA sequence appropriate site in the naturally occurring nucleic acid sequence by methods known in the art. Once formed, the gene or appropriate DNA sequence can be introduced into bacteria or other types of cells using any of the methods available in the art for purposes of expressing the low mass form of apolipoprotein CI.

The gene/protein variant can also be incorporated into an experimental animal to be used for experimentation regarding the properties of this protein in an animal model. One approach is to make an homologous mutation in an animal form of ApoCI. The mouse is the most likely target for study. The protein sequence for mouse ApoC1 from the Expasy web site (available on the worldwide web at expasy.org) is as follows:

| | |
|---|---|
| Mouse ApoC1 | |
| APDLSGTLESIPDKLKEFGNTLEDKARAAIEHIKQKE | (SEQ ID NO:8) |
| ILTKTRAWFSEAFGKVKEKLKTTFS | |

The residue homologous to T45 of human ApoC1 is A49 in mouse ApoC1. In one approach, the gene for mouse ApoC1 can be altered to generate an ApoC1 protein with a A49S mutation. Animals that express the desired mutation can be used for study of metabolic disease. The invention thus includes a mouse in which the gene for ApoC1 has been modified to substitute alanine at amino acid position 49 with serine (A49S).

Another useful animal model is a mouse in which the gene for ApoC1 has been modified so that the proline at amino acid position 2 (Pro2) has been replaced by Xaa, wherein Xaa is any amino acid other than alanine. In this variant, ApoC1 is not readily cleaved by dipeptidylpeptidase IV. Since modified protein is poorly cleaved by dipeptidylpeptidase IV, one can experimentally determine the impact of ApoC1 truncation on the health and metabolism of that animal.

Additional examples of homologous apolipoproteins from animals are shown below. The amino acid sequences of mouse, human, dog and rat apolipoprotein CI show similar organization. This similarity or homology is emphasized by the alignment that emphasizes the charged amino acids. The acidic residues are in bold and basic residues in large type and bold print. From this alignment, it is clear that one can find the amino acid residue altered in the low mass form of human apolipoprotein CI and then introduce changes in the DNA sequence encoding the animal protein to create a homologous modification in the expressed animal protein. For example, if the mutation resulted in a K to N change in the human, one could locate the homologous residue in the animal protein, make a change in the animal gene that codes for the same change in the animal protein. The altered gene for the animal protein can then be introduced into a cell line for purposes of expressing the protein for subsequent studies of protein properties, either in the test tube or by direct introduction into an experimental animal. The gene can also be introduced into an animal so that the animal produces the protein. This would constitute an experimental model for study of the effects of the low mass human protein described. In this way, it would be possible to study the effects of the polymorphic protein in a species other than human.

Protein sequence comparisons for apolipoprotein CI from mouse, human, dog and rat. Alignment of these residues maximizes the homology comparison. The numbers at the end of the sequences indicate the number of negatively charged residues and the number of positively, charged residues, respectively. The net charge ranges from +1 to +3.

| | |
|---|---|
| Mouse CI (SEQ ID NO:9) | |
| APDLSGTLESIPDKLKEFGNTLEDKARAAIEH IKQKEILTK | −10 + 12 |
| TRAWFSEAFGKVKEKLKTTFS | |
| Human CI (SEQ ID NO:10) | |
| TPDVSSAL DKLKEFGNTLEDKAR ELISRIKQSELS | −11 + 12 |
| AKMREWFSETFQKVKEKLK IS | |
| Dog CI (SEQ ID NO:11) | |
| AGEISSTFERIPDKLKEFGNTLEDKARAAIES IK KSDIPA | −10 + 13 |
| KTRNWFSEAFKKVKEHLKTAFS | |
| Rat CI (SEQ ID NO:12) | |
| APDFSSAMESLPDKLKEFGNTLEDKARAAIEH IKQKEIMIK | −10 + 12 |
| TRNWFSETLNKMKEKLKTTFA | |

### Example XIV

### A kit to Obtain Blood for Storage and Transport for Profile Analysis

Protein profiles can be obtained from plasma or serum that has been dried onto filter paper. One example of a kit designed to yield a dried sample suitable for analysis can contain: 1) An alcohol swab, similar to those used for disinfection before injection of blood removal. 2) a device to prick the finger, such as a common finger stick used for blood glucose detection instruments, 3) strips of Whatman 3mm filter paper or other absorbant material such as strips of cloth, string. The strip should be approximately 0.2 to 5 mm wide and a length convenient to sample the blood, 1 to 3 inches would be a good length. Preferably the paper will be soaked in a 2 to 20 mM solution of butylated hydroxyanisole in ethanol or other appropriate solvent and dried before placing in the kit. 4) A vessel into which the blood will be placed while it clots or agglutinates. This vessel preferably holds at least 10 microliters of blood and is suitable for introduction of the tip of the filter paper or absorbent material to touch the surface of the liquid. A convenient size would be 2 to 5 mm wide. The vessel should have a cover that prevents evaporation during the incubation phase. A convenient cover would be similar to that found on the common Eppendorf tube. 5) Instructions for how to identify the sample and return the strip to the analysis center. 6) Instructions for how to obtain serum for subsequent detection by protein profile analysis.

The instructions can include many modifications but a minimum outline as follows: A) Remove the alcohol swab from its packet and swab the tip of your finger. Let your finger air dry. B) Remove the cover from the needle and pierce your finger in the area that was disinfected. The instructions may contain a picture to show how to remove the cover and will be designed for the exact device that is used. c) Blood will appear and should be allowed to form a droplet that is transferred into the vessel provided. The blood should fill the vessel to the marked line, an amount of at least 10 microliters but less than 50 microliters. It may be necessary to gently squeeze your finger to coax out the blood. Do not over-squeeze, it is possible to obtain 1 0-times the necessary volume from a single finger prick. As soon as you have transferred the small drop of blood to the vessel. Stop the bleeding by pressing with the sterile gauze provided in the kit. Apply pressure to your finger for a minute or so to ensure that bleeding has stopped. When it has stopped, you can discard the alcohol swab and gauze in the waste basket. D) Cover the vessel and allow it to stand at room temperature for about 2 hours. E) open the vessel and place the end of the paper strips provided in the kit to the surface of the blood clot. You should see liquid seep up the paper strip. Allow it to reach a height of at least 3 mm (the line provided on the strip). If the tip of the strip is very red, remove the red portion by clipping the paper with a scissors. The liquid on the paper should be only slightly red in color and may be entirely clear. F) allow the paper strip to dry thoroughly, place it into the plastic bag provided with the kit, seal and send to the laboratory by an appropriate carrier. G) Be sure to identify your sample. For your confidentiality, you can give any identification you would like. The address on the envelop is the only identification we have and it will be returned to you with no identifiers retained by the laboratory.

### Example XV

### Quantification of Proteins in a MALDI-TOF Profile by a Deuterium Labeling Method

Analysis of protein profiles by MALDI-TOF mass spectrometry is a rapid and useful approach for detection of biomarkers. Several profile methods are available including SELDI by Ciphergen, Inc. (Surface-Enhanced Laser Desorption Ionization), an extraction system of coated magnetic beads provided by Bruker Daltonics, Inc., a method for protein extraction described by Perkin Elmer, Inc. These are described in materials available from the respective companies. It is anticipated that additional profiling methods will be presented in the future. For example, we have used carefully controlled ZipTip extraction to obtain protein profiles of serum, plasma, bronchoalveolar lavage fluid and other body fluids to identify protein biomarkers (e.g., Nelsestuen et al. Proteomics, 5, 1705-1713 (2005)). For plasma and serum, profiles are extremely reproducible and the ratio of one peak to another has proven an excellent approach by which to obtain relative quantification information about the profiles. This approach was especially useful for homologous peaks, those that are composed of nearly identical proteins components that differ by a small degree. One approach to analysis of profiles was to determine the ratio of one peak intensity or area to another in the profile. This method allows comparative analysis but does not measure absolute concentration. The approach would not detect change when all of the proteins of the profile are up-regulated or down-regulated to the same extent.

A classical approach to quantification of proteins by mass spectrometry consists of spiking the sample with a known amount of a synthetic or purified protein or peptide that differs from the protein in the sample on the basis of its isotope content. For example, the spiking material may contain nitrogen-15, deuterium, or carbon-13 atoms instead of nitrogen-14, hydrogen, or carbon-12, respectively, to change the mass but provide a chemically identical structure. The nitrogen, deuterium or carbon label is incorporated by chemical or biological means into the protein in such a way that it is stable to standard manipulation of the sample. Nitrogen and carbon atoms are stable to standard manipulations in most structures and deuterium is provided in a stable form such as in covalent attachment to carbon atoms.

Typically, the proteins and peptides are separated and analyzed in the mass spectrometer. Comparison of peak area or intensity for the target compound with that of the spiked material in the same sample allows quantification of the protein or peptide on the basis of the known concentration of the spiked material. The two proteins are chemically identical and therefore give identical intensities in the profile.

Other methods for quantification by mass spectrometry and isotope labels use modification of proteins or peptides in two samples with chemically identical but isotopically different agents. The agents contain stable isotopes in non-exchangeable positions. There are a number of examples of this approach including Regnier, F. E. (Mar. 8, 2005) U.S. Pat. No. 6,864,099; Aebersold et al. (Dec. 30, 2003) U.S. Pat. No. 6,670,194; and Pappin et al. (Jul. 7, 2005) United States Patent Application 20050148087. The proteins or peptides are allowed to react with a reagent that attaches a covalent moiety to the protein with different masses for each derivative. Ratios of proteins in the two samples can be determined from the peak intensity ratios for the different peptides labeled with different isotopes and analyzed in the mass spectrometer. Current examples of commercially available approaches include isotope coded affinity tag (ICAT, Applied Biosystems, Inc.) and iTRAQ™, (Applied Biosystems, Inc.). Other approaches use ¹⁸O water and a protease enzyme such as trypsin to introduce ¹⁸O into the peptides during hydrolysis of one sample and ¹⁶O water during hydrolysis of another sample. The samples are mixed and analyzed in the mass spectrometer. Ratios of peptides in the two samples are then obtained by comparing intensities or peak areas for the peptides containing ¹⁶O or ¹⁸O. These isotope labeling methods share the property that they detect protein ratios in two samples rather than absolute concentration. Methods for determining the ratio of peptides in two samples are reviewed in Moritz et al., Proteomics (2003) 11:2208-20.

Quantification of materials in a protein profile provides several challenges. When a biomarker is known and can be obtained in stable, isotopically labeled form, quantification of can be achieved by spiking the sample as described above. With sufficient knowledge, it would be possible to spike with a mixture of every protein of the profile. This is very effort intense and expensive. Even if possible, the extraction method may be incomplete so that the purified, spiked protein is extracted to a different extent than the protein that is present in the sample. For example, many proteins exist in tight complexes and may not be fully released by the extraction procedure. The ratio of the target protein to the spiked material in the mass spectrometer may not give a proper estimate the concentration in the sample. Furthermore, the profile may contain many components, some of which may not be available or the structure may not be known.

Hydrogens in a protein can be described as either in exchangeable or non-exchangeable sites. Non-exchangeable sites are stable to normal chemical reactions and manipulations of the sample. For example, nearly all carbon-linked hydrogens or deuterium atoms are non-exchangeable. Exchangeable hydrogens are those that exchange with solvent hydrogen atoms under mild conditions. The rate of exchange differs with structure. Hydrogens of alcohol and amine groups generally exchange within seconds or less. However, it is known that amide hydrogens have slower exchange. Depending on solvent accessibility, the exchange rate can take hours. Slow exchange of amide hydrogens has been used for many years to develop methods to detect the relative accessibility of amide hydrogens in different regions of a protein in order to detect folding properties of the protein, changes in protein structure associated with ligand binding or interaction with other proteins.

Recently, detection of the rate of exchange has been expanded to include mass spectrometry methods (Woods, V. L., Jr., (Sep. 18, 2001) U.S. Pat. No. 6,291,189; Woods, V. L. (Jul. 29, 2003) U.S. Pat. No. 6,599,707; Woods, V. L. (Sep. 18, 2004) U.S. Pat. No. 6,797,482). Many examples of use of this approach to determine protein properties of single or complexed proteins are available in the scientific literature (e.g. Mandell et al; Methods Mol Biol. (2005) 305:65-80; Guan et al., Biochemistry (2005) 44, 3166-75; and Busenlehner et al., Arch Biochem Biophys. Jan. 1, 2005;433(1):34-46). In a typical experiment, the protein in question is labeled by incubation in deuterium oxide solvent under conditions capable of exchanging amide hydrogens for deuterium of the solvent. The protein is then returned to hydrogen water and the rate of exchange of the deuterium atoms for hydrogen is determined by measuring protein m/z values in the mass spectrometer. Since most proteins are too large for direct observation in the mass spectrometer, more commonly the protein is digested with a protease that releases peptides from the intact protein and analysis is conducted on the released and fractionated peptides. This process must be completed within a short time in order to avoid complete deuterium exchange after the protein has been digested.

The present invention provides a unique coupling of exchangeable deuterium labeling of a protein with protein profile analysis by mass spectrometry to produce a robust approach for direct quantification of protein concentration in an unknown sample. This method requires several modifications from previously described methods for profile analysis to ensure that amide deuterium atoms are not exchanged during extraction and analysis. To our knowledge, such a labeling method has not been described or used in protein profile analysis. Furthermore, methods described for sample extraction by virtually all of the methods for protein ratio determination in a sample as well as the profile methods described by Ciphergen, Inc. and Bruker Daltonics, Inc. involve extraction procedures that include conditions that would allow excess exchange of amide hydrogens. These conditions would prevent separate detection of a sample originally introduced in D₂O from one introduced in H₂O.

The method is performed by labeling a reference sample, referred to herein as a “standard,” by incubation in D₂O to exchange amide protein hydrogens for deuterium. The standard could be one or more pure proteins or it could be a biological sample of any complexity. Exchange of deuterium into the proteins or peptides is accomplished by lyophilizing the protein or other means to remove water followed by rehydration with D₂O and incubation, for example at 37° C. for 2 hours and overnight at room temperature. This produces a sample in which all proteins have higher mass due to deuterium incorporation into exchangeable sites. A known amount of the standard sample is then mixed with a target sample that is provided in H₂0. Generally, the water sample is in large excess (volume) to the deuterium sample. Upon mixing, the deuterium in exchangeable positions begins to exchange with hydrogen in the water. An excess of H₂O is also provided during wash steps such as those described for ZipTip extraction, ensuring that the deuterium water is entirely removed. By lowering the temperature of the sample target and analysis of the sample within a short time interval, the sample that was originally in deuterium water will retain a substantial number of deuteriums in amide positions and give a peak clearly distinguished from the proteins originally found in the H₂O sample.

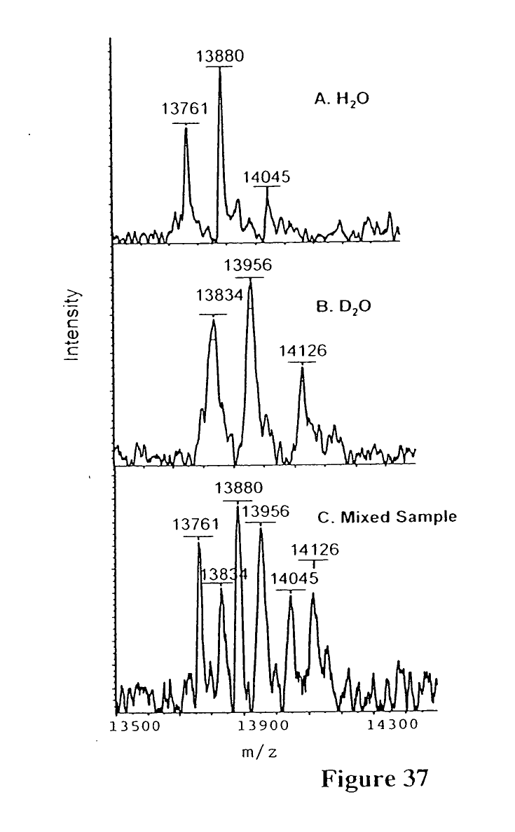

Examples of results are shown in the FIGS. 37, 38 and 39. FIG. 37 shows a deuterium-labeled sample of plasma showing the hydrogen sample (FIG. 37A) and deuterium-labeled sample (FIG. 37B) separately. Each has been extracted in H₂O solvent by the standard extraction method. Only the region containing transthyretin is shown. All peaks of the profile show higher mass for the deuterium sample than the hydrogen sample. The top panel shows the water sample alone, the middle panel shows the deuterium water sample alone and the bottom panel shows an equal the mixture of the two. The peaks from the H₂O and D₂O samples are well separated and the ratio of peak intensity or areas of the peaks can be used to determine the concentration of proteins in the two samples. In this case, the ratio is approximately 1:1.

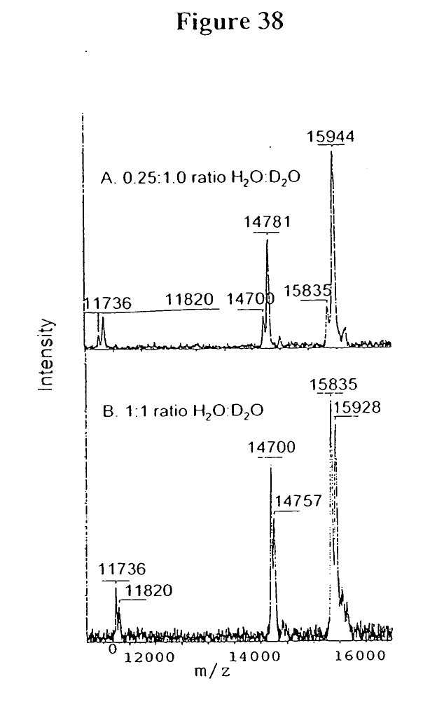

FIG. 38 shows a portion of the proteins in a profile of bronchoalveolar lavage fluid (BALF) from a healthy control that was mixed with the same sample that had been incubated in D₂O. The deuterium sample had been concentrated 10-fold so mixture of equal amounts of protein (FIG. 38B, 4 micrograms from each sample), and further dilution to 150 microliters of water provided 20-fold dilution of the D₂O. Once again, two peaks for each component are apparent, one for the protein from the D₂O sample and the other from the H₂O sample. FIG. 38A shows the method for quantification by mixing different ratios of protein (0.25:1.0, H₂O:D₂O samples). The ratio of each protein in the target sample to that in the standard can be obtained from the ratio of peak heights or areas. The D₂O sample often showed greater peak width and lower peak height than the H₂O sample, possibly due to variable exchange rates for the different sites in the protein that result in a larger range of mass for the peptides. Consequently, peak area may be the preferred method for comparing the two peaks.

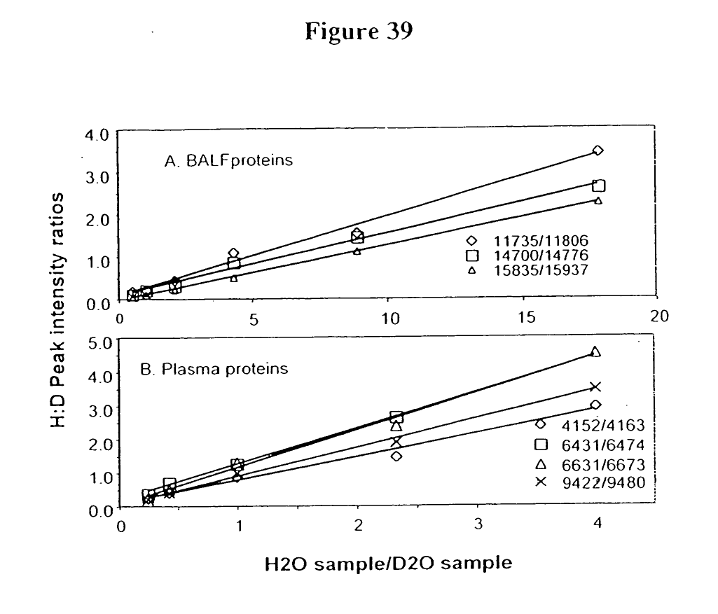

Nevertheless, the results in FIG. 39 show that peak intensity ratios provided a relatively good linear relationship to the amount of D₂O or H₂O samples that were mixed. The R² values for the line drawn was >0.98 for all peak ratios shown.

This method can be used with a standard sample in which the concentration of the biomarker proteins is known. In this case, the absolute concentration of the proteins in the target sample can be determined from the ratio of the added component to that of the endogenous compound. In the case of unidentified proteins, the method allows measurement of a peak in all samples to be studied, relative to the peak in the standard. This can provide relative differences between proteins in the samples of a study and can eventually be converted to absolute concentration when the protein is identified and quantified in the standard.

This approach can be used for any peak observed in a profile. It allows all proteins to be labeled with heavy isotopes for quantification in one analysis. The method can be used to compare protein levels in an individual before and after exposure to a stimulus by comparison to the same deuterium-labeled sample. Alternatively, it can be used by labeling one sample with deuterium with direct comparison to the after sample from the same individual

Optimum conditions for assay include use of cold temperatures. Extraction at 4° C. allows at least an hour before most peptides exchange too many of the amide hydrogens for subsequent quantification. Another way to stabilize the sample and prevent exchange once the proteins have been applied to the MALDI target is to dry the sample thoroughly by means such as high vacuum provided by the mass spectrometer. Air drying alone is generally insufficient to stop exchange of proteins on the target surface.

### Example XVI

### Analysis of Urine using MALDI-TOF

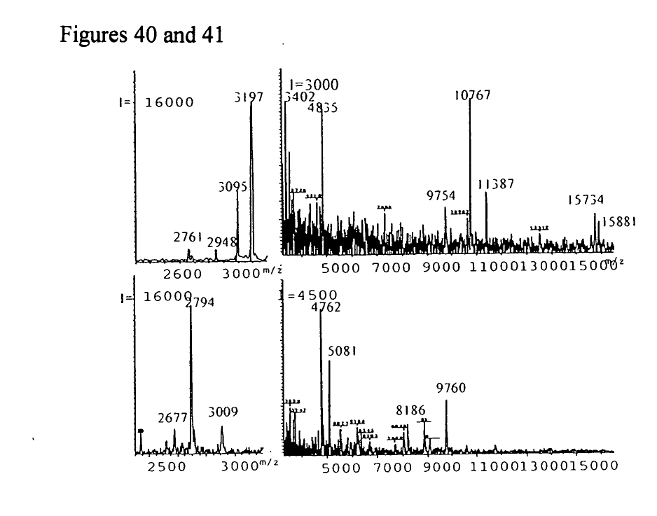

Urine was concentrated by about 50-fold through use of speed vacuum or centrifuge filter (cutoff at 3500 atomic mass units) to provide an improved signal. Alternatively, larger volumes of unaltered urine (100 μL) were adsorbed for three minutes onto a ZipTip to provide a substantial signal. The samples were analyzed by MALDI-TOF according methods described herein. The protein profiles of a healthy adolescent male (FIG. 40) and an adult (FIG. 41) are shown. The spectrum is provided in two sections with the m/z values indicated. Well-defined peaks were detected that indicated that discrete compounds can be identified. Since signal intensity in the mass spectrometer is unique to each sample, strict quantification of a peptide component in the spectrum requires use of an internal standard. A plot of m/z versus peak intensity can reveal components that are common to many samples.

The results show that mass spectrometry is uniquely suited to detect small peptides such as those arising from proteolytic fragmentation. The potential for analysis of small peptides can be illustrated by diagnosis of chronic lung transplant rejection from the appearance of polypeptides below m/z=20,000 (see Example XI). Thus, this type of analysis may be valuable for analysis of any pathology that results in kidney damage and tissue damage. Target diseases or conditions include nephropathy from diabetes type 1 or 2, kidney disease or injury from other sources, kidney transplant and other conditions. Also, many small peptides are excreted via the kidney and it is possible that urine analysis will detect diseases from other organs that release peptides or proteases into the blood stream or solid tissue. Once again, change in the level of peptide excretion can be used to indicate the response of an individual to treatment or a worsening of the condition.

Various stimuli can be used to monitor kidney function. Food intake can include various protein sources or food additives, such as those that will appear in the urine. Samples taken before and an appropriate time after food intake can be used to monitor kidney function. Alternatively, peptides appropriate for analysis by MALDI-TOF can be injected into the blood stream and their appearance in the urine can be used to detect kidney function. Overall, there are a number of ways that a stimulus can be applied to test kidney function by MALDI-TOF profile with comparison to the individual's personal urine profile before and after the stimulus.

For sample preparation, a convenient method is to extract urine directly without concentration by modifying the ZipTip extraction procedure. This approach was used for the remaining experiments in this example. Urine (0.1 mL) was acidified (pH<3.0) with trifluoroacetic acid (TFA) and extracted with a C4ZipTip by slow passage of the solution into and out of the ZipTip for 2 minutes (about 50 passages of 10 microliters each). The tip was washed with 7×10 microliter washes of water:TFA (100:0.1) and was eluted by drawing and extruding 1.6 microliters of water:acetonitrile:TFA (20:80:0.1) 10 times. The extract solution (0.75 microliters) was applied to a spot on the MALDI target that already contained 0.75 microliters of an 85% saturated solution of sinapinic acid in water:acetonitrile:TFA (50:50:0.1). Crystallization of the sinapinic acid was induced by abrasion of the surface with the plastic pipette tip until the entire solution was crystallized. The spot was air-dried and subjected to MALDI-TOF analysis with collection of 1000 shots in the Bruker Biflex III mass spectrometer with the laser attenuated at 39%. The spectrum was smoothed and peaks identified as usual.

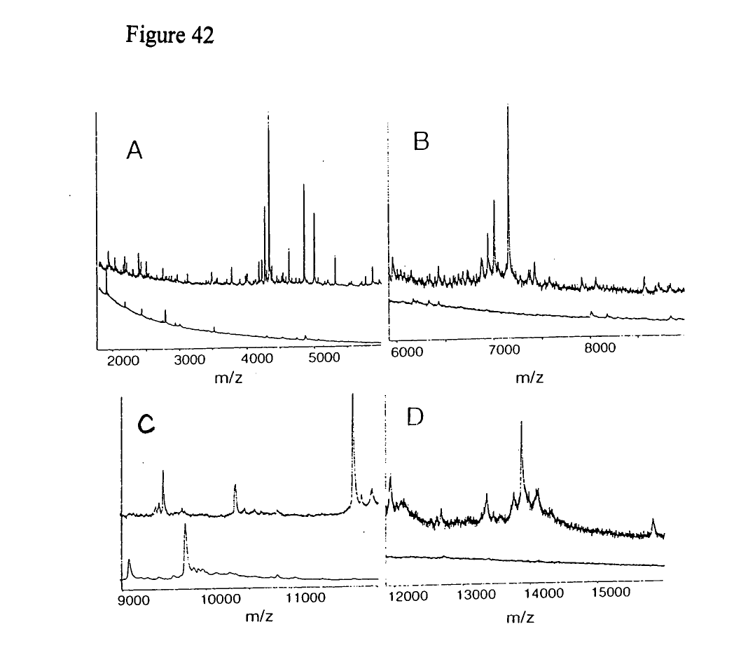

FIG. 42 shows the sum of profiles of 25 healthy individuals in one spectrum (sum performed by ClinProTools from Bruker Daltonics, Inc.) as well as the sum of profiles from 10 persons with kidney disease in another spectrum. The region of the profile from m/z=2000 to 6000 in Panel A showed few peaks for healthy persons, in contrast to the diseased group who showed many intense peaks. Components for healthy controls included significant peaks at m/z=2187, 2431, 2786, 3000, 3525, 4300, 4511, 4750, and 5070. The peaks at 2187, 2786, 4750 and 5070 were almost universal while others appeared in a lower percentage of individuals. Normally, the error in these m/z measurement is ±0.1% so that report of a peak at 4750, for example, indicates a peak in the range of m/z=4745-4755.

Due to differences in instrument calibration, the peaks all appear at about 10 mass units higher in the profiles shown in FIGS. 40 and 41. For example, the peaks at 9754 and 9760 in FIGS. 40 and 41 correspond to the component described more accurately as m/z=9742.

Individuals with advanced kidney disease included 4 individuals with diabetes, one each with IgA nephropathy, membranous glomerulonephritis, membranous nephropathy, polycystic kidney disease, CSA toxicity, and focal sclerosing glomerulosclerosis. These all showed many intense peaks in this region (Panel A of FIG. 42) of the profile. These peaks were largely individual or representative of a portion of the individuals. Consequently, most of these peaks were excellent markers for individuals, who can be monitored for advance of kidney disease by comparison of a profile to an earlier baseline, obtained before disease or at an earlier stage of disease.

Panel B of FIG. 42 shows the m/z=6000 to 9000 region of the profile. The mass range from 6000 to 9000 shows another group of peaks that differ in health vs. disease and can be used for disease diagnosis in the ways already described for the peaks in panel A. Again, the controls show few low intensity peaks, generally at 6175, 6333, 8015, 8184 and 8843. These were not universal but were specific to individuals. They can be used to document change in a personal profile over time. Persons with advanced disease showed many intense peaks in this region of the profile as well. Again, most of these peaks were found in a subset of the individuals and can be used for diagnosis by detecting change by comparison of an individual's profile to an earlier profile from the same individual. Furthermore, individual peaks may be disease-specific.

Panel C shows the region from 9000 to 12000. This region is quite important and discussed in greater detail below.

The mass range from 11900 to 15000 (Panel D, FIG. 42) shows other intense peaks in the profile. Especially notable are peaks at 11980, 13350, 13760 and 13880. The peaks at 13760 and 13880 corresponds to transthyretin, a plasma protein that has entered the urine, indicating proteinuria. The peak at 14049 is also a plasma protein and can be used to detect proteinuria. As pointed out below, however, the combination of plasma proteins that appear in the profiles do not appear in unison. As a result, the specific proteins can be used to determine the detailed nature of the lesion that produced the proteinuria. For example, peaks at 9422, 9713 and 8915 represent the apolipoproteins CIII1, CIII2 and CII, respectively. These components were found at various levels in different disease states. Sometimes they appeared only in samples containing transthyretin while in others they appeared without transthyretin. Consequently, the order of appearance of these plasma proteins may offer important insight into disease status and kidney function. Peaks at m/z=15126 and 15860 correspond to alpha and beta hemoglobin, respectively. These peaks are not highly abundant in advanced kidney disease but their presence can be used to diagnose specific types of kidney dysfunction. They were more common in persons who had received a kidney transplant and who displayed chronic rejection.

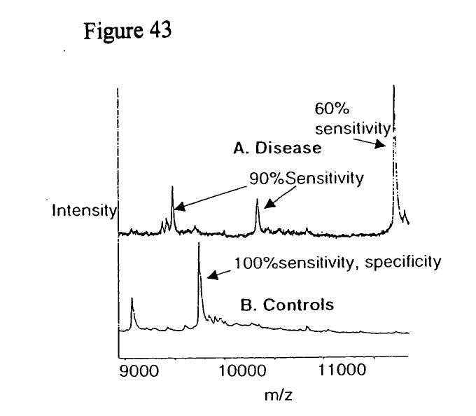

FIG. 43 provides a more detailed presentation of the profiles described in FIG. 42 for the region of m/z=9000 to 12000 (Panel C). The lower profile is of the healthy control individuals, and the upper is of the 10 individuals with advanced kidney disease. Healthy individuals showed two major peaks, one at a nominal m/z of 9742 and another at 9070. The peak at 9070 is a degradation product of the 9742 peak. This produces two forms of a single component in every one of a larger group of control individuals tested (53 to date). It was also detected in at least 50 samples from persons with low to intermediate disease levels. Consequently, a striking feature of the disease profiles was the absence of the component at 9742. This occurred in all ten individuals, giving loss of this peak a 100% sensitivity and 100% specificity for detection of kidney disease. It is apparent that the levels of this component in the profile will decline gradually as kidney disease advances so that quantification of this component in a person's profile and comparison to earlier profiles can be used to detect the rate of advance of a kidney disease in an individual.

A second biomarker in this region of the profile is a peak at approximately 10,350. This appeared to be an excellent biomarker. However, caution must be used since this peak also appeared in some of the control samples, although at a lower intensity. In addition, from a larger pool of controls, two contained significant levels of the defensin proteins at m/z=3370, 3441 and 3485. These individuals showed quite high levels of peaks at 10,350 and 10,840. Thus, appearance of the 10,350 peak in conjunction with the defensins must be discounted for disease diagnosis as it is found in a normal response mechanism. Frequent or prolonged appearance of these peaks may constitute a biomarker of kidney disease, however. Peaks at 10,840, 10,570, 10,760 were found at low levels in control individuals and can be used as biomarkers of disease only on the basis of consistent appearance in the profile, a very high intensity or appearance in unusual combination with other components of the profile. Other peaks found in a smaller section of disease individuals include m/z=10,174 and 10,215.

An important marker of disease was the component at 9480. This component arose with disease and was unique to relatively severe disease such as those in FIG. 43 or to persons with chronic kidney transplant rejection (not shown). It was not found at significant levels in any control individual or in persons with minor disease. It was found in 9 of 10 persons with advanced disease, the tenth person had extreme changes in other regions of the profile and was easily diagnosed on these other grounds. However, the presence of this individual made it clear that the optimum diagnosis of kidney disease generally requires use of several components. These are all observed simultaneously by the MALDI-TOF profile analysis method outlined here. In the samples analyzed to date, an increase of the 9480 component was the second most accurate single biomarker of kidney disease, after loss of the 9742 peak.

Another very intense peak of the profile occurred at 11728. This is beta-microglobulin, which was also a biomarker of chronic lung transplant rejection and other disease states (see Examples I, IX). This biomarker is obviously very intense in the averaged profile FIG. 43) and has been identified previously by other methods as a potential biomarker of kidney transplant rejection. Among the 10 advanced disease samples in this study, it was present in 6 of 10 individuals, indicating a good but not excellent biomarker with a sensitivity of 60% in this group of patients. Use of profile analysis or a combination of assays for these compounds will allow beta 2-microglobulin to constitute a partial diagnosis of specific kidney conditions, when used in conjunction with other biomarkers.

The components at m/z=9742±10 and 9073±9 (also referred to herein as the m/z=9070 component) offer several approaches to diagnosis of disease. The smaller component is a degradation product of the larger. This allows calculation of a homologous peak ratio, a very precise measurement in the MALDI-TOF profile. Homologous peaks are those that differ by a small structural element, giving very consistent relative intensities in the MALDI_profile. The other components of healthy individuals were not found in all individuals and they did not appear to constitute homologous peaks. The precision and reproducibility of peak ratio measurement for non-related components is less than for homologous peaks.

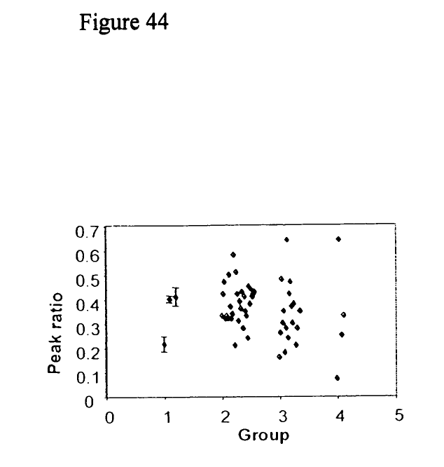

The constancy of each healthy person's urine profile is illustrated by the plot in FIG. 44, which shows the ratio of intensities for the m/z=9073/9742 components in several groups of people. Repeated samples obtained from three healthy individuals over one to 27-month periods showed an extremely constant ratio for each but that each had their own personal protein ratio (Group 1, FIG. 44). The samples included variations of time of day and even after extended exercise that produced significant exercise-induced dehydration and after high liquid intake that resulted in more dilute samples. Each data point shows the average for one individual with standard deviation for that persons samples taken under all conditions. The ratio was highly stable for each individual, indicating personal profile.

Group 2 individuals consists of single samples from persons who qualified for kidney donation (Group 2, FIG. 44). The 9070/9742 peak ratio showed the range of values observed among a healthy population. Ratios of 0.2 to 0.6 were characteristic of a healthy tissue. The results in group 1 and prior experience with plasma suggest that each of the individuals in group 2 will show their own characteristic ratio as long as they remain healthy.

The ratios can be used in several ways. First, observation that an individual has a protein ratio that exists outside of the values for group 2 (FIG. 44) would allow diagnosis that a disease state exists on the basis of a single sample. This is illustrated by individuals in group 4 (FIG. 44), described below. Second, much greater sensitivity is obtained by comparison of a profile to the same person's baseline profile taken at another time. The baseline can be obtained at any time when the individual demonstrates full health with respect to the kidney and related organ function. If analysis is started only after disease diagnosis, comparison of later samples to a first sample can be used to detect change and therefore alteration of disease. For the example of kidney transplant individuals, constancy of the profile would indicate health while fluctuations in the ratio over time would indicate an undesirable situation that should be followed up with further study. The results for group 1 suggest that a change of more than 10% could suggest a health problem, even though the actual peak ratio remained within the values observed for other healthy persons. This would constitute a type of individualized medicine and diagnosis.

Transplant recipients who showed no sign of rejection or other problem are shown in FIG. 44, group 3. These all showed ratios characteristic of healthy individuals. However, it is not possible to determine if the ratios represent the state of maximum health. This is because a single sample cannot determine whether the ratio is stable or fluctuating. A longitudinal analysis of each individual would detect fluctuation to identify early problems arising from kidney disease.

A second feature of group 3 profiles was signal intensity. The average peak intensity for the m/z=9742 component in healthy controls (Groups 1 and 2, FIG. 44) was 13 87±1000 counts. In contrast, the average for the successful kidney transplant individuals (group 3) was 332±233. While it was apparent that a wide range of intensities were observed for both categories of individuals, the kidney transplant recipients obviously tended to show a lower average. This should correspond to a lower level of the 9742 component in the urine of the transplant recipients.

As expected, the signal intensity for a healthy individual can vary with conditions. For example, an individual in Group I made a urine donation following high excretion of liquid induced by consumption of about 2 quarts of liquid over 2 hours including caffeinated beverages that served as a diuretic. The urine was more dilute as indicated by the intensity of the m/z=9742 peak. It was 334 counts versus 1580 found as the average of other samples taken from this person at times without high liquid intake. While the intensity difference did not influence the 9742/9073 peak ratio, this example showed that intensity can vary widely depending on prior history of urine production. The samples in groups 2 and 3 were taken in a clinical setting and under similar conditions and should be comparable. It was apparent that, on average, those who had received a kidney had lower levels of the m/z=9742 protein. Thus, absolute protein concentration or rate of excretion of the 9742 component can be used as a very sensitive method to determine health status, as long as the sample is corrected for conditions under which the sample was obtained. Use of protein ratios avoids most of the problems associated with urine concentration. However, with judicious use, absolute concentration of a protein can be used for diagnosis.

Group 4 individuals (FIG. 44) includes individuals who had received a kidney transplant and were in the clinic for an apparent problem. Biopsy did not indicate rejection. For two individuals in this group the peak ratios were far outside the values for healthy individuals, at values of 5.4 and 0.07. In five cases, the peaks at 9742 and 9073 were completely absent, suggesting a substantial medical problem. Clearly, the urine profile confirmed a problem for 8 of 10 of these individuals even though biopsy did not. Further work can show whether the different types of change detected specific disease states and if they only can be used to signify a general problem. The technology described here therefore enables one to investigate and assign specific importance to any change observed.

Combinations of peaks and use of lower mass peaks shown in FIG. 42 afford additional important information regarding the stage of a disease. Table 4 lists common peaks with emphasis on those that often appear in clusters. Some combinations of biomarkers are associated with mild conditions while others are associated with severe problems.

TABLE 4
Peaks from Chart 42 and other samples with use for diagnosis of
different levels of disease.

| Condition | m/z values (+/−0.1%) | Comments |
|---|---|---|
| Very mild conditions | 8180 | 8180 is often found at |
| | 3370, 3441, 3485 | low levels, it is a |
| | (Human | biomarker only when it |
| | neutrophil | approaches the intensity |
| | defensins, HNP) | of 9742 peak. |
| | 10840 | HNP is a biomarker if it |
| | (calgranulin A) | occurs frequently. |
| | More than a 20% | Calgranulin A usually |
| | change in the | appears with HNP. |
| | baseline | |
| | 9073/9742 peak | |
| | intensity ratio | |
| | taken when the | |
| | individual did not | |
| | display kidney | |
| | stress or disease. | |
| Biomarkers of mild kidney stress | 11732 (Beta 2 | Ratio of intensity to that |
| such as that following | Microglobulin) | of 9742 peak can be high |
| kidney donation | 4302 | (up to 20:1) without |
| | 9742 may decline | immediate danger as |
| | temporarily | long as auxiliary peaks |
| | | (below) are not seen. |
| | | 4302 is seldom seen in |
| | | advanced kidney disease. |
| Biomarkers of slightly greater kidney | 10350 followed | Intensity can range from |
| stress | by | very low relative to 9742 |
| | 9480 | to high. Degree of |
| | | kidney stress is |
| | | evaluated by the |
| | | intensity relative to |
| | | 9742. |
| More advanced Kidney disease that | 3495 | The low mass peaks |
| contain | 4180* | often appear in part or |
| Beta2 microglobulin | 4224 | complete unison with |
| (m/z = 11732) (about 52% | 4338* | 11732. |
| of advanced kidney | 4634 | The low mass peaks do |
| disease patients) | 11732 | not occur in mild kidney |
| | *generally the most | distress, regardless of the |
| | intense | intensity of 11732 or |
| | | 4302 peaks. |
| More advanced Kidney disease | 3785 | These often appear in |
| without Beta 2 | 3984 | part or complete unison |
| microglobulin (about | 4277 | for kidney disease that |
| 28% of advanced kidney | 4375 | does not show 11732. |
| disease patients) | 4860* | |
| | 5006* | |
| | 5320 | |
| | *generally the most | |
| | intense ions. | |
| A minor pattern (about | 9392* | These generally appear |
| 5% of advanced kidney | 5763 | along with other peaks |
| disease) | 12685* | that may not be |
| | *generally the most | consistent from one |
| | intense ions | individual to another |
| Other peaks that are | 6940* | |
| highly important in | 2715 | |
| disease but do not | 15835 or its +2 | |
| consistently correlate | state at 7918 | |
| with the groups above | (urinary protein | |
| | 1; also known as | |
| | clara cell protein) | |
| Idiotypic patterns for advanced | 9422 and 9713 | Indicate plasma proteins |
| kidney disease | (ApoCIII) | are entering the urine |
| | 13762 and 13881 | directly. Normally very |
| | (Transthyretin) | low, even in advanced |
| | 8915 (ApoCII) | native kidney disease but |
| | 13350 (unknown) | can be high in chronic |
| | | transplant rejection |
| General idiotypic (about | | May include any of the |
| 15% of advanced native | | biomarker peaks above |
| kidney disease states) | | but in combinations |
| | | other than those |
| | | presented. The 9742 |
| | | peak is generally low |
| | | intensity and many |
| | | unique peaks may |
| | | accompany these |
| | | patterns. |

The protein Beta 2 microglobulin is a biomarker but is not highly valuable as a single protein. It can be quite intense in mild kidney stress situations such as that experienced by a kidney donor after transplant. Healthy individuals almost never show a detectable level of the m/z=11732 component, and the average ratio of peak intensities for 11732/9742 among healthy persons was 0.03. All 10 kidney donors showed increase of the 11732 peak after surgery. For eight individuals the maximum ratio for 11732/9742 was <2 and began to return to zero by day 2 after surgery.

However, there were two instances of much higher ratios. These cases were predicted on the basis of abnormal profiles of the donors on the day before surgery. In one instance, a donor had a low 9742 peak intensity and a higher intensity of the m/z=8180 peak (peak ratio for m/z=8180/9742=1.0). The m/z=8180 component is found in many healthy persons but gave an average intensity ratio for m/z=8180/9742=0.04. Thus, this individual was unusual. After surgery, this individual reached peak ratio for m/z=11732/9742 of 40 and did not show recovery of this ratio by day 3 after surgery. This phenomenon was subclinical for the donor and was not detected by standard practice in the clinic. However, this individual may have been a poor kidney donor for either long-term or temporary reasons and the result may only be detected by kidney failure in the recipient at an early date of only a few years.

Another individual showed a substantial amount of both the 4300 peak (ratio of 4300/9750=1.0 versus 0.12 average among 26 other donors) and beta-2 microglobulin (11732/9730=0.2 versus an average of 0.02 among 26 healthy donors) before surgery. This individual reached ratios of 11732/9750 of 82 on day 1 after surgery but recovered to a ratio of 3 on day 2. Thus, profiles of donors before kidney removal can predict the level of response they will show after the operation. Protein profiles can be used to help identify the best kidney donors and to avoid operation if it coincides with a temporary stress on the donor kidney for other reasons.

Beta2 microglobulin (“beta2”) alone is not an effective biomarker by itself due to the fact that it can reach extreme levels in relatively mild states such as after kidney donation and it is often absent from some of the most severe kidney diseases. However, as used in this study and placed in proper context, it becomes a valuable biomarker. For example, kidney donors with high beta2 could be distinguished from advanced kidney disease on the basis of the presence of peaks listed in Table 4 that are absent from healthy kidney donors. The state of the patient can also help determine whether high beta2 is a serious or relatively low level concern. For detection of a mild condition, beta 2 microglobulin is not a normal detectable component of urine by the profile method. Its presence in persons suspected of mild disease is therefore an indication that a problem exists and additional tests or more frequent follow-up are needed.

Some of the biomarker peaks occur in clusters while others are idiosyncratic, appearing in odd clusters or as a single observation in one patient. Most peaks occurred in multiple ways. The following list of m/z values represents major peak intensities of the profiles from disease in approximately 100 samples from disease and transplant that have been analyzed to date. This list also does not give peaks below m/z=2500. These were often quite intense and can be used, but were often not as consistent as peaks in Table 4 or below. The method employed focused on peaks of >3000 m/z and these appear to provide the best biomarkers for most purposes. Peaks associated with disease that were seen in multiple samples (accuracy of ±0.1 percent): 2715, 2750, 2844, 2882, 3272, 3370, 3441, 3485, 3495, 3787, 3900, 3982, 4132, 4180, 4224, 4253, 4271, 4300, 4338, 4352, 4375, 4565, 4637, 4675, 4740, 4840, 4859, 4988, 5006, 5170, 5321, 5419, 5556, 5704, 5764, 5865, 6343, 6353, 6431, 6489, 6590, 6632, 6643, 6676, 6733, 6750, 6766, 6868, 6937, 7007, 7154, 7319, 7421, 7510, 7560, 7919, 7937, 8566, 8846, 8915, 9096, 9394, 9422, 9480, 9713, 10350, 10649, 10780, 10840, 10880, 11035, 11183, 11310, 11323, 11368, 11728, 12262, 12684, 12690, 13350, 13880, 15012, 15835, 20950.

Because normal individuals have so few peaks in their profile, the appearance of any unusual peak can signal a kidney or other urinary tract problem. Peaks observed on one occasion to date include (accuracy of ±0.1%): 2936, 2950, 3029, 3080, 3123, 3142, 3180, 3580, 4009, 4316, 4417, 4448, 4523, 4698, 4710, 4809, 4891, 4922, 4934, 4957, 4984, 4993, 5121, 5160, 5275, 6274, 6466, 6466, 6681, 7057, 7582, 7952, 8668, 8761, 9327, 10204, 13411, 14114, 20840. These represent peaks that were very intense in the sample in which they were observed. While observation of a peak on only one occasion makes it less valuable in specifying the type of disease, the appearance of one or more unusual peaks constitutes a non-specific diagnosis that indicates the need for additional tests. Often, these peaks appeared in intense clusters in one individual. For example, peaks at 4922, 4934, 4993, and 5160 were very intense components of one individual who presented other peaks as well but virtually none of the 9742 component. This person had severe disease even though only a few of the classic components of disease were present. Unusual peaks may represent a specific type of disease that will be revealed with additional study.

Table 5 summarizes profile analysis in a very simple way to demonstrate the power of the method, overall. Persons with advanced native kidney disease, i.e., those who are to be evaluated for possible kidney transplant, were correctly identified in 33 of 33 cases. Only 5 were considered to be even marginal in their profiles, mostly due to at least some residual peak at m/z=9742. Of 11 individuals with acute rejection, all but one was correctly identified as disease. Biopsy by current clinical methods classified that individual as mild acute rejection, the lowest grade. Even then, there were minor changes in that profile when compared with the majority of healthy controls. Those persons diagnosed with chronic rejection all showed severe changes in their protein profiles (Table 5). Other diseases included several conditions, some of which did not suggest a kidney disease. Profile analysis of those who attended clinic due to a suspected problem but for whom no diagnosis was found with current technologies showed that over half had a kidney problem. This diagnosis by profile analysis will stimulate further tests to identify the real problem for these individuals and avoid further kidney testing where the profile was normal.

One major goal of this method is to detect kidney transplant recipients who are completely successful and therefore need no further testing at this time. Of those individuals who had been clinically identified as successful transplants, profile analysis found significant numbers showing some evidence of a problem. Seven of 11 successful kidney recipients who were tested at one month after surgery showed evidence of a problem, mostly an elevated level of beta2-microglobulin, the peak at m/z=10350 and the m/z=4302 peak. It should be emphasized that the score of m in this category is often milder than a score of m in other categories in Table 5, where any residual peak at 9742 was often sufficient for a score of m. Another common, low level problem was the presence of human neutrophil defensins (HNP, m/z=3370, 3441, 3485) and the accompanying peak at m/z=10,840. While the actual HNP peaks can be very intense, they are considered a mild problem as long they are temporary components of the urine.

These mild disease proteins can appear in healthy persons but seldom reach the levels observed in the examples in Table 5. For example, in healthy controls, the average peak intensity ratios of beta2-microglobulin:9750 was 0.02, the average ratio of the 10350:9750 peaks was 0.03, the average for the 4302/9750 peak was 0.125. The so-called milder cases in Table 5 gave ratios for any or all of these components that were >0.3 and more commonly >1.0. The milder cases may represent post-operative problems that are experienced by all individuals, including donors, and which will correct over longer times. Nevertheless, appearance of these peaks at one month indicated the need for more frequent follow-up.

Two individuals at 1 month showed severe profile changes, indicating that there is a problem that should be monitored even more closely to determine whether it will improve or worsen. One of the values of regular screening by urine profiles will be to determine those individuals who improve vs. those who present a chronic condition that is likely to worsen if left untreated, or to detect those persons who develop problems long after the most critical time has passed. Thus, those individuals at I month who showed some profile problems are in need of more frequent monitoring by profile analysis, biopsy and other methods.

At one year the number of problem cases was lower (3 of 10). The two classified as mild showed the presence of HNP. Again, HNP is found in healthy urine with low frequency (about 2%). However, transplant patients showed detectable levels in 4 of 21 cases. Again, chronic expression of HNP may be detrimental to the kidney or other parts of the urinary tract and should be monitored to detect persons with prolonged expression that might lead to organ damage. One person at I year showed severe profile changes. This individual may present with organ problems within a relatively short time if the profile cannot be altered by treatment.

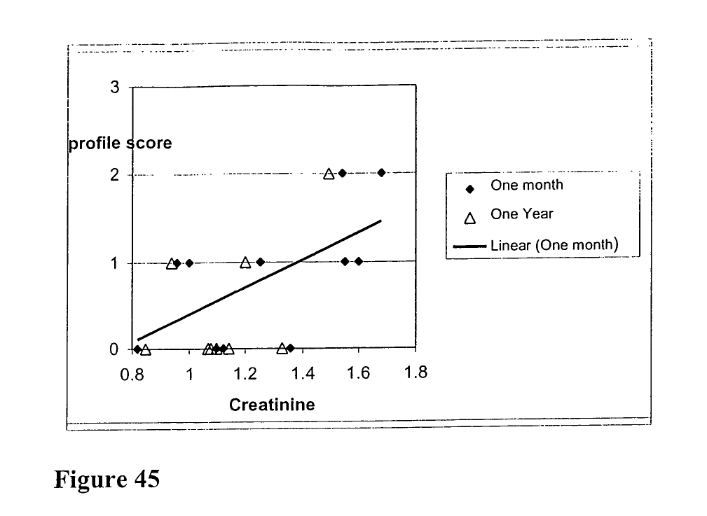

Profile analysis from the successful transplant individuals from Table 5 is presented in FIG. 45 as a function of serum creatinine levels. Creatinine is the classic measurement made to detect kidney function. A problem with use of creatinine is that each individual has their own personal level of creatinine that correlates with optimum personal health. While the average level for healthy individuals is 1.0 or lower, some persons may have healthy values that are substantially greater than this while others may be unhealthy at lower values. A clear trend existed between elevated creatinine and protein profile analysis (FIG. 45). Creatinine values of >1.4 were always accompanied by altered profiles. For some, even lower values signaled a problem detected by the profile. FIG. 45 also shows that diagnosis on the basis of creatinine alone is much less effective since selection of a creatinine level with very high sensitivity for disease detection will include a large number of individuals who are not in distress as indicated by protein profile. Thus, protein profile analysis corroborated creatinine as an effective biomarker but is much more sensitive and provides a better approach to detecting those in need of therapy or other change to improve their kidney health.

TABLE 5
Summary of diagnosis for various samples related to kidney disease.

| | Disease | | | | | |
|---|---|---|---|---|---|---|
| | Native | | | | | |
| | kidney disease | | Acute rejection | | Chronic rejection | |
| | Diagnosis | | | | | |
| | Detected | ND | Detected | ND | Detected | ND |
| Score*: | ssssssssss | | sssssssmmm | 1 | sssssssssss | |
| Severe (s) | ssssssssss | | | | | |
| or | ssssssssmm | | | | | |
| moderate | mmm | | | | | |
| (m) | | | | | | |
| totals | 33 | 0 | 10 | 1 | 11 | 0 |

| | Disease | | | | | |
|---|---|---|---|---|---|---|
| | Other kidney | | Something wrong | | Healthy transplant | |
| | disease | | but no diagnosis | | (m is any abnormality) | |
| Score* | sssm | 1 | sssmm | 4 | mmmmm | 10 |
| | | | | | mmmsss | |
| Totals | 4 | 1 | 5 | 4 | 11 | 10 |
| *The score represents a categorization of no detected problem (ND), a mild problem (m) and a severe problem (s). Category placement was generally very easy to make. “No detected problem” were profiles that fit the healthy individuals shown in FIG. 42 where the dominant peaks above 8000 occurred at m/z = 9742 and 9073. Other peaks were much | | | | | | |
| # lower than the 9742 component. A severe problem, indicated by a score of “s,” was generally defined by parameters for severe or advanced kidney disease described in Table 4. Persons with a score of “s” tended to have almost no detectable component at m/z = 9742 +/− 0.1%, defined as less than 0.05 times the intensity of the most abundant ion | | | | | | |
| # of m/z >3000, and further to have intense peaks representing severe or advanced disease at m/z values given in column 2 of Table 4 or listed in the text. A mild problem, indicated by a score of “m,” is given to a profile pattern that retains significant intensity of the peak at m/z = 9742 +/− 0.1% that is generally greater than 0.05 times the most | | | | | | |
| # intense ion in the profile above m/z = 3000. Peak intensities tend to increase at low mass so that the higher the m/z value, the lower the peak intensity needed to designate a biomarker. As an approximation, profiles scored “m” generally lack the peaks listed in Column 2 of Table 4 that are described in rows for advanced or severe kidney disease or | | | | | | |
| # they will display these peaks at less than 0.2 times the intensity of the peak at 4302 +/− 0.1% for peaks in the m/z range of 3000 to 5000. In the m/z range of 5000 to 8000, peak intensities are generally less than 5 times the intensity of the m/z = 9742 peak. In the m/z range of 8000-10000 the biomarker peak intensities are generally more than >0.3 times | | | | | | |
| # the intensity of the peak at m/z = 9742 +/− 0.1%. In the mass range of >10,000, a biomarker peak characteristic of a score of m may occur at greater than 0.2 times the intensity of the peak at 9742 +/− 0.1%. If desired, the score can be expanded greatly to define many more than two stages of disease. | | | | | | |

The ability to use protein profiles to diagnose early stages of native kidney disease is apparent from the studies outlined here. Detection of advanced kidney disease is accompanied by radical changes in profiles that allow detection of virtually hundreds of intermediate stages of disease levels. The biomarker peaks for advanced disease will appear long before clinical diagnosis of a problem. Analysis of urine presents an easily accessed source that can be analyzed on frequent occasion to detect disease.

It is also apparent that this method can be expanded to analysis of other problems of the urinary tract, including urinary tract infections, kidney cancer, bladder cancer and prostate cancer. These conditions may result in release of specific peptides into the urinary tract that will be detected by profile analysis. For prostate cancer, it would be optimal to collect the initial urine rather than mid-stream collection as is standard practice. Initial urine should collect any materials accumulating in the urinary tract from adjacent organs and tissues.

Determination of the absolute concentration of a component in urine, described above by use of raw signal intensity in the MALDI-TOF, is best accomplished by comparison to an internal standard. This can be accomplished by adding a known amount of a heavy atom derivative of a protein containing deuterium or carbon-13 to the sample. The heavy atoms can be incorporated into a synthetic peptide by standard methods described elsewhere in this document. An internal standard can also include a structural analog of the protein to be quantified. The analog should differ in a small way that alters the mass of the peptide but does not affect the manner in which it crystallizes in the matrix used for ionization or the manner in which the compound ionizes in the mass spectrometer. Absolute concentrations of a protein in the sample can then be obtained by comparison of peak intensity or peak area ratios of the spiked material to the peptide of the sample. An alternative approach to generation of a heavy atom derivative consists of deuterium labeling of a standard sample by incubation in D2O as described herein for proteins of plasma and bronchoalveolar lavage fluid (BALF). The proteins take up deuterium at amide positions that exchange at rates that allow one to perform MALDI-TOF profile analysis and distinguish the deuterium-labeled, spiked proteins from those of the sample. This approach is attractive since it can be applied to components of the profile that are unknown. That is, it can allow calculation of the concentration of a component in many different samples relative to the concentration in the same standard. In this way, relative concentration levels of peptides can be determined in many samples and compared in a way that allows one to create a diagnostic assay without ever knowing the identity of a component.

The chemical structure of the component of each peak can be identified by methods outlined elsewhere in this document. That information can be used to create alternative quantitative assays for these components. Methods of quantification can include mass spectrometry techniques, using the spiking method with structural analogs of the compound, stable isotope derivatives with carbon-13 or deuterium in non-exchangeable locations or by deuterium labeling of the purified protein or of a standard sample at amide residues as described above. An attractive approach would be to deuterium-label the baseline sample of an individual and use that sample to mix with later samples from the same individual. In that way, the greatest sensitivity for change would be achieved. Loss of some peaks and enhancement of others would allow one to determine that change has occurred and to use the information in a diagnosis.

Use of urine protein profiles to detect kidney and urinary tract health, as described herein, could rapidly replace expensive and risky biopsy methods and allow much more frequent analysis to detect kidney disease at an earlier state. Moreover, identification of the proteins or peptides that are represented by the diagnostic and prognostic m/z peaks that appear in these profiles, using methods described herein and known to the art, will make it possible to generate assays of other types such as an ELISA that will quantify the 9742 and 9073 components as well as others. Heavy atom derivatives of these proteins could also be made to spike the sample and generate internal standards for quantification of the proteins in the profile. These will permit detection the absolute level of protein in the sample.

As described for plasma elsewhere in this document, it is possible to avoid the ZipTip extraction and analyze the unfractionated urine. This approach requires concentration of the urine proteins by any appropriate method such as a spin cartridge with membrane to retain the proteins. In one example, approximately 30-fold concentration of a sample was easily achieved. The sample was dialyzed against 5 millimolar ammonium bicarbonate to remove urine salts, 0.75 microlites of the concentrated solution was mixed with 0.75 microliters of 85% saturated sinapinic acid in water (50):acetonitrile(50):TFA(0.1), the solution was mixed with the pipette tip with abrasion of the target surface. After drying, the sample was subjected to MALDI-TOF analysis as described elsewhere. Protein patterns and peaks corresponding to those observed following ZipTip extraction were apparent.

### Example XVII

### Animal Models that Express ApoC1protein that is Characteristics of the Protein Found in LDL Species

Obesity and its many related disease states such as hyperlipidemia, atherosclerosis, diabetes, hypertension, etc. are characteristic of species referred to as low-density lipoprotein (LDL) species. These species, including humans, are characterized by high levels of LDL in the circulation. LDL is used as a general term for several classes of related lipoproteins including chylomicrons, VLDL, IDL and partially degraded lipoprotein particles. Many other species, including common laboratory animals such as the rat and mouse, are high HDL animals. They have very little circulating LDL and instead of very high levels of HDL. These species have the characteristic of humans with high HDL and do not develop the diseases associated with some members of high LDL species. In order to create a mouse model of LDL disease states, it is often necessary to make many genetic manipulations of the animal. It is questionable whether these changes produce a model that is closely related to the human high LDL status. Thus, it would be a boon to laboratory research to develop a simple approach to conversion of a mouse or rat to a high LDL species. Several important new pieces of information allow the design of a major contributor to this conversion. That is, it is known that mice into which human Apolipoprotein C1 has been incorporated develop hyperlipidemia (Berbee et al., (2005) J Lipid Res 46, 297-306; Muurling et al., (2004) J Lipid Res 45, 9-16). This shows the crucial role of ApoC1 in converting a high HDL species to a high LDL species. However, it would be better if this conversion occurred by manipulation of the ApoC1 protein of the mouse. One approach to instituting the change toward similarity is illustrated in example XIII where changes in the amino terminal of ApoC1 can convert the characteristics of mouse ApoC1 to human ApoC1 by changes in the protease cleavage site.

Study of the T45S variant of ApoC1 that was discovered in New World populations has now shown the importance of the C-terminal region of the protein (attached manuscript). Table 3 below shows the C-terminal sequences of apolipoproteins of high LDL species (human and Baboon) and high HDL species. The major difference consists of addition of two hydrophobic residues in the -2 and -3 positions from the C-terminal of the high HDL species. Structural analysis shows that the residues in bold in the high LDL species are involved in an alpha helix that produces one side with hydrophobic residues that face the lipid of lipoprotein structure(Rozek et al., (1995) Biochemistry 34, 7401-8). The additional hydrophobic residues of ApoC1 are positioned to allow one more turn of the alpha helix that will place these hydrophobic residues on the lipid-binding face of the alpha helix. This will create a much tighter association of ApoC1 of high HDL species with lipid. We have also found (FIG. 4B of the attached manuscript) that the S45 variant of human ApoC1 shows selective binding to LDL over HDL. This shows that proteins with lowered affinity for lipid are increasingly displacement to LDL. Once on the LDL, it is known that ApoC1 inhibits uptake by VLDL receptors, thereby increasing the level of LDL in the circulation (Weisgraber et al., (1990) J. Biol. Chem 265, 22453-22459; Liu et al., (1993) Biochim Biophys Acta 1168, 144-52). Comparison of the structures in Table 3 shows that the incorporation of S45 into human ApoC1 has the effect of increasing the difference between the hydrophobic interaction of ApoC1 of high HDL animals with that of high LDL species such as the human. In effect, humans with the S45 variant of ApoC1 might be described as in a ‘super LDL’ condition. This may enhance both the advantages and disadvantages experienced by high LDL animals.

Together, these properties show that one approach to convert a high HDL animal model to a high LDL model will be to substitute the C-terminal region of mouse, rat or other high HDL species with the structure found in human or other high LDL species. This can be accomplished by removal of the C-terminal 4 residues of, for example, Dog, mouse, rat or tree shrew ApoC1 and replacing them with three residues such as those of human or baboon ApoC1. A number of other changes can be used as well, as long as the outcome is to abolish the hydrophobic residues at -2 and -3 of high HDL species. This will lower affinity for lipid surfaces and increase binding specificity of the ApoC1 protein for LDL. The increase of ApoC1 bound to LDL will inhibit its uptake from the bloodstream (4, 5) and contribute to a higher blood level of LDL.

To create an experimental animal model the approach would be to remove or inactivate the gene for the animal's own ApoC1 protein and substitute a gene coding for the amino acids selected to create the appropriate ApoC1 protein. This can be done by known transgenic animal technologies.

TABLE 3
C-terminal sequence homology of ApoC1 from different species (from
Swiss-Prot Data Bank, http://us.expasy.org/sprot). Hydrophobic residues
that interface with the lipid are in bold. Primary Accession numbers
are: human P02654, baboon P34929, mouse P34928, rat P19939,
dog P56595, tree shrew Q9XSN5. Position 45, the site of mutation
in human ApoC1 is labeled. This site corresponds in homology
alignment to position 49 of Dog, Mouse, Rat and Tree Shrew ApoC1.
45*

ELSAKMREWFSESFQKVKEKLKIDS Human S45
ELSAKMREWFSETFQKVKEKLKIDS Human
EFPAKTRDWFSETFRKVKEKLKINS Baboon
DIPAKTRNWFSEAFKKVKEHLKTAFS Dog
EILTKTRAWFSEAFGKVKEKLKTTFS Mouse
EIMIKTRNWFSETLNKMKEKLKTTFA Rat
DLPAKTRNWFTETFGKVRDTFKATFS Tree shrew
*Position 49 in dog, mouse, rat and tree shrew.

### Example XVIII

### Profiles of Human Saliva

Saliva represents a readily accessible fluid that can be evaluated for protein content by profile analysis to detect a variety of disease states of the oral cavity, throat, lungs or bronchial passages or disease states that alter protein content of the saliva remotely or by altering health status of that individual in a manner that impacts on saliva proteins. Oral mucosa and therefore proteins of the oral cavity can be a window into many systemic disorders and skin diseases. A summary of disease states that may influence the tongue or oral mucosa can be found on the worldwide web at, for example, http://thedoctorsdoctor.com/bodysites/mouth_and_throat.htm, or in appropriate medical texts or journals. The reference cited provides a general idea of conditions of the oral cavity or wide-spread systemic diseases that might be diagnosed by the content of salivary proteins.

Profile analysis of saliva was performed on 4 healthy individuals on three occasions each. Every assay was repeated three times. Sample size can be 0.1 mL of saliva acidified to pH<3.0 with 10% TFA and extracted with a C4 ZipTip, eluted and applied to the MALDI target as described for plasma and other fluids elsewhere in this document. However, ZipTip extraction of 2 microliters of saliva that had been diluted with 30 microliters of reconstitution solution (water:Acetonitrile:TFA, 95:5:0.1) gave equal signal intensity. The latter sample size was used to compare replicate analysis of the same sample, replicate analysis of sequential samples from the same individual and to compare the sum of sequential samples from one individual to that of another individual. Sinapinic acid was used as the matrix in the usual manner. One thousand laser shots in the MALDI-TOF mass spectrometer were accumulated as before.

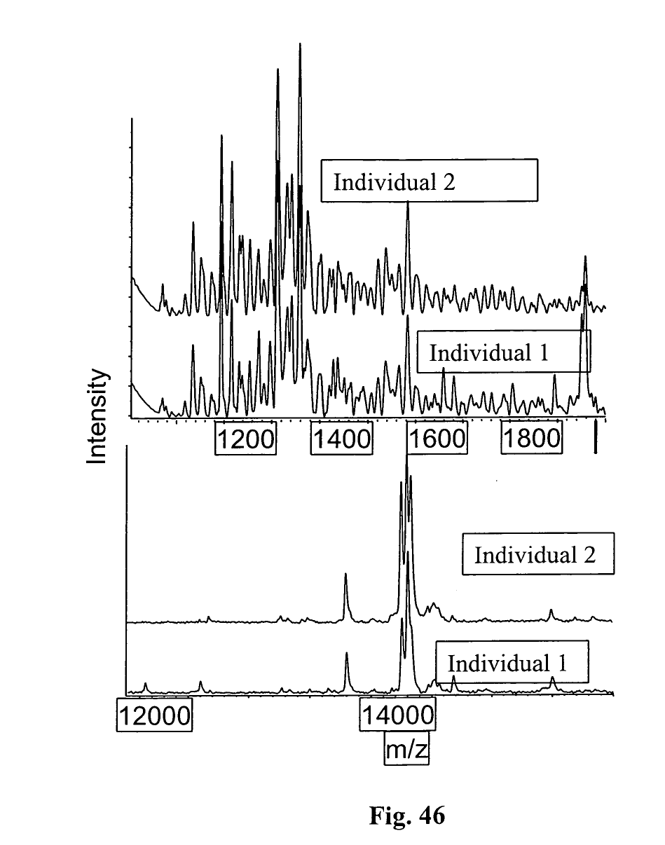

FIG. 46 shows comparison of two individuals over two portions of their profiles. While a common perception may be that saliva is a discard fluid that contains molecules to be eliminated from the body and therefore represents a relatively unorganized fluid, protein profile analysis illustrated in FIG. 46 revealed saliva to be highly consistent among different healthy individuals. It was also highly consistent in the same individual from time to time. Although some differences in intensity ratios of different peaks were observed in different individuals and within the same individual at different times, the major characteristic was the consistency of the peaks and relative intensities. This consistency lends itself to detection of disease states that might influence any aspect of protein levels in the saliva.

It is apparent that a large number of components were detected. It is also apparent that the two individuals had very similar components. MS/MS analysis revealed that several of the lower mass components were various forms of proline-rich anti-microbial peptides. The identity of the individual peptide components is not necessarily important to the potential to use the profile to identify abnormal components or profile patterns that might be linked to disease or health status.

The profile of one healthy individual was assessed for significant components. At a relatively high intensity cutoff, 178 different components were found with the following m/z ratios: 15852±0.1%, 15708±0.1%, 15512±0.1%, 14532±0.1%, 14342±0.1%, 14309±0.1%, 14263±0. 1%, 14177±0.1%, 14073±0.1%, 13810±0.1%, 13512±0.1%, 13341±0.1%, 11583±0.1%, 11161±0.1%, 11004±0.1%, 10831±0.1%, 10758±0.1%, 10611±0.1%, 9796±0.1%, 9526±0.1%, 8357±0.1%, 7757±0.1%, 7607±0.1%, 7265±0.1%, 7171±0.1%, 7155±0.1%, 7131±0.1%, 6906±0.1%, 6059±0.1%, 6017±0.1%, 5999±0.1%, 5970±0.1%, 5831±0.1%, 5814±0.1%, 5793±0.1%, 5775±0.1%, 5696±0.1%, 5604±0.1%, 5586±0.1%, 5502±0.1%, 5458±0.1%, 5439±0.1%, 5419±0.1%, 5401±0.1%, 5380±0.1%, 5301±0.1%, 5267±0.1%, 5255±0.1%, 5233±0.1%, 5215±0.1%, 5177±0.1%, 5132±0.1%, 5118±0.1%, 5100±0.1%, 5083±0.1%, 5061±0.1%, 5017±0.1%, 4966±0.1%, 4930±0.1%, 4898±0.1%, 4841±0.1%, 4755±0.1%,4705±0.1%,4610±0.1%,4573±0.1%,4549±0.1%, 4436±0.1%, 4391±0.1%,4371±0.1%, 4353±0.1%, 4190±0.1%,4148±0.1%, 4128±0.1%,4069±0.1%,4032±0.1%,4000±0.1%,3971±0.1%,3899±0.1%, 3878±0.1%,3823±0.1%,3800±0.1%,3722±0.1%,3666±0.1%, 3644±0.1%,3587±0.1%,3545±0.1%,3521±0.1%,3497±0.1%,3441±0.1%, 3395±0.1%,3370±0.1%,3350±0.1%,3312±0.1%,3274±0.1%, 3251±0.1%, 3220±0.1%, 3204±0.1%, 3140±0.2%, 3101±0.2%, 3028±0.2%, 3005±0.2%, 2968±0.2%, 2945±0.2%, 2895±0.2%, 2813±0.2%, 2790±0.2%, 2756±0.2%, 2733±0.2%, 2719±0.2%, 2688±0.2%, 2665±0.2%, 2615±0.2%, 2605±0.2%, 2579±0.2%, 2539±0.2%, 2528±0.2%, 2496±0.2%, 2482±0.2%, 2446±0.2%, 2416±0.2%, 2367±0.2%, 2337±0.2%, 2311±0.2%, 2255±0.2%, 2220±0.2%, 2164±0.2%, 2116±0.2%, 2088±0.2%, 2074±0.2%, 2026±0.2%, 2009±0.2%, 1992±0.2%, 1975±0.2%,1961±0.2%,1953±0.2%, 1945±0.2%,1928±0.2%,1897±0.2%, 1870±0.2%,1847±0.2%,1828±0.2%,1809±0.2%,1790±0.2%,1764±0.2%,1748±0.2%,1719±0.2%,1704±0.2%,1685±0.2%,1662±0.2%, 1644±0.2%,1627±0.2%,1603±0.2%,1586±0.2%,1568±0.2%,1540±0.2%,1523±0.2%,1509±0.2%,1494±0.2%,1466±0.2%,1440±0.2%, 1431±0.2%,1423±0.2%,1402±0.2%,1378±0.2%, 1361±0.2%,1344±0.2%,1333±0.2%,1314±0.2%,1300±0.2%,1286±0.2%,1276±0.2%, 1257±0.2%,1235±0.2%,1218±0.2%,1196±0.2%,1177±0.2%,1153±0.2%,1137±0.2%.

Changes in these components or the ratios of these components can be determined over time for healthy individuals to set the limits for natural variation. Observation of abnormal variation or of new components linked to disease can be used for diagnosis of health status related to the oral cavity or used to assess changes in overall health condition that influences proteins of the saliva. Following profiles of an individual over time can also be used to detect changes in health status, reaction to a drug therapy or other reaction to external stimulus. Saliva can also be a surrogate biomarker to detect general health status and such events as response to radiation treatment or chemotherapy. Oral diseases such as cancer may be detected by profile analysis due to appearance of new components or changes in common components.

### Example XIX

### Oxidized Proteins in Hepatitis C

The diagnostic capability of profile analysis by protein oxidation was illustrated by samples from persons with active hepatitis C disease. These individuals had reached the stage where treatment was begun. Hepatitis C is often characterized by initial disease followed by apparent recovery while the disease is dormant. Two individuals examined during this stage of disease did not show unusual features of their plasma profiles. In many individuals over time, a chronic level of disease appears with the liver damage and other symptoms of hepatitis C. This is the stage where major intervention begins. The following example illustrates that protein profiles are sensitive to events in persons with hepatitis and that biological profile analysis offers a method to diagnose adverse events at an earlier time than current practice and to monitor success of therapy.

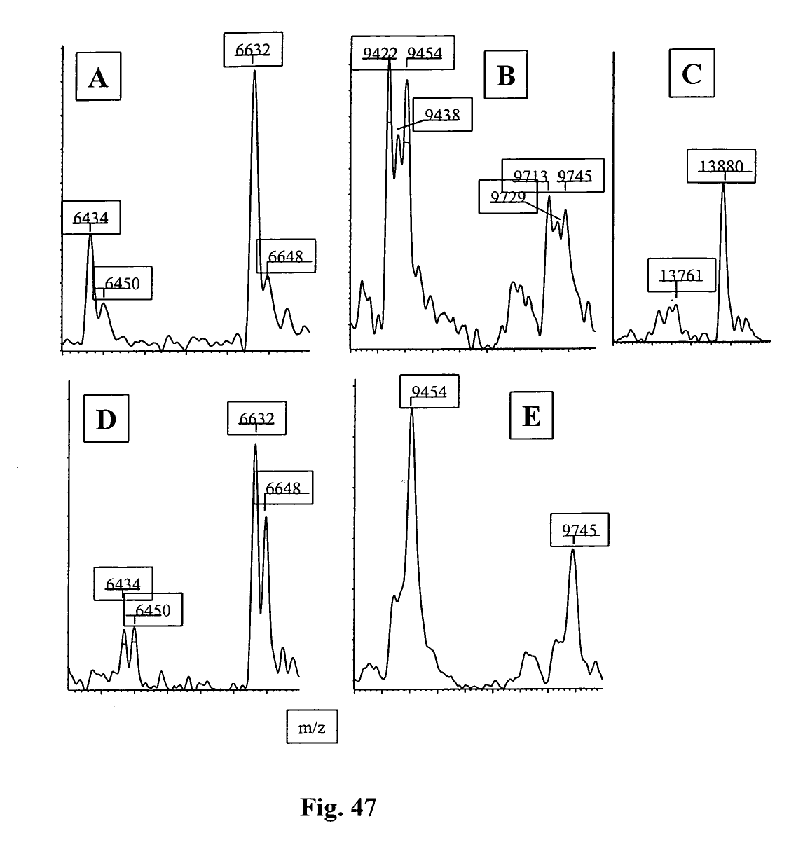

Sequential samples were analyzed from 5 individuals over a 72 week period of treatment with interferon. Samples were also analyzed from another 43 who were followed for 5 to 48 weeks. At the outset of the treatment, all individuals showed extremely oxidized plasma proteins. For example, the ratio of TTr (m/z=13761) to TTr-Cys (m/z=13880) peak intensities was always less than 0.5 (FIG. 47C) and was often much lower. This is very unusual since healthy adults typically give ratios in the range of 1.5 to 5. A second indication of oxidation in the plasma was observed by the appearance of oxidized forms of apolipoprotein CIII. The unoxidized form of ApoCIII-I appears at m/z=9422. The two oxidized forms appear at m/z=9438 and 9454 (all values are ±0.1%). The oxidized forms are not detected in plasma of healthy persons. The lowest level of oxidation observed among the hepatitis C individuals was peak intensity ratios of approximately 1:1:1 for the normal and two oxidized forms of this protein (FIG. 47B). For more extreme states, the fully oxidized state at m/z=9454 was the only form detected in the profile (FIG. 47E). Analogous oxidation states were observed for the Apolipoprotein CIII2 form that appears at m/z=9713 (FIG. 47). Similar levels of oxidation also occurred for ApoCII. The unoxidized form of ApoCII occurs at m/z=8915 while two oxidized forms appear at m/z=8931 and 8947 (FIG. 48). Apolipoprotein CI was most resistant to oxidation. The unoxidized protein (m/z=6632) was almost always the more abundant (FIG. 47A) and a singly oxidized species appeared at m/z=6648 (FIG. 47A). Apolipoprotein C1 contains a single methionine while Apolipoprotein CII and CIII both have two. Thus, oxidation occurred on methionine residues and included up to quantitative oxidation of these residues in apolipoprotein CII and CIII. Apolipoprotein C1 was least subject to oxidation. For example, approximately 15% oxidation of apolipoprotein C1 occurred in samples with nearly 100% oxidation of apolipoprotein CIII. Differential susceptibility of oxidation in the different proteins offered the ability to continuously evaluate oxidation in the plasma over a wide range. Mildest oxidation was detected by decline of TTr with corresponding increase of TTr-Cys. Intermediate oxidation was detected by the distribution of oxidized forms of ApoCIII and ApoCII and the most severe oxidation was evaluated by oxidation of ApoC1.

Therapy with interferon often resulted in more extensive oxidation immediately after application. However, at 72 weeks, three of 5 treated individuals showed lower oxidation than they did at the start of treatment. In one case, an individual with modest oxidation at the start of therapy (only about 15% oxidation of ApoCI and approximately equal intensity of the unoxidized and oxidized forms of ApoCIII) showed almost complete remediation of oxidized ApoCIII to its unoxidized state (m/z=9422) at week 72. This contrasted with another individual who began with extreme oxidation (apoCI: oxidized apoC1 peak intensity ratio of approximately 1.0 and complete oxidation of ApoCIII). This person showed correction at 72 weeks to an intermediate state that was approximately equal to the initial state described for the first of these two individuals. It appeared that improvement toward normal was approximately equal in these cases so that an individual with more severe oxidation at early time did not approach the normal state as well as the individual with lower oxidation at start of therapy. Consequently, early therapeutic intervention should be advantageous. However, neither individual showed recovery of the TTr:TTr-Cys ratio, the most sensitive measure of oxidative problems.

Overall, these results indicated that current clinical approaches to detect deterioration of persons with hepatitis C results in treatment only when severe oxidation problems have started. Early treatment along with a method capable of monitoring levels of protein oxidation would be advantageous. Profile analysis provided a highly sensitive method to monitor both early and late stages of oxidation in hepatitis C patients. The results indicated that early treatment may return individuals to more robust health. However, once the condition has advanced to the stage currently used for therapy, it appeared that none of the therapies were able to eliminate oxidative damage altogether. Oxidative stress may be the leading cause of eventual liver failure and the other pleotropic problems experienced by hepatitis C patients. Thus, early and continuous monitoring of oxidized proteins in the blood by profile analysis may constitute an important approach to evaluate hepatitis C patients in order to time therapy at a more advantageous stage and to monitor an individual's response to therapy.

Other important biomarkers of hepatitis C include an increase in the components at m/z=8696±0.1% and 8825±0.1%. These are normally undetectable (intensity relative to apoCIII1=<0.1) in healthy individuals. However, both increase greatly in persons with chronic hepatitis C (FIG. 48). The intensity of the 8825 peak can exceed the intensity of ApoCII or its oxidized forms, or ApoCIII or its oxidized forms. Monitoring ratios of these components to other peaks of the profile or oxidized to reduced forms of these proteins provide additional methods for monitoring severity of protein oxidation in the blood. Thus, either an increase of the ratio of m/z=8825 or 8696 components to other components of the profile such as ApoCI, ApoCIII or ApoCII can be used as a diagnostic tool to monitor disease state in chronic hepatitis C, to detect times when therapy should be started as well as the response to therapy. FIG. 48 also shows ApoCII (m/z=8915) along with its oxidized forms (m/z=8931 and 8947) in various stages of hepatitis C disease.

In the case of hepatitis C, oxidation of proteins occurred without concomitant appearance of the marker at m/z=4150. It is likely that other chronic conditions such as those resulting from the AIDS virus or other chronic virus infections can be evaluated by evaluating oxidized plasma protein profiles as well. The combination of pathological markers in the plasma can offer information regarding the type of disease and its stage of advance.

The complete disclosures of all patents, patent applications including provisional patent applications, publications, and electronically available material (e.g., GenBank amino acid and nucleotide sequence submissions) cited herein are incorporated by reference. The foregoing detailed description and examples have been provided for clarity of understanding only. No unnecessary limitations are to be understood therefrom. The invention is not limited to the exact details shown and described; many variations will be apparent to one skilled in the art and are intended to be included within the invention defined by the claims.

What is claimed is:

1. A method for analyzing a biological sample obtained from a subject, the method comprising:
providing an biological sample comprising a fluid selected from the group consisting of plasma, fractionated plasma, serum, fractionated serum and urine;
subjecting the sample to mass spectrometry to yield a plurality of mass spectrometry peaks;
analyzing at least one mass spectrometry peak that is indicative of the health or fitness of the subject, wherein the mass spectrometry peak is selected
(a) from the group consisting of mass spectrometry peaks from a plasma or serum sample having an m/z value of 4152±0.1%; 4184±0.1%; 6420±0.1%; 6434±0.1%; 6450±0.1%; 6618±0.1%; 6632±0.1%; 6648±0.1%; 8765±0.1%; 8810±0.1%; 8825±0.1%; 8915±0.1%; 8931±0.1%; 8947±9; 9352±0.1%; 9422±0.1%; 9438±0.1%; 9454±0.1%; 9642±0.1%; 9713±0.1%; 9729±0.1%; 9745±0.1%; 11524±0.1%; 11681±0.1%; 13761±0.1%; 13840±0.1%; and 13880±0.1%; or
(b) from a group consisting of mass spectrometry peaks from a urine sample having an m/z value of 2187±0.1%, 2431±0.1%, 2715±0.1%, 2750±0.1%, 2844±0.1%, 2882±0.1%, 2786±0.1%, 3000±0.1%, 3272±0.1%, 3370±0.1%, 3441±0.1%, 3485±0.1%, 3495±0.1%, 3525±0.1%, 3787±0.1%, 3900±0.1%,3982±0.1%,4132±0.1%,4180±0.1%,4224±0.1%,4253±0.1%, 4271±0.1%, 4300±0.1%, 4338±0.1%, 4352±0.1%, 4375±0.1%, 4511±0.1%, 4565±0.1%, 4637±0.1%, 4675±0.1%, 4750±0.1%, 4840±0.1%, 4859±0.1%, 4988±0.1%, 5006±0.1%, 5070±0.1%, 5170±0.1%, 5321±0.1%, 5419±0.1%, 5556±0.1%, 5704±0.1%, 5764±0.1%, 5865±0.1%, 6343±0.1%, 6353±0.1%, 6431±0.1%, 6489±0.1%, 6590±0.1%, 6632±0.1%, 6643±0.1%, 6676±0.1%, 6733±0.1%, 6750±0.1%, 6766±0.1%, 6868±0.1%, 6937±0.1%, 7007±0.1%, 7154±0.1%, 7319±0.1%, 7421±0.1%, 7510±0.1%, 7560±0.1%, 7919±0.1%, 7937±0.1%, 8566±0.1%, 8846±0.1%, 8915±0.1%, 9070±0.1%, 9096±0.1%, 9394±0.1%, 9422±0.1%, 9480±0.1%, 9713±0.1%, 9742±0.1%, 10350±0.1%, 10649±0.1%, 10780±0.1%, 10840±0.1%, 10880±0.1%, 11035±0.1%,11183±0.1%, 11310±0.1%, 11323±0.1%, 11368±0.1%, 11732±0.1%,12262±0.1%, 12684±0.1%, 12690±0.1%, 13350±0.1%, 13760±0.1%, 13380±0.1%, 15012±0.1%, 15835±0.1%, and 20950±0.1%; and
diagnosing, evaluating or monitoring the presence, absence or status of a metabolic or disease state selected from the group consisting of diabetes, pre-diabetes, insulin resistance, metabolic fitness level, allergy, autoimmune disorder, inflammatory response, urinary tract disease or dysfunction, kidney transplant rejection, kidney disease or damage, and hepatitis C;
with the proviso that (i) a biological sample that is used for analyzing a peak having an m/z value of 6434±0.1%; 6632±0.1%; 9422±0.1%; or 9713±0.1% for the disease state of hyperlipidemia is a biological sample that comprises unprocessed plasma, fractionated plasma, serum or fractionated serum; and (ii) a biological sample that is used for analyzing a peak having an m/z value of 13840±0.1% for kidney disease is a biological sample that comprises unprocessed plasma, fractionated plasma, serum or fractionated serum.

2. The method of claim 1 wherein the method of mass spectrometry is matrix assisted laser desorption ionization mass spectrometry.

3. The method of claim 1 wherein analyzing at least one mass spectrometry peak comprises:
(i) comparing a measurable attribute of a first peak from a plasma or serum sample or a urine sample as recited in claim 1, with the measurable attribute of a second peak from the plasma or serum sample or urine sample; or (ii) comparing a measurable attribute of a first peak from a plasma or serum sample or a urine sample as recited in claim 1, with the measurable attribute of an analogous peak obtained for the subject at a different time.

4. The method of claim 3 wherein the measurable attribute comprises peak height or area defined by the peak.

5. The method of claim 3 wherein comparing the peak attributes comprises determining a ratio of the peak attributes.

6. The method of claim 3 wherein the first and second peaks are analyzed prior to the administration of a therapeutic agent to the subject, and the analogous peaks are analyzed subsequent to the administration of a therapeutic agent to the subject, and wherein the comparison is useful for monitoring the treatment of the metabolic or disease state.

7. The method of claim 3 wherein the first and second peaks are analyzed prior to the administration of a therapeutic agent to the subject, and the analogous peaks are analyzed subsequent to the administration of a therapeutic agent to assess toxicity of the therapeutic agent.

8. The method of claim 3 wherein the biological sample comprises urine, and wherein the first peak has an m/z value of 9742±0.1% or 9073±0.1%.

9. The method of claim 5 wherein the biological sample comprises plasma, fractionated plasma, serum or fractionated serum, and wherein the ratio of peak attributes is selected from the group consisting of peak ratios having m/z values of 4152/6632, 6632/6434, 9422/9713, 9422/6434, 13671/13880, 13840/13880, 8931/8915, 8925/8915, 9438/9422, 9454/9422, 9729/9713; 9745/9713, 8825/(sum of 9422+9438+9454), 8825/8810, 6648/6632 and 6450/6434; and the inverses of said peak ratios.

10. The method of claim 1 wherein the biological sample is unprocessed.

11. The method of claim 1 wherein the biological sample comprises plasma, fractionated plasma, serum or fractionated serum, the method further comprising diluting the sample prior to subjecting the sample to mass spectrometry.

12. The method of claim 11 further comprising rapidly preprocessing the sample prior to subjecting the sample to mass spectrometry.

13. The method of claim 12 wherein rapidly preprocessing the sample comprises subjecting the sample to a chromatographic process selected from the group consisting of ion exchange chromatography, affinity chromatography, hydrophobic chromatography, hydrophilic chromatography and reverse phase chromatography.

14. The method of claim 12 wherein the chromatographic preprocessing comprises reverse phase chromatography carried out in a pipette tip.

15. The method of claim 1 wherein the biological sample comprises urine, the method further comprising concentrating the sample prior to subjecting the sample to mass spectrometry.

16. The method of claim 1 further comprising rapidly preprocessing the sample prior to subjecting the sample to mass spectrometry.

17. The method of claim 16 wherein rapidly preprocessing the sample comprises subjecting the sample to a chromatographic process selected from the group consisting of ion exchange chromatography, affinity chromatography, hydrophobic chromatography, hydrophilic chromatography and reverse phase chromatography.

18. The method of claim 16 wherein the chromatographic preprocessing comprises reverse phase chromatography carried out in a pipette tip.

19. An analytical device comprising:
a mass spectrometer preprogrammed with instructions for measuring an attribute of at least one peak having an m/z value selected from the group consisting of peaks from a plasma or serum sample having an m/z value of 4152±0.1%; 4184±0.1%; 6420±0.1%; 6434±0.1%; 6450±0.1%; 6618±0.1%; 6632±0.1%; 6648±0.1%; 8765±0.1%; 8810±0.1%; 8825±0.1%; 8915±0.1%; 8931±0.1%; 8947±9; 9352±0.1%; 9422±0.1%; 9440±0.1%; 9454±0.1%; 9642±0.1%; 9713±0.1%; 9729±0.1%; 9745±0.1%; 11524±0.1%; 11681±0.1%; 13761±0.1%; 13840±0.1%; and 13880±0.1%; or from a group consisting of peaks from a urine sample having an m/z value of 2187±0.1%, 2431±0.1%, 2715±0.1%, 2750±0.1%, 2844±0.1%, 2882±0.1%, 2786±0.1%, 3000±0.1%, 3272±0.1%, 3370±0.1%, 3441±0.1%, 3485±0.1%, 3495±0.1%, 3525±0.1%, 3787±0.1%, 3900±0.1%, 3982±0.1%, 4132±0.1%, 4180±0.1%, 4224±0.1%, 4253±0.1%, 4271±0.1%, 4300±0.1%, 4338±0.1%, 4352±0.1%, 4375±0.1%, 4511±0.1%, 4565±0.1%, 4637±0.1%, 4675±0.1%, 4750±0.1%, 4840±0.1%, 4859±0.1%, 4988±0.1%, 5006±0.1%, 5070±0.1%, 5170±0.1%, 5321±0.1%, 5419±0.1%, 5556±0.1%, 5704±0.1%, 5764±0.1%, 5865±0.1%, 6343±0.1%, 6353±0.1%, 6431±0.1%, 6489±0.1%, 6590±0.1%, 6632±0.1%, 6643±0.1%, 6676±0.1%, 6733±0.1%, 6750±0.1%, 6766±0.1%, 6868±0.1%, 6937±0.1%, 7007±0.1%, 7154±0.1%, 7319±0.1%, 7421±0.1%, 7510±0.1%, 7560±0.1%, 7919±0.1%, 7937±0.1%, 8566±0.1%, 8846±0.1%, 8915±0.1%, 9070±0.1%, 9096±0.1%, 9394±0.1%, 9422±0.1%, 9480±0.1%, 9713±0.1%, 9742±0.1%, 10350±0.1%, 10649±0.1%, 10780±0.1%, 10840±0.1%, 10880±0.1%, 11035±0.1%, 11183±0.1%, 11310±0.1%, 11323±0.1%, 11368±0.1%, 11732±0.1%, 12262±0.1%, 12684±0.1%, 12690±0.1%, 13350±0.1%, 13760±0.1%, 13380±0.1%, 15012±0.1%, 15835±0.1%, and 20950±0.1%.

20. A method for assessing the health or disease status of a subject, or the susceptibility of a subject to developing a disease, comprising determining whether the subject has an apolipoprotein C1 variant having a T45S amino acid substitution, or a DNA sequence encoding said variant.


SEQUENCE LISTING (19 sequences)

SEQ ID NO: 1 - protein, 34 aa, homo sapiens
TLLVFEVQQPFLFVLWDQQHKFPVFMGRVYDPRA

SEQ ID NO: 2 - DNA, 101 bp, homo sapiens
ccctgctggtctttgaagtgcagcagcccttcctcttcgtgctctgggaccagcagcacaagttccctgtcttcatggggcgagtatatgaccccagggcc

SEQ ID NO: 3 - protein, 35 aa, homo sapiens
MTLLVFEVQQPFLFVLWDQQHKFPVFVGRVYDPRA

SEQ ID NO: 4 - protein, 83 aa, homo sapiens
MRLFLSLPVLVVVLSIVLEGPAPAQGTPDVSSALDKLKEFGNTLEDKARELISRIKQSELSAKMREWFSETFQKVKEKLKIDS

SEQ ID NO: 5 - protein, 83 aa, homo sapiens
MRLFLSLPVLVVVLSIVLEGPAPAQGTPDVSSALDKLKEFGNTLEDKARELISRIKQSELSAKMREWFSESFQKVKEKLKIDS

SEQ ID NO: 6 - DNA, 419 bp, homo sapiens
cccgcagctcagccacggcacagatcagcaccacgacccctccctcgggcctcgccatgaggctcttcctgtcgctcccggtcctggtggtggttctgtcgatcgtcttggaaggcccagccccagcccaggggaccccagacgtctccagtgccttggataagctgaaggagtttggaaacacactggaggacaaggctcgggaactcatcagccgcatcaaacagagtgaactttctgccaagatgcgggagtggttttcagagtcatttcagaaagtgaaggagaaactcaagattgactcatgaggacctgaagggtgacatccaggaggggcctctgaaatttcccacaccccagcgcctgtgctgaggactcccgccatgtggccccaggtgccaccaataaaaatcctaccg

SEQ ID NO: 7 - protein, 419 aa, homo sapiens
CCCGCAGCTCAGCCACGGCACAGATCAGCACCACGACCCCTCCCTCGGGCCTCGCCATGAGGCTCTTCCTGTCGCTCCCGGTCCTGGTGGTGGTTCTGTCGATCGTCTTGGAAGGCCCAGCCCCAGCCCAGGGGACCCCAGACGTCTCCAGTGCCTTGGATAAGCTGAAGGAGTTTGGAAACACACTGGAGGACAAGGCTCGGGAACTCATCAGCCGCATCAAACAGAGTGAACTTTCTGCCAAGATGCGGGAGTGGTTTTCAGAGACATTTCAGAAAGTGAAGGAGAAACTCAAGATTGACTCATGAGGACCTGAAGGGTGACATCCAGGAGGGGCCTCTGAAATTTCCCACACCCCAGCGCCTGTGCTGAGGACTCCCGCCATGTGGCCCCAGGTGCCACCAATAAAAATCCTACCG

SEQ ID NO: 8 - protein, 62 aa, mus musculus
APDLSGTLESIPDKLKEFGNTLEDKARAAIEHIKQKEILTKTRAWFSEAFGKVKEKLKTTFS

SEQ ID NO: 9 - protein, 36 aa, mus musculus
APDLSGTLESIPDKLKEFGNTLEDKARAAIEHIKQK

SEQ ID NO: 10 - protein, 32 aa, homo sapiens
TPDVSSALDKLKEFGNTLEDKARELISRIKQS

SEQ ID NO: 11 - protein, 36 aa, canis familiares
AGEISSTFERIPDKLKEFGNTLEDKARAAIESIKKS

SEQ ID NO: 12 - protein, 36 aa, rattus orvegicus
APDFSSAMESLPDKLKEFGNTLEDKARAAIEHIKQK

SEQ ID NO: 13 - protein, 25 aa, homo sapiens
ELSAKMREWFSESFQKVKEKLKIDS

SEQ ID NO: 14 - protein, 25 aa, homo sapiens
ELSAKMREWFSETFQKVKEKLKIDS

SEQ ID NO: 15 - protein, 25 aa, papio hamadryas
EFPAKTRDWFSETFRKVKEKLKINS

SEQ ID NO: 16 - protein, 26 aa, canis familiares
DIPAKTRNWFSEAFKKVKEHLKTAFS

SEQ ID NO: 17 - protein, 26 aa, mus musculus
EILTKTRAWFSEAFGKVKEKLKTTFS

SEQ ID NO: 18 - protein, 26 aa, rattus norvegicus
EIMIKTRNWFSETLNKMKEKLKTTFA

SEQ ID NO: 19 - protein, 26 aa, pyrus pyrifolia
DLPAKTRNWFTETFGKVRDTFKATFS